(19) United States
(12) Patent Application Publication
(10) Pub. No.: US 2022/0113672 A1
(43) Pub. Date: Apr. 14, 2022

(54) METHOD FOR FABRICATING OFF-AXIS FOCUSING GEOMETRIC PHASE ELEMENT

(71) Applicant: Facebook Technologies, LLC, Menlo Park, CA (US)

(72) Inventors: Wai Sze Tiffany LAM, Bothell, WA (US); Oleg YAROSHCHUK, Redmond, WA (US); Yun-Han LEE, Redmond, WA (US); Maxwell PARSONS, Seattle, WA (US); Andrew John OUDERKIRK, Kirkland, WA (US); Lu LU, Kirkland, WA (US); Scott Charles MCELDOWNEY, Redmond, WA (US)

(21) Appl. No.: 17/065,734

(22) Filed: Oct. 8, 2020

(51) Int. Cl. G03H 1/04; G02B 5/30

(52) U.S. Cl. CPC G03H 1/0404; G03H 2001/0495; G02B 5/305; G02B 5/3016

(57) ABSTRACT

A method is provided. The method includes directing a first beam to a polarization sensitive recording medium. The method also includes directing a second beam to the polarization sensitive recording medium to interfere with the first beam to generate a polarization interference pattern, to which the polarization sensitive recording medium is exposed. One of the first beam and the second beam has a planar wavefront and the other has a non-planar wavefront. A first propagation direction of the first beam and a second propagation of the second beam are non-parallel.

### TECHNICAL FIELD

The present disclosure relates generally to methods for fabricating optical devices and, more specifically, to a method for fabricating an off-axis focusing geometric phase element.

### BACKGROUND

In a conventional optical system, in order to correct off-axis aberration, conventional lenses may be tilted at relatively large angles. The tilting configuration of the conventional lenses may increase the size of the optical system. Diffractive off-axis focusing lenses can provide off-axis focusing without tilting, or with tilting at smaller angles as compared with the conventional lenses. Thus, diffractive off-axis focusing lenses may reduce a form factor of the optical system. Moreover, diffractive off-axis focusing lenses may perform two or more functions simultaneously, such as deflection, focusing, and spectral selection of light. Geometric phase (“GP”) lenses (also referred to as Pancharatnam-Berry phase (“PBP”) lenses) may be formed in an optically anisotropic material layer with an intrinsic or induced (e.g., photo-induced) optical anisotropy. The optically anisotropic material may be liquid crystals, liquid crystal polymers, or metasurfaces. In the optically anisotropic material layer, a desirable lens phase profile may be directly encoded into a local orientation of an optic axis of the optically anisotropic material layer. GP or PBP lenses modulate a circularly polarized light based on a lens phase profile provided through the geometric phase. PBP lenses may be flat or curved diffractive lenses sensitive to handedness of a circularly polarized incident light or an elliptically polarized incident light. PBP lenses may be switchable between a focusing state and a defocusing state by reversing the handedness of a circularly polarized incident light. PBP lenses can be fabricated by various methods, e.g., holographic interference or holography, laser direct writing, and various other forms of lithography.

### SUMMARY OF THE DISCLOSURE

One aspect of the present disclosure provides a method. The method includes directing a first beam to a polarization sensitive recording medium. The method also includes directing a second beam to the polarization sensitive recording medium to interfere with the first beam to generate a polarization interference pattern, to which the polarization sensitive recording medium is exposed. One of the first beam and the second beam has a planar wavefront and the other has a non-planar wavefront. A first propagation direction of the first beam and a second propagation of the second beam are non-parallel.

Other aspects of the present disclosure can be understood by those skilled in the art in light of the description, the claims, and the drawings of the present disclosure.

### BRIEF DESCRIPTION OF THE DRAWINGS

The accompanying drawings are provided for illustrative purposes according to various disclosed embodiments and are not intended to limit the scope of the present disclosure. In the drawings:

FIG. 1A illustrates a schematic diagram of an off-axis focusing Geometric Phase (“GP”) lens or Pancharatnam-Berry phase (“PBP”) lens, according to an embodiment of the present disclosure;

FIG. 1B illustrates a schematic diagram of an off-axis focusing PBP lens, according to another embodiment of the present disclosure;

FIG. 1C illustrates a schematic diagram of an off-axis focusing PBP lens, according to another embodiment of the present disclosure;

FIG. 1D illustrates a schematic diagram of an off-axis focusing PBP lens, according to another embodiment of the present disclosure;

FIG. 2A illustrates a liquid crystal (“LC”) alignment pattern in an on-axis focusing PBP lens, according to an embodiment of the present disclosure;

FIG. 2B illustrates a section of an LC alignment pattern taken along an x-axis in the on-axis focusing PBP lens shown in FIG. 2A, according to an embodiment of the present disclosure;

FIG. 2C illustrates an LC alignment pattern in an on-axis focusing PBP lens, according to another embodiment of the present disclosure;

FIG. 2D illustrates a side view of the on-axis focusing PBP lens shown in FIG. 2A or FIG. 2C, according to an embodiment of the present disclosure;

FIG. 3A illustrates an LC alignment pattern in an off-axis focusing PBP lens, according to an embodiment of the present disclosure;

FIG. 3B illustrates a section of an LC alignment pattern along an x-axis in the off-axis focusing PBP lens shown in FIG. 3A, according to an embodiment of the present disclosure;

FIG. 3C illustrates an LC alignment pattern in an off-axis focusing PBP lens, according to another embodiment of the present disclosure;

FIG. 3D illustrates a side view of the off-axis focusing PBP lens shown in FIG. 3A or FIG. 3C, according to an embodiment of the present disclosure;

FIGS. 4A-4F illustrate deflection of lights by an off-axis focusing PBP lens, according to an embodiment of the present disclosure;

FIGS. 5A and 5B illustrate a switching of an off-axis focusing PBP lens between a focusing state and a defocusing state, according to an embodiment of the present disclosure;

FIGS. 6A and 6B illustrate a switching of an active off-axis focusing PBP lens between a focusing state and a neutral state, according to an embodiment of the present disclosure;

FIGS. 7A and 7B illustrate a switching of an active off-axis focusing PBP lens between a focusing state and a neutral state, according to another embodiment of the present disclosure;

FIG. 8 illustrates a schematic diagram of a lens stack including one or more off-axis focusing PBP lenses, according to an embodiment of the present disclosure;

FIGS. 9A-9D schematically illustrate processes for fabricating an off-axis focusing PBP lens, according to an embodiment of the present disclosure;

FIGS. 10A-10D schematically illustrate processes for fabricating off-axis focusing PBP lenses, according to various embodiments of the present disclosure;

FIGS. 11A and 11B schematically illustrate processes for fabricating an off-axis focusing PBP lens, according to an embodiment of the present disclosure;

FIGS. 12A-12D schematically illustrate holographic two-beam-interference exposure processes, according to various embodiments of the present disclosure;

FIG. 13A schematically illustrates an optical system for generating a holographic two-beam-interference exposure, according to an embodiment of the present disclosure;

FIG. 13B schematically illustrates an optical system for generating a holographic two-beam-interference exposure, according to another embodiment of the present disclosure;

FIGS. 14A and 14B schematically illustrate processes for fabricating off-axis focusing PBP lenses, according to various embodiments of the present disclosure;

FIG. 15 illustrates a flowchart showing a method for fabricating an off-axis focusing GP optical element, according to an embodiment of the present disclosure;

FIG. 16A illustrates a varying periodicity of an off-axis focusing PBP lens, according to an embodiment of the present disclosure; and

FIG. 16B illustrates a varying periodicity of an off-axis focusing PBP lens, according to another embodiment of the present disclosure.

### DETAILED DESCRIPTION

Embodiments consistent with the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

As used herein, the terms “couple,” “coupled,” “coupling,” or the like may encompass an optical coupling, a mechanical coupling, an electrical coupling, an electromagnetic coupling, or a combination thereof. An “optical coupling” between two optical elements refers to a configuration in which the two optical elements are arranged in an optical series, and a light output from one optical element may be directly or indirectly received by the other optical element. An optical series refers to optical positioning of a plurality of optical elements in a light path, such that a light output from one optical element may be transmitted, reflected, diffracted, converted, modified, or otherwise processed or manipulated by one or more of other optical elements. In some embodiments, the sequence in which the plurality of optical elements are arranged may or may not affect an overall output of the plurality of optical elements. A coupling may be a direct coupling or an indirect coupling (e.g., coupling through an intermediate element).

The phrase “at least one of A or B” may encompass all combinations of A and B, such as A only, B only, or A and B. Likewise, the phrase “at least one of A, B, or C” may encompass all combinations of A, B, and C, such as A only, B only, C only, A and B, A and C, B and C, or A and B and C. The phrase “A and/or B” may be interpreted in a manner similar to that of the phrase “at least one of A or B.” For example, the phrase “A and/or B” may encompass all combinations of A and B, such as A only, B only, or A and B. Likewise, the phrase “A, B, and/or C” has a meaning similar to that of the phrase “at least one of A, B, or C.” For example, the phrase “A, B, and/or C” may encompass all combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

When the first element is shown or described as being disposed or arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

The term “communicatively coupled” or “communicatively connected” indicates that related items are coupled or connected through an electrical and/or electromagnetic coupling or connection, such as a wired or wireless communication connection, channel, or network.

The wavelength ranges, spectra, or bands mentioned in the present disclosure are for illustrative purposes. The disclosed optical device, system, element, assembly, and method may be applied to a visible wavelength range, as well as other wavelength ranges, such as an ultraviolet (“UV”) wavelength range, an infrared wavelength range, or a combination thereof.

The term “processor” used herein may encompass any suitable processor, such as a central processing unit (“CPU”), a graphics processing unit (“GPU”), an application-specific integrated circuit (“ASIC”), a programmable logic device (“PLD”), or a combination thereof. Other processors not listed above may also be used. A processor may be implemented as software, hardware, firmware, or a combination thereof.

The term “controller” may encompass any suitable electrical circuit, software, or processor configured to generate a control signal for controlling a device, a circuit, an optical element, etc. A “controller” may be implemented as software, hardware, firmware, or a combination thereof. For example, a controller may include a processor, or may be included as a part of a processor.

The term “object-tracking system,” “object-tracking device,” “eye-tracking system,” or “eye-tracking device” may include suitable elements configured to obtain eye-tracking information, or to obtain sensor data for determining eye-tracking information. For example, the object-tracking (e.g., eye-tracking) system or device may include one or more suitable sensors (e.g., an optical sensor, such as a camera, motion sensors, etc.) to capture sensor data (e.g., images) of a tracked object (e.g., an eye of a user). In some embodiments, the object-tracking (e.g., eye-tracking) system or device may include a light source configured to emit a light to illuminate the tracked object (e.g., the eye of the user). The object-tracking (e.g., eye-tracking) system or device may also include a processor or controller configured to process the sensor data (e.g., the images) of the tracked object (e.g., the eye of the user) to obtain object-tracking information (e.g., eye-tracking information). The processor or controller may provide the object-tracking (e.g., eye-tracking) information to another device, or may process the object-tracking (e.g., eye-tracking) information to control another device, such as a grating, a lens, a waveplate, etc. The object-tracking (e.g., eye-tracking) system or device may also include a non-transitory computer-readable medium, such as a memory, configured to store computer-executable instructions, and sensor data or information, such as the captured image and/or the object-tracking (e.g., eye-tracking) information obtained from processing the captured image. In some embodiments, the object-tracking (e.g., eye-tracking) system or device may transmit the sensor data to another processor or controller (e.g., a processor of another device, such as a cloud-based device) for determining the object-tracking (e.g., eye-tracking) information.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“RAM”), a flash memory, etc.

As used herein, the term “liquid crystal compound” or “mesogenic compound” may refer to a compound including one or more calamitic (rod- or board/lath-shaped) or discotic (disk-shaped) mesogenic groups. The term “mesogenic group” may refer to a group with the ability to induce liquid crystalline phase (or mesophase) behavior. In some embodiments, the compounds including mesogenic groups may not exhibit a liquid crystal (“LC”) phase themselves. Instead, the compounds may exhibit the LC phase when mixed with other compounds. In some embodiments, the compounds may exhibit the LC phase when the compounds, or the mixture containing the compounds, are polymerized. For simplicity of discussion, the term “liquid crystal” is used hereinafter for both mesogenic and LC materials. In some embodiments, a calamitic mesogenic group may include a mesogenic core including one or more aromatic or non-aromatic cyclic groups connected to each other directly or via linkage groups. In some embodiments, a calamitic mesogenic group may include terminal groups attached to the ends of the mesogenic core. In some embodiments, a calamitic mesogenic group may include one or more lateral groups attached to a long side of the mesogenic core. These terminal and lateral groups may be selected from, e.g., carbyl or hydrocarbyl groups, polar groups such as halogen, nitro, hydroxy, etc., or polymerizable groups.

As used herein, the term “reactive mesogen” (“RM”) may refer to a polymerizable mesogenic or a liquid crystal compound. A polymerizable compound with one polymerizable group may be also referred to as a “mono-reactive” compound. A compound with two polymerizable groups may be referred to as a “di-reactive” compound, and a compound with more than two polymerizable groups may be referred to as a “multi-reactive” compound. RMs may also be referred to as passive LCs that are not reorientable by an external field. Compounds without a polymerizable group may be also referred to as “non-reactive” compounds.

As used herein, the term “director” may refer to a preferred orientation direction of long molecular axes (e.g., in case of calamitic compounds) or short molecular axes (e.g., in case of discotic compounds) of the LC or RM molecules. In a film including a uniaxially positive birefringent LC or RM material, the optic axis may be provided by the director.

The term “optic axis” may refer to a direction in a crystal. A light propagating in the optic axis direction may not experience birefringence (or double refraction). An optic axis may be a direction rather than a single line: lights that are parallel to that direction may experience no birefringence. The term “lens plane” or “lens layer” of a lens refers to a film plane or a film layer of an optically anisotropic film included in the lens.

As used herein, the term “film” and “layer” may include rigid or flexible, self-supporting or free-standing film, coating, or layer, which may be disposed on a supporting substrate or between substrates. The term “in-plane” in phrases “in-plane direction,” “in-plane orientation,” “in-plane alignment pattern,” “in-plane rotation pattern,” and “in-plane pitch” means within a plane of a film or a layer (e.g., a surface plane of the film or layer, or a plane parallel to the surface plane of the film or layer).

As used herein, the phrase “aperture of a lens” refers to an effective light receiving area of the lens. A “geometry center” of a lens refers to a center of a shape of the effective light receiving area (e.g., aperture) of the lens. The geometry center may be a point of intersection of (i.e., a crossing point between) a first symmetric axis and a second symmetric axis of the shape of the aperture. When the entire shape of the lens constitutes the effective light receiving area of the lens, the geometry center of the lens is the center of the shape of the lens. For example, when the aperture has a circular shape, the geometry center is a point of intersection of a first diameter (also a first symmetric axis) and a second diameter (also a second symmetric axis) of the aperture of the lens. When the aperture has a rectangular shape, the geometry center is a point of intersection of a longitudinal symmetric axis (also a first symmetric axis) and a lateral symmetric axis (also a second symmetric axis) of the aperture of the lens.

Pancharatnam-Berry phase (“PBP”) is a geometric phase (“GP”) related to changes in the polarization state experienced by a light while the light propagates in an optically anisotropic material. Such a geometric phase may be proportional to a solid angle defined by the polarization state along the light propagation path on the Poincaré sphere. In an optically anisotropic material, a transverse gradient of PBP may be induced by local rotations of the optic axis. When the thickness of an optically anisotropic plate corresponds to a half-wave plate phase difference between the ordinary and the extraordinary lights, the PBP between two points across a light beam profile may be equal to twice the relative rotation of the optic axis at the two points. Thus, the wavefront of the light may be polarization-dependent and may be configured by a spatial rotation of the optic axis in the in-plane.

GP elements such as PBP lenses may be formed by a thin layer of one or more birefringent materials with intrinsic or induced (e.g., photo-induced) optical anisotropy (referred to as an optically anisotropic film), such as liquid crystals, liquid crystal polymers, amorphous polymers, or metasurfaces. The birefringent materials may include optically anisotropic molecules. A desirable lens phase profile may be directly encoded into local orientations of the optic axis of the optically anisotropic film. PBP lenses have features such as flatness, compactness, high efficiency, high aperture ratio, absence of on-axis aberrations, possibility of switching, flexible design, simple fabrication, and low cost, etc. Thus, the GP lenses or PBP lenses can be implemented in various applications such as portable or wearable optical devices or systems.

The in-plane orientation of the optic axis of the optically anisotropic film may be determined by orientations (e.g., alignment directions) of the elongated molecules or molecular units (e.g., small molecules or fragments of polymeric molecules) in the film. For discussion purposes, elongated optically anisotropic molecules are used as examples for describing the alignment pattern in the PBP lens. The alignment of the elongated optically anisotropic molecules may also be referred to as the orientation of the directors of the elongated optically anisotropic molecules. In some embodiments, the alignment pattern may include an in-plane orientation pattern, i.e., the orientation pattern in a plane, such as a surface plane of the film or a plane parallel with the surface of the film. The in-plane orientation pattern of the optically anisotropic molecules may result in an in-plane orientation pattern of the optic axis of the optically anisotropic film. In some embodiments, the molecules may have a continuous in-plane rotation in at least two opposite directions along a film plane (e.g., a surface plane) of the optically anisotropic film. The at least two opposite in-plane directions may be opposite directions from a lens pattern center to opposite lens peripheries of the PBP lens. The least two opposite directions along the surface plane of the optically anisotropic film may be referred to as at least two opposite in-plane directions. Correspondingly, the optic axis of the optically anisotropic film may have a continuous in-plane rotation in the at least two opposite in-plane directions of the optically anisotropic film.

An in-plane orientation of the optic axis of the optically anisotropic film may correspond to an in-plane projection of the optic axis, e.g., a projection of the optic axis on a film plane. An angle formed by the projection with a predetermined reference direction in the film plane (e.g., +x-axis direction) may be defined as an azimuthal angle of the optic axis at a local point, which may be the same as the azimuthal angle of a corresponding molecule. The azimuthal angle of the optic axis (or the azimuthal angles of the molecules) may change from one local point to another local point, resulting in changes in the in-plane projection of the optic axis.

A lens pattern (or an optic axis pattern) of the PBP lens refers to the orientation pattern of the optic axis of the optically anisotropic film, or the orientation pattern of the elongated molecules or elongated molecular units, the pattern of change of the azimuthal angles of the optic axis of the optically anisotropic film, or the pattern of change of the azimuthal angles of the optically anisotropic molecules in the optically anisotropic film. The azimuthal angles of the optic axis of the optically anisotropic film may change in at least two opposite in-plane directions of the optically anisotropic film. The at least two opposite in-plane directions may be opposite directions from a lens pattern center to opposite lens peripheries of the PBP lens. At the same distance from the lens pattern center in the at least two opposite in-plane directions, the optic axis of the optically anisotropic film of the PBP lens may rotate in the same rotation direction (e.g., clockwise or counter-clockwise) respectively. The lens pattern (or the optic axis pattern) of the PBP lens may correspond to an alignment pattern of the elongated molecules or molecular units (e.g., small molecules or fragments of polymeric molecules) in the optically anisotropic film. A fringe of the PBP lens refers to a set of local points at which the azimuthal angles of the optic axis (or the rotation angles of the optic axis starting from the lens pattern center to the local points in the radial direction) are the same. The PBP lens may have a plurality of fringes. For a PBP lens functioning as a spherical lens or an aspherical lens, the fringes may be concentric rings. For a PBP lens functioning as a cylindrical lens, the fringes may be parallel lines.

A center of the lens pattern of an on-axis focusing PBP lens is referred to as a lens pattern center, which may be a symmetry center of the lens pattern. The lens pattern center of the on-axis focusing PBP lens may coincide with a geometry center of the on-axis focusing PBP lens. An off-axis focusing PBP lens may be considered as a lens obtained by shifting the lens pattern center of a corresponding on-axis focusing PBP lens with respect to the geometry center of the on-axis focusing PBP lens. The lens pattern center of the corresponding on-axis focusing PBP lens may also be a lens pattern center of the off-axis focusing PBP lens. That is, the off-axis focusing PBP lens may have an on-axis focusing counterpart with the same lens pattern center.

A geometry center of a PBP lens may be defined as a center of a shape of the effective light receiving area (i.e., an aperture) of the PBP lens. When the entire area of the PBP lens constitutes the effective light receiving area, the geometry center of the PBP lens may correspond to the center of the shape of the PBP lens. An out-of-plane geometry center axis (also referred to as a lens axis) refers to an axis passing through the geometry center that is perpendicular to the surface plane of the optically anisotropic film of the PBP lens. An in-plane geometry center axis refers to an axis passing through the geometry center that is within the surface plane of the optically anisotropic film of the PBP lens. The out-of-plane geometry center axis may be parallel with the out-of-plane lens pattern center axis.

In some embodiments, when the PBP lens is an on-axis focusing PBP lens, the lens pattern center may correspond to the geometry center of the PBP lens (i.e., the center of the shape of the effective light receiving area of the lens). In some embodiments, when the PBP lens is an off-axis focusing PBP lens, the lens pattern center of the PBP lens may not correspond to a geometry center of the PBP lens. Instead, the lens pattern center of the PBP lens may be shifted from the geometry center of the PBP lens. An “out-of-plane lens pattern center axis” refers to an axis passing through the lens pattern center that is perpendicular to the surface plane of the optically anisotropic film of the PBP lens. An in-plane lens pattern center axis refers to an axis passing through the lens pattern center that is within the surface plane of the optically anisotropic film of the PBP lens. Thus, the in-plane lens pattern center axis is perpendicular to the out-of-plane lens pattern center axis.

For a PBP lens functioning as a spherical lens or an aspherical lens (referred to as a PBP spherical lens or aspherical lens), the at least two opposite in-plane directions may include a plurality of opposite radial directions. A PBP spherical/aspherical lens may focus a light into a point (e.g., a focal point or focus). A PBP spherical/aspherical lens may have a geometry center that is a point of intersection of a first in-plane symmetric axis (e.g., a first diameter) and a second in-plane symmetric axis (e.g., a second diameter) of the shape of the aperture. In some embodiments, the lens pattern center and the geometry center of the PBP spherical/aspherical lens may be located on a same in-plane symmetric axis of the aperture of the PBP spherical/aspherical lens.

For a PBP lens functioning as an on-axis focusing PBP spherical lens or aspherical lens, the alignment pattern and the fringes of the PBP lens may be centrosymmetric with respect to the lens pattern center of the PBP lens. In addition, the fringes of the PBP lens may be symmetric with respect to an axis passing through the lens pattern center of the PBP lens. The alignment pattern of the PBP lens may be asymmetric with respect to the axis passing through the lens pattern center of the PBP lens.

For a PBP lens functioning as an off-axis focusing PBP spherical lens or aspherical lens, the alignment pattern and the fringes of the PBP lens over the entire PBP lens may not be centrosymmetric with respect to the lens pattern center of the PBP lens. Instead, the alignment pattern and the fringes of an off-axis focusing PBP lens in a predetermined region of the entire PBP lens including the lens pattern center may be centrosymmetric with respect to the lens pattern center of the PBP lens. In addition, the fringes of an off-axis focusing PBP lens in a predetermined region of the entire PBP lens including the lens pattern center may be symmetric with respect to an axis passing through the lens pattern center of the PBP lens. The alignment pattern of the PBP lens in a predetermined region of the entire off-axis focusing PBP lens including the lens pattern center may be asymmetric with respect to the axis passing through the lens pattern center of the PBP lens.

A PBP spherical lens (e.g., an on-axis or off-axis focusing PBP spherical lens) may have a point at which an azimuthal angle changing rate of the optic axis (or an azimuthal angle changing rate of the optically anisotropic molecules) of the optically anisotropic film in the opposite radial directions is the smallest, as compared to the remaining points of the PBP spherical lens. That is, in the PBP spherical lens, the azimuthal angle changing rate of the optic axis of the optically anisotropic film may be configured to increase in substantially the entire PBP lens in opposite radial directions from the lens pattern center to the opposite lens peripheries. In the PBP spherical lens, the lens pattern center may also be defined as the point at which an azimuthal angle changing rate of the optic axis (or an azimuthal angle changing rate of the optically anisotropic molecules) of the optically anisotropic film in the at least two opposite in-plane directions is the smallest. As a comparison, in a PBP aspherical lens (e.g., an on-axis or off-axis focusing PBP aspherical lens), the azimuthal angle changing rate of the optic axis of the optically anisotropic film may be configured to increase in at least a portion of the PBP lens including a lens pattern center (less than the entire PBP lens) from the lens pattern center to the opposite lens peripheries in opposite radial directions.

For a PBP lens functioning as a cylindrical lens (referred to as a PBP cylindrical lens), which may be considered as a 1D case of a PBP lens functioning as a spherical lens, the at least two opposite in-plane directions may include two opposite lateral directions. A PBP cylindrical lens may focus a light into a line (e.g., a line of focal points or line focus). A PBP cylindrical lens may have two symmetric axes of the shape of the aperture, e.g., a lateral symmetric axis in a lateral direction (or width direction) of the PBP cylindrical lens and a longitudinal symmetric axis in a longitudinal direction (or length direction) of the PBP cylindrical lens. The geometry center of the PBP cylindrical lens may be a point of intersection of the two symmetric axes. When the cylindrical lens has a rectangular shape, the geometry center may also be a point of intersection of two diagonals. A PBP cylindrical lens may have a plurality of points, at each of which an azimuthal angle changing rate of the optic axis (or an azimuthal angle changing rate of the optically anisotropic molecules) of the optically anisotropic film in the at least two opposite in-plane directions may be the smallest. The plurality of points, at each of which an azimuthal angle changing rate is the smallest may be arranged in a line. The line may be referred to as an “in-plane lens pattern center axis” of the PBP cylindrical lens. The in-plane lens pattern center axis may be in the longitudinal direction. A lens pattern center of the PBP cylindrical lens may also be considered as one of the plurality of points, which is located on a same symmetric axis (e.g., the lateral symmetric axis) with the geometry center of the PBP cylindrical lens. In other words, the lens pattern center is also a point of intersection of the in-plane lens pattern center axis and the lateral symmetric axis.

A PBP cylindrical lens may have a central symmetry of fringes and alignment pattern with respect to the lens pattern center in the two opposite lateral directions (and in some embodiments, only in the two opposite lateral directions). For a PBP lens functioning as an on-axis focusing PBP cylindrical lens, the alignment pattern and the fringes of the PBP lens over the entire PBP lens may be centrosymmetric with respect to the lens pattern center in the two opposite lateral directions (and in some embodiments, only in the two opposite lateral directions). In addition, the fringes of the PBP lens may be symmetric with respect to the in-plane lens pattern center axis of the PBP lens. The alignment pattern of the PBP lens may be asymmetric with respect to the in-plane lens pattern center axis of the PBP lens.

For a PBP lens functioning as an off-axis focusing PBP cylindrical lens, the alignment pattern and the fringes of the PBP lens over the entire PBP lens may not be centrosymmetric with respect to the lens pattern center in the two opposite lateral directions. Instead, the alignment pattern and the fringes of the PBP lens in a predetermined region of the entire PBP lens including the lens pattern center may be centrosymmetric with respect to the lens pattern center of the PBP lens in the two opposite lateral directions. In addition, the fringes of the PBP lens in the predetermined region of the entire PBP lens including the lens pattern center may be symmetric with respect to the in-plane lens pattern center axis of the PBP lens. The alignment pattern of the PBP lens in the predetermined region of the entire PBP lens including the lens pattern center may be asymmetric with respect to the in-plane lens pattern center axis of the PBP lens.

The present discourse provides an off-axis focusing GP lens or PBP lens configured to provide an off-axis focusing capability to an incoming light without tilting the off-axis focusing PBP lens. The off-axis focusing PBP lens may include an optically anisotropic film. An optic axis of the optically anisotropic film (or the off-axis focusing PBP lens) may be configured with a continuous in-plane rotation in at least two opposite in-plane directions of the optically anisotropic film from a lens pattern center, thereby creating a geometric phase profile for the off-axis focusing PBP lens. The at least two opposite in-plane directions may be opposite directions from a lens pattern center to opposite lens peripheries of the off-axis focusing PBP lens. The optic axis of the optically anisotropic film may rotate in a same rotation direction (e.g., a clockwise direction or a counter-clockwise direction) along the at least two opposite in-plane directions from the lens pattern center. The rotation of the optic axis of the optically anisotropic film in a predetermined rotation direction (e.g., a clockwise direction or a counter-clockwise direction) may exhibit a handedness, e.g., right handedness or left handedness. An azimuthal angle changing rate of the optic axis of the optically anisotropic film may be configured to increase from the lens pattern center in the at least two opposite in-plane directions in at least a predetermined portion of the off-axis focusing PBP lens including the lens pattern center. The lens pattern center may be shifted from a geometry center of the off-axis focusing PBP lens by a predetermined distance in a predetermined direction. In some embodiments, the lens pattern center of the off-axis focusing PBP lens may be a point at which the azimuthal angle changing rate of the optic axis of the optically anisotropic film is the smallest in at least the portion of the lens including the lens pattern center. In some embodiments, the lens pattern center of the off-axis focusing PBP lens may be a symmetric center of a lens pattern of a corresponding on-axis focusing PBP lens.

The lens pattern of the off-axis focusing PBP lens may have a period P that is defined as a distance over which the azimuthal angle θ of the optic axis of the optically anisotropic film changes by π in the at least two opposite in-plane directions. The period P of the lens pattern may vary in the at least two opposite in-plane directions. The period P of the lens pattern may monotonically decrease from the lens pattern center in the at least two opposite in-plane directions in at least the predetermined portion of the off-axis focusing PBP lens including the lens pattern center. In some embodiments, the predetermined portion of the off-axis focusing PBP lens including the lens pattern center may be substantially the entire off-axis focusing PBP lens. In some embodiments, the predetermined portion of the off-axis focusing PBP lens including the lens pattern center may be less than the entire off-axis focusing PBP lens. For example, the period P of the lens pattern may monotonically decrease from the lens pattern center in the at least two opposite in-plane directions in a first predetermined portion of the off-axis focusing PBP lens including the lens pattern center, and increase from the lens pattern center in the at least two opposite in-plane directions from the lens pattern center to the periphery in a second predetermined portion of the off-axis focusing PBP lens. The first predetermined portion may be different from the second predetermined portion. In some embodiments, the first predetermined portion may be adjacent to the second predetermined portion.

In some embodiments, the off-axis focusing PBP lens may be obtained by cropping or cutting an on-axis PBP lens asymmetrically. In some embodiments, the off-axis focusing PBP lens may be fabricated by one or more of holographic recording, direct writing, exposure through a master mask, or a photocopying, etc. In some embodiments, the orientation pattern of the optic axis of the optically anisotropic film may be holographically recorded in a layer of a recording medium by two coherent polarized lights. In some embodiments, the two polarized lights may be two circularly polarized lights with opposite handednesses irradiated onto the same surface of the recording medium. The fabricated off-axis focusing PBP lens may be a transmissive type optical element. In some embodiments, one of the two circularly polarized lights may be a collimated light and the other may be a converging or diverging light.

In some embodiments, the two circularly polarized lights may be two circularly polarized lights with a same handedness irradiated onto different surfaces (e.g., two opposite surfaces) of the recording medium. The fabricated off-axis focusing PBP lens may be a reflective type optical element. In some embodiments, one of the two circularly polarized lights may be a collimated light and the other may be a converging or diverging light.

The recording medium may include one or more optically recordable and polarization sensitive materials configured to generate a photo-induced anisotropy when subjected to a polarized light irradiation. The molecules (fragments) and/or the photo-products of the recording medium may be configured to generate orientational ordering under a light irradiation. The interference of the two circularly polarized lights may result in patterns of light polarization (or polarization interference patterns), without resulting in intensity modulation. In some embodiments, the molecules of the optically recordable and polarization sensitive materials may include elongated anisotropic photo-sensitive units (e.g., small molecules or fragments of polymeric molecules). The patterns of light polarization may induce a local alignment direction of the anisotropic photo-sensitive units in the layer of recording medium, resulting in a modulation of an optic axis due to a photo-alignment of the anisotropic photo-sensitive units. The optic axis orientation inscribed in the recording medium may be further enhanced by disposing a layer of birefringent materials having an intrinsic birefringence, such as liquid crystals (“LCs”) or reactive mesogens (“RMs”), on the recording medium. LCs or RMs may be aligned along the local alignment direction of the anisotropic photo-sensitive units in the layer of the recording medium. Thus, the orientational pattern of the optic axis in the recording medium may be transferred to the LCs or RMs. That is, the irradiated layer of the recording medium may function as an photo-alignment (“PAM”) layer for the LCs or RMs. Such an alignment procedure may be referred to as a surface-mediated photo-alignment.

In some embodiments, the photo-alignment of photo-sensitive units may occur in a volume of one or more optically recordable and polarization sensitive materials. When irradiation is provided with holographically created patterns of light polarization, the alignment patterns of photo-sensitive units may occur in the layer of the recording medium. Such an alignment procedure may be referred to as a bulk-mediated photo-alignment. In some embodiments, the optically recordable and polarization sensitive materials for bulk-mediated photo-alignment may include photo-sensitive polymers, such as amorphous polymers, liquid crystal (“LC”) polymers, etc. In some embodiments, the amorphous polymers may be initially optically isotropic prior to undergoing the recording process, and may exhibit an induced (e.g., photo-induced) optical anisotropy during the recording process. In some embodiments, the birefringence and orientational patterns may be recorded in the LC polymers due to an effect of photo-induced optical anisotropy. The photo-induced optical anisotropy in the LC polymers may be considerably enhanced by a subsequent heat treatment (e.g., annealing) in a temperature range corresponding to liquid crystalline state of the LC polymers due to intrinsic self-organization of mesogenic fragments of the LC polymers.

The molecules of photo-sensitive polymers may include polarization sensitive photo-reactive groups embedded in a main or a side polymer chain. In some embodiments, the polarization sensitive groups may include an azobenzene group, a cinnamate group, or a coumarin group, etc. In some embodiments, the photo-sensitive polymer may include an LC polymer with a polarization sensitive cinnamate group incorporated in a side polymer chain. An example of the LC polymer with a polarization sensitive cinnamate group incorporated in a side polymer chain is a polymer M1. The polymer M1 has a nematic mesophase in a temperature range of about 115° C. to about 300° C. An optical anisotropy may be induced by irradiating the M1 film with a polarized UV light (e.g., a laser light with a wavelength of 325 nm or 355 nm) and subsequently enhanced by more than an order of magnitude by annealing at a temperature range of about 115° C. to about 300° C. It is to be noted that the material M1 is for illustrative purposes, and is not intended to limit the scope of the present disclosure. The dependence of the photo-induced birefringence on exposure energy is qualitatively similar for other materials from liquid crystalline polymers of M series. Liquid crystalline polymers of M series are discussed in U.S. patent application Ser. No. 16/443,506, filed on Jun. 17, 2019, titled “Photosensitive Polymers for Volume Holography,” which is incorporated by reference for all purposes. In some embodiments, with suitable photo-sensitizers, a visible light (e.g., a violet light) may also be used to induce anisotropy in this material.

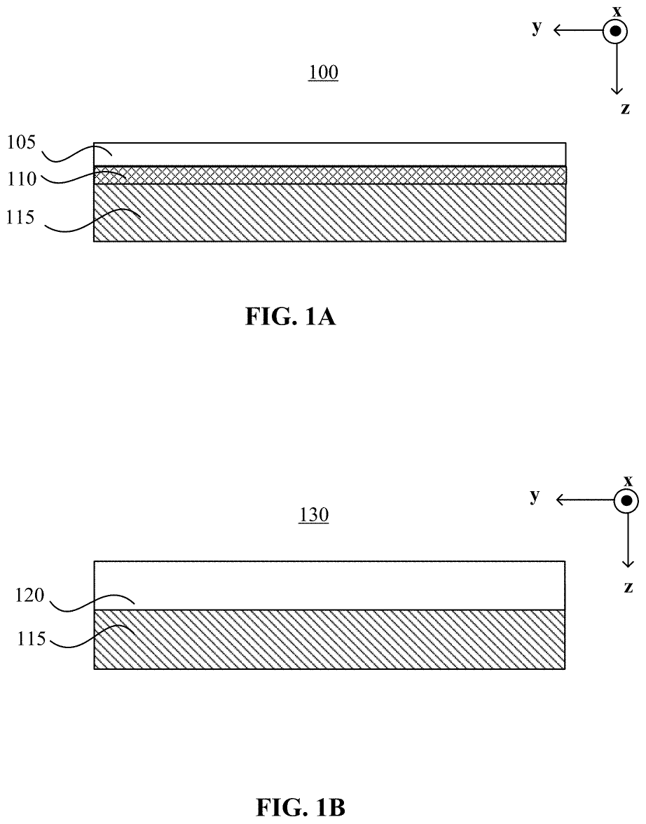

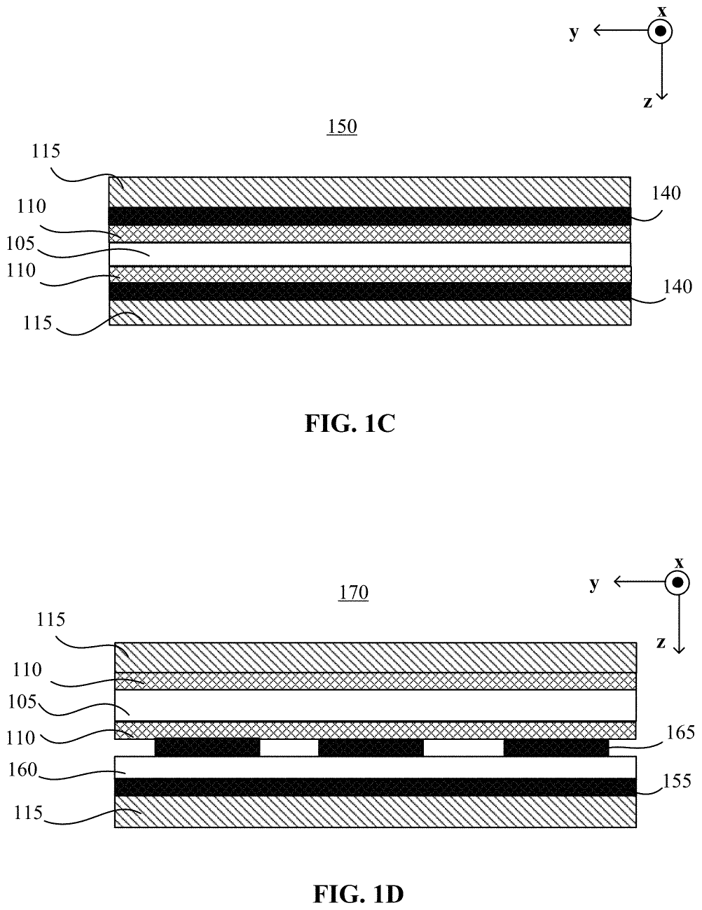

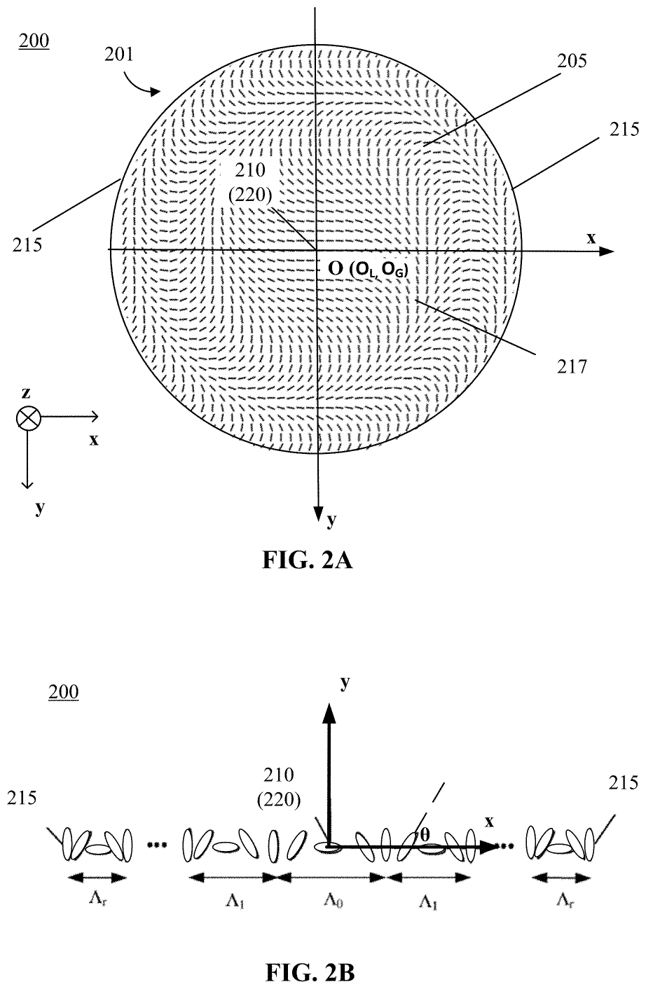

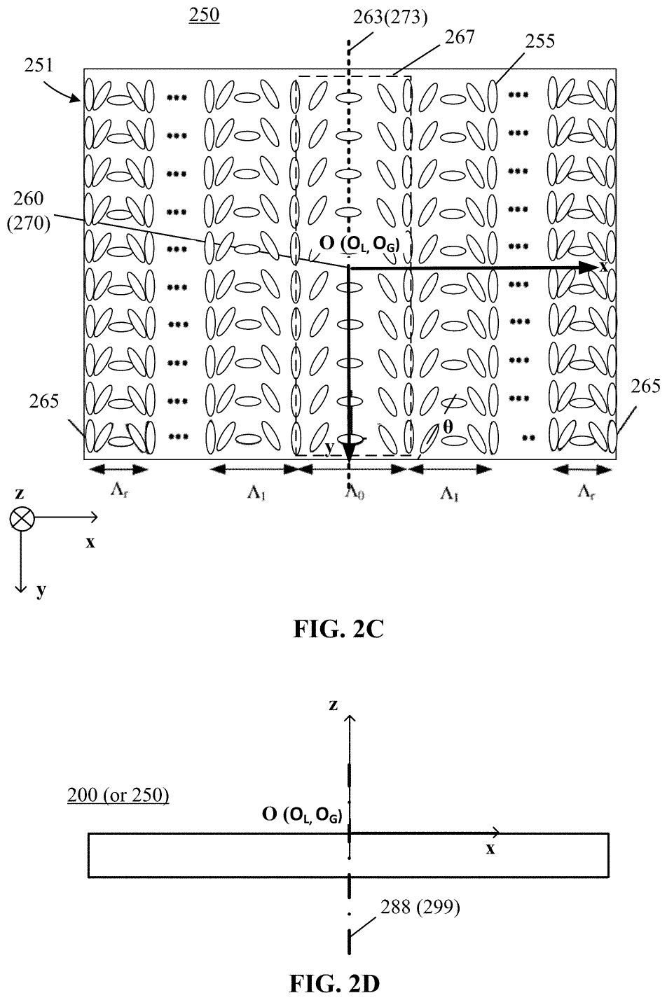

FIG. 1A illustrates a schematic diagram of an off-axis focusing PBP lens 100 according to an embodiment of the present disclosure. The off-axis focusing PBP lens 100 may be fabricated based on the surface-mediated photo-alignment technology. As shown in FIG. 1A, the off-axis focusing PBP lens 100 may include an optically anisotropic film 105 and an alignment layer 110 (e.g., a PAM layer 110) coupled to the optically anisotropic film 105. The PAM layer 110 may include one or more recording media, where a predetermined local orientation pattern of the optic axis of the birefringent material has been directly recorded in the photo-alignment process. For example, the PAM layer 110 may provide a planar alignment (or an alignment with a small pretilt angle, e.g., smaller than 15 degrees) that is in-plane patterned to provide a lens pattern. The optically anisotropic film 105 may include one or more birefringent materials having an intrinsic birefringence, such as LCs or RMs. The PAM layer 110 may at least partially align the LCs or RMs in the optically anisotropic film 105 that are in contact with the PAM layer 110, such that the local orientational pattern of the optic axis recorded in the PAM layer 110 may be transferred to the LCs or RMs in the optically anisotropic film 105. In some embodiments, the optically anisotropic film 105 may be configured to have local optic axis orientations that vary (e.g., non-linearly) in at least one direction along a surface of the optically anisotropic film 105 to define a lens pattern having a varying pitch. In some embodiments, RMs may be mixed with photo- or thermo-initiators, such that the aligned RMs may be in-situ photo- or thermo-polymerized/crosslinked to solidify the film and stabilize the alignment pattern of the RMs in the optically anisotropic film 105. In some embodiments, LCs may be mixed with photo- or thermo-initiators and polymerizable monomers, such that the aligned LCs may be in-situ photo- or thermo-polymerized/crosslinked to solidify the film and stabilize the alignment pattern of the LCs in the optically anisotropic film 105.

In some embodiments, the PAM layer 110 may be used to fabricate, store, or transport the off-axis focusing PBP lens 100. In some embodiments, the PAM layer 110 may be detachable or removable from other portions of the off-axis focusing PBP lens 100 after the other portions of the off-axis focusing PBP lens 100 are fabricated or transported to another place or device. That is, the PAM layer 110 may be used in fabrication, transportation, and/or storage to support the optically anisotropic film 105 provided at a surface of the PAM layer 110, and may be separated or removed from the optically anisotropic film 105 of the off-axis focusing PBP lens 100 when the fabrication of the off-axis focusing PBP lens 100 is completed, or when the off-axis focusing PBP lens 100 is to be implemented in an optical device.

In some embodiments, the off-axis focusing PBP lens 100 may include one or more substrates 115 for support and protection purposes. The optically anisotropic film 105 may be disposed at (e.g., formed at, attached to, deposited at, bonded to, etc.) a surface of the substrate 115. For discussion purposes, FIG. 1A shows that the off-axis focusing PBP lens 100 includes one substrate 115. In some embodiments, the substrate 115 may be a substrate where the recording film is disposed during the recording process of the off-axis focusing PBP lens 100. The substrate 115 may be transparent and/or reflective in one or more predetermined spectrum bands. In some embodiments, the substrate 115 may be transparent and/or reflective in at least a portion of the visible band (e.g., about 380 nm to about 700 nm). In some embodiments, the substrate 115 may be transparent and/or reflective in at least a portion of the infrared (“IR”) band (e.g., about 700 nm to about 1 mm). In some embodiments, the substrate 115 may be transparent and/or reflective in at least a portion of the visible band and at least a portion of the IR band. The substrate 115 may be fabricated based on an organic material and/or an inorganic material that is substantially transparent to the light of above-listed spectrum bands. The substrate 115 may be rigid or flexible. The substrate 115 may have flat surfaces or at least one curved surface, and the optically anisotropic film 105 disposed at (e.g., formed at, attached to, deposited at, bonded to, etc.) the curved surface may also have a curved shape. In some embodiments, the substrate 115 may also be a part of another optical element, another optical device, or another opto-electrical device. In some embodiments, the substrate 115 may be a part of a functional device, such as a display screen. In some embodiments, the substrate 115 may be a part of an optical waveguide fabricated based on a suitable material, such as glass, plastics, sapphire, or a combination thereof. In some embodiments, the substrate 115 may be a part of another optical element or another optical device. In some embodiments, the substrate 115 may be a conventional lens, e.g., a glass lens. Although one substrate 115 is shown in FIG. 1A, in some embodiments, the off-axis focusing PBP lens 100 may include two substrates 115 sandwiching the optically anisotropic film 105. In some embodiments, each substrate 115 may be disposed with a PAM layer 110 configured to provide an alignment of the LCs or RMs in the optically anisotropic film 105.

In some embodiments, the substrate 115 may be used to fabricate, store, or transport the off-axis focusing PBP lens 100. In some embodiments, the substrate 115 may be detachable or removable from other portions of the off-axis focusing PBP lens 100 after the other portions of the off-axis focusing PBP lens 100 are fabricated or transported to another place or device. That is, the substrate 115 may be used in fabrication, transportation, and/or storage to support the PAM layer 110 and the optically anisotropic film 105 provided on the substrate 115, and may be separated or removed from the PAM layer 110 and the optically anisotropic film 105 when the fabrication of the off-axis focusing PBP lens 100 is completed, or when the off-axis focusing PBP lens 100 is to be implemented in an optical device.

FIG. 1B illustrates a schematic diagram of an off-axis focusing PBP lens 130 according to an embodiment of the present disclosure. The off-axis focusing PBP lens 130 may be fabricated based on bulk-mediated photo-alignment technology. As shown in FIG. 1B, the off-axis focusing PBP lens 130 may include an optically anisotropic film 120. The optically anisotropic film 120 may include one or more materials configured to generate a photo-induced birefringence, such as amorphous or liquid crystal polymers with polarization sensitive photo-reactive groups. The optically anisotropic film 120 shown in FIG. 1B may be relatively thicker than the PAM layer 110 shown in FIG. 1A. A predetermined local orientation pattern of the optic axis of the optically anisotropic film 120 may be directly recorded in the optically anisotropic film 120 via bulk-mediated photo-alignment during the recording process. The optically anisotropic film 120 may be configured to have local optic axis orientations that vary non-linearly in at least one direction along a surface of the optically anisotropic film 120 to define a pattern having a varying pitch. In some embodiments, the off-axis focusing PBP lens 130 may also include one or more substrates 115 for support and protection purposes. Detailed descriptions of the substrate 115 may refer to the above descriptions rendered in connection with FIG. 1A. Although one substrate 115 is shown in FIG. 1B, in some embodiments, the off-axis focusing PBP lens 130 may include two substrate 115 sandwiching the optically anisotropic film 120.

FIG. 1C illustrates a schematic diagram of an off-axis focusing PBP lens 150 according to an embodiment of the present disclosure. The off-axis focusing PBP lens 150 shown in FIG. 1C may include elements that are the same as or similar to those included in the off-axis focusing PBP lens 100 shown in FIG. 1A. Detailed descriptions of the same or similar elements may refer to the above descriptions rendered in connection with FIG. 1A. As shown in FIG. 1C, the optically anisotropic film 105 may be disposed (e.g., sandwiched) between two substrates 115. In some embodiments, as FIG. 1C shows, each substrate 115 may be provided with a conductive electrode 140 and the PAM layer 110. The electrode 140 may be disposed between the PAM layer 110 and the substrate 115. The PAM layer 110 may be disposed between the electrode 140 and the optically anisotropic film 105, and configured to provide a planar alignment (or an alignment with a small pretilt angle) that is in-plane patterned to provide a lens pattern. The electrode 140 may be transmissive and/or reflective at least in the same spectrum band as the substrate 115. The electrode 140 may be a continuous planar electrode or a pattern electrode. FIG. 1C shows the electrode 140 as a continuous planar electrode. A driving voltage may be applied to the electrodes 140 disposed at two opposite substrates 115 to generate a vertical electric field perpendicular to the substrates 115 in the optically anisotropic film 105. The electric field may reorient the anisotropic molecules, thereby switching the optical properties of the off-axis focusing PBP lens 100. The vertical electric field may realize an out-of-plane reorientation of anisotropic molecules in the optically anisotropic film 105. The term “out-of-plane reorientation” refers to rotation (or reorientation) of the directors of the optically anisotropic molecules in a direction non-parallel with (hence out of) a surface plane of the optically anisotropic film 105. Although not shown in FIG. 1C, in some embodiments, one of the two substrates 115 may be provided with the PAM layer 110, and the other one of the two substrates 115 may not be provided with a PAM layer.

FIG. 1D illustrates a schematic diagram of an off-axis focusing PBP lens 170 according to an embodiment of the present disclosure. The off-axis focusing PBP lens 170 shown in FIG. 1D may include elements that are the same as or similar to those included in the off-axis focusing PBP lens 100 shown in FIG. 1A. Detailed descriptions of the same or similar elements may refer to the above descriptions rendered in connection with FIG. 1A. As shown in FIG. 1D, the optically anisotropic film 105 may be disposed (e.g., sandwiched) between two substrates 115. At least one (e.g., each) of the substrates 115 may be provided with the PAM layer 110. In some embodiments, each of the PAM layers 110 disposed at the two substate 115 may be configured to provide a planar alignment (or an alignment with a small pretilt angle) that is in-plane patterned to provide a lens pattern. In some embodiments, the PAM layer 110 disposed at each of two the substate 115 may be configured to provide a planar alignment (or an alignment with a small pretilt angle) that is in-plane patterned to provide a lens pattern. The PAM layers 110 disposed at the two substate 115 may be configured to provide parallel surface alignments or anti-parallel surface alignments. In some embodiments, the PAM layers 110 disposed at the two substate 115 may be configured to provide hybrid surface alignments. For example, the PAM layer 110 disposed at one of two the substate 115 may be configured to provide a planar alignment (or an alignment with a small pretilt angle) that is in-plane patterned to provide a lens pattern, and the PAM layer 110 disposed at the other substate 115 may be configured to provide a homeotropic alignment. In some embodiments, an upper electrode 165 and a lower electrode 155 may be disposed at the same substate 115 (e.g., a bottom substate 115 shown in FIG. 1D). In some embodiments, the lower electrode 155 may be disposed directly on a surface of the bottom substrate 115. An electrically insulating layer 160 may be disposed between the upper electrode 165 and the lower electrode 155. The PAM layer 110 provided at the bottom substate 115 may be disposed between the upper electrode 165 and the optically anisotropic film 105. In some embodiments, the lower electrode 155 may include a planar electrode and the upper electrode 165 may include a patterned electrode (e.g., a plurality of striped interleaved electrodes arranged in parallel). A voltage may be applied to the upper electrode 165 and the lower electrode 155 disposed at the same substrate 115 (e.g., the lower substrate 115) to generate a horizontal electric field in the optically anisotropic film 105 to reorient the anisotropic molecules, thereby switching the optical properties of the off-axis focusing PBP lens 100. The horizontal electric field may realize an in-plane reorientation of the anisotropic molecules in the optically anisotropic film 105. In some embodiments, other configurations of the electrodes for generating a horizontal electric field in the optically anisotropic film 105 may be used. For example, another configuration of the electrodes may include interdigital electrodes (e.g. in-plane switching electrodes) disposed at the same substate for an in-plane switching of the anisotropic molecules. Although not shown, in some embodiments, one of the substrates 115 may be provided with the PAM layer 110, and the other one of the substrates 115 may not be provided with the PAM layer 110.

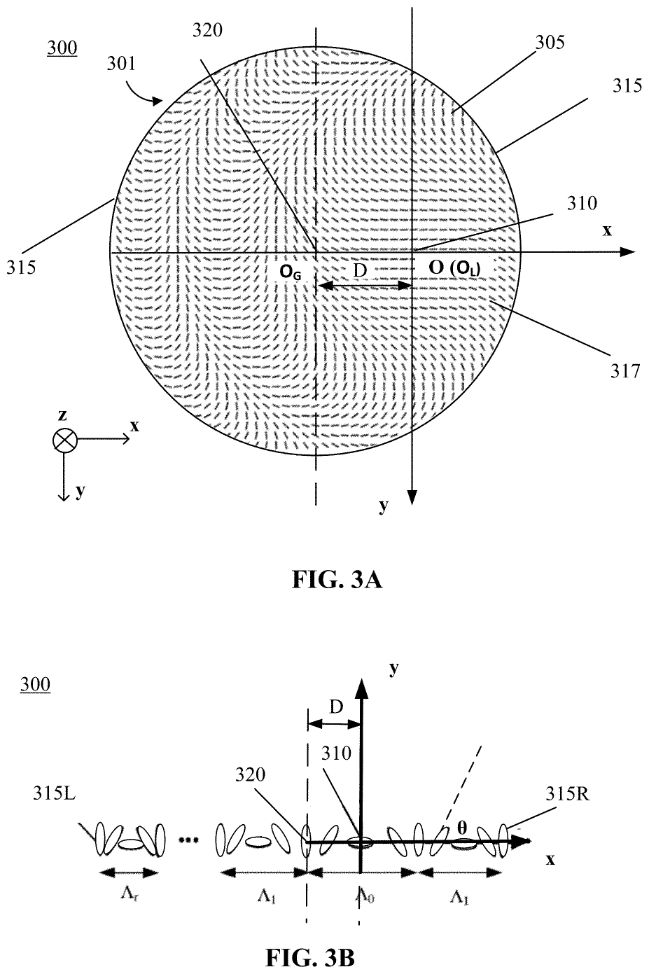

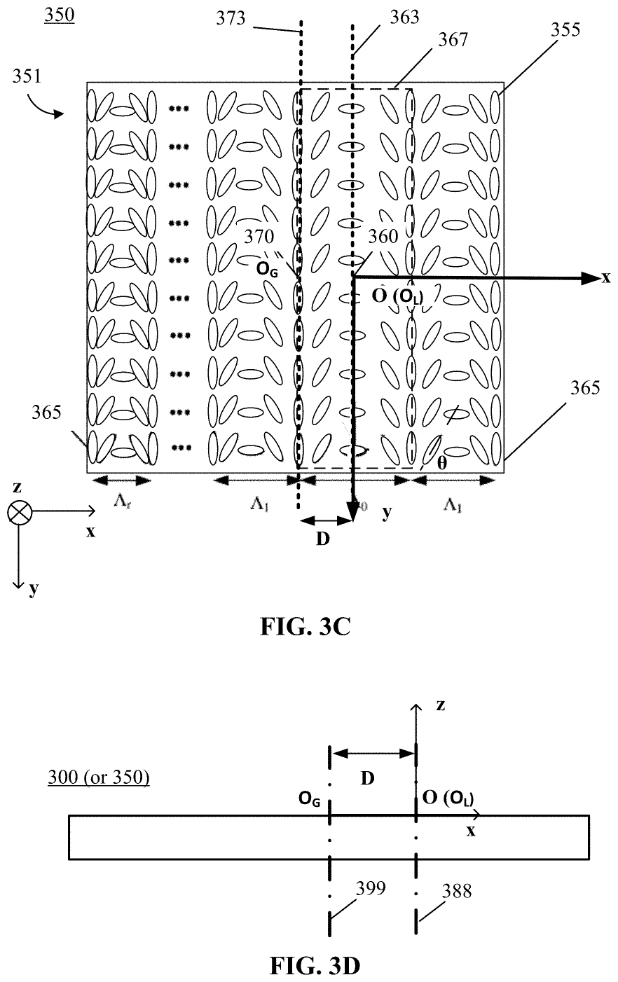

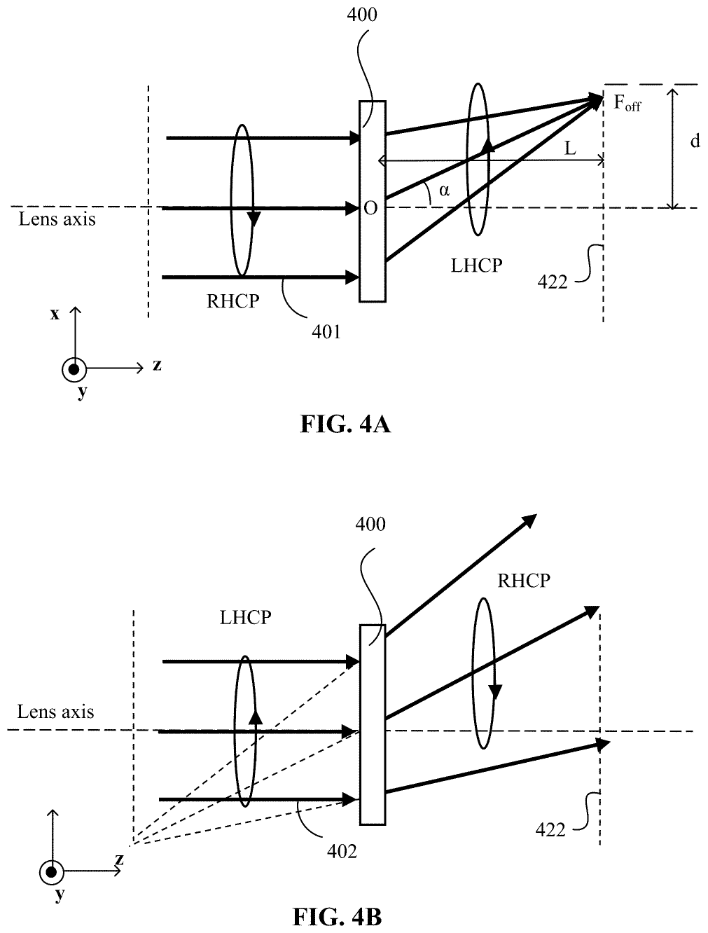

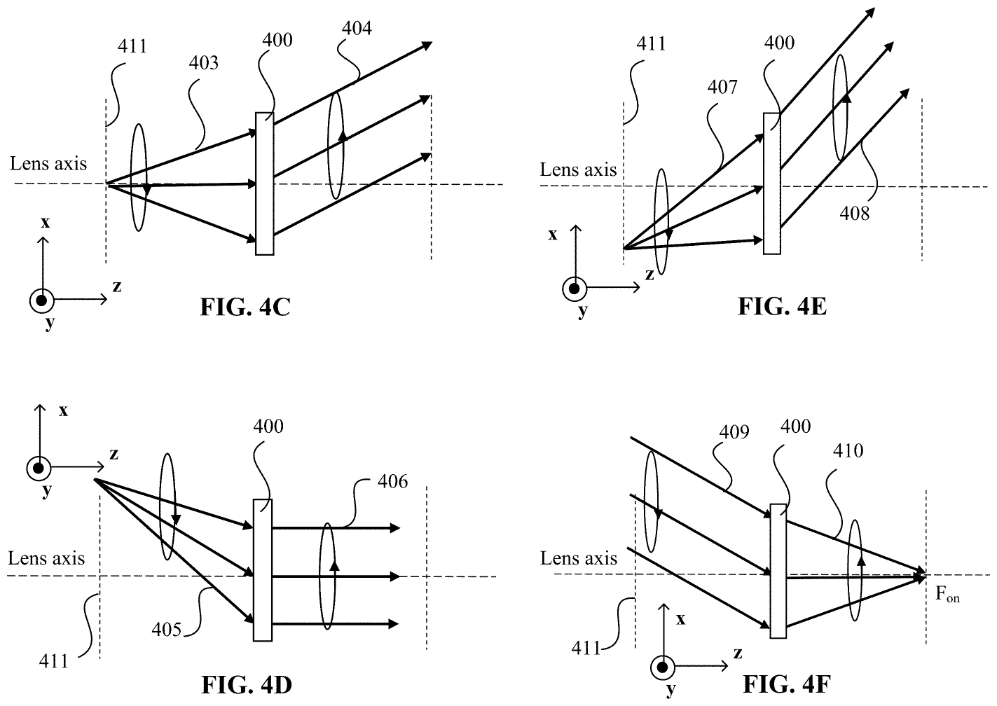

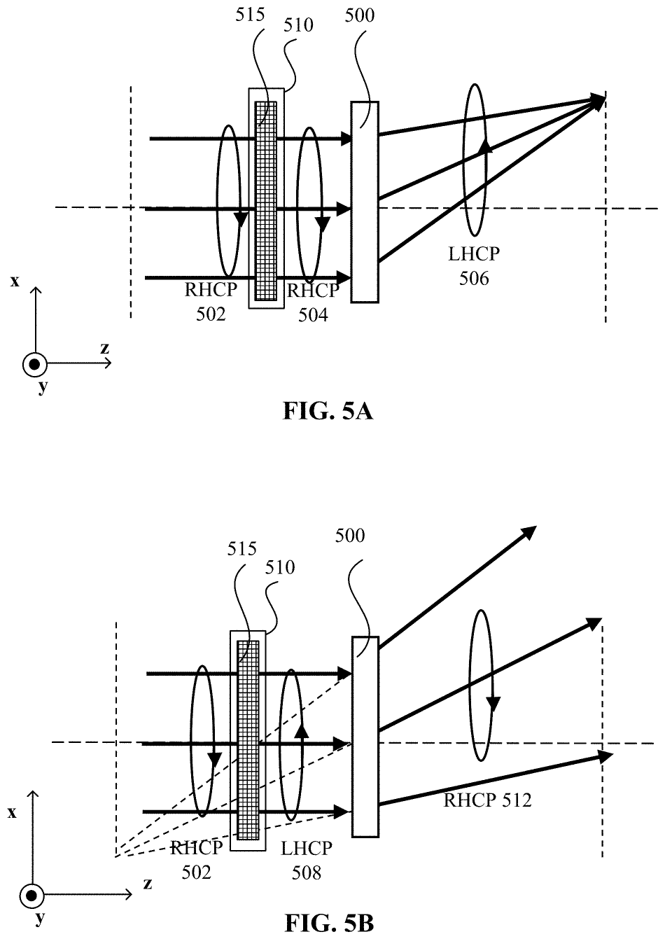

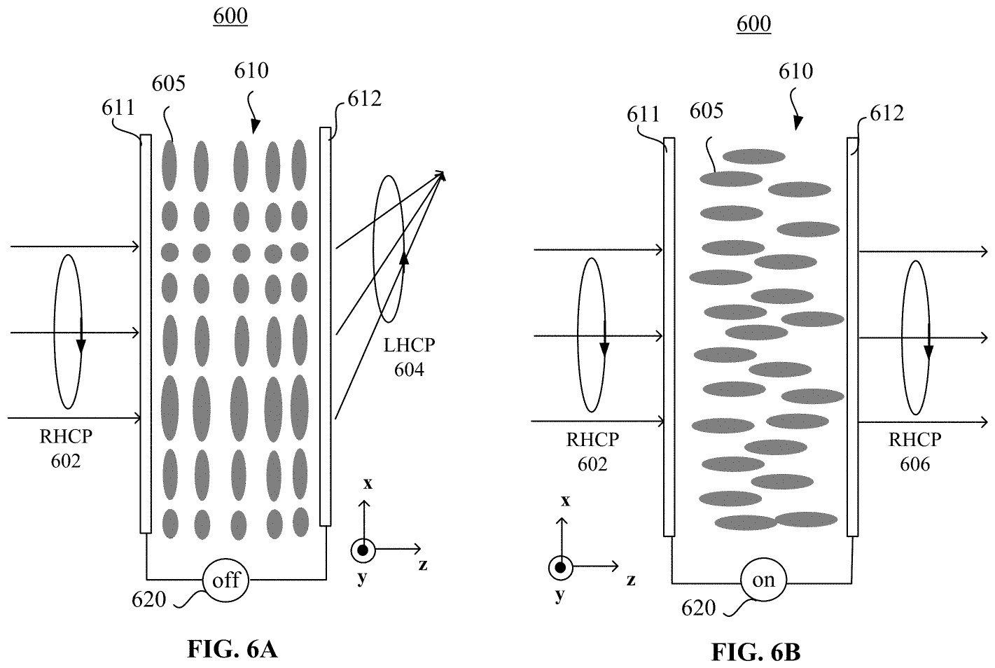

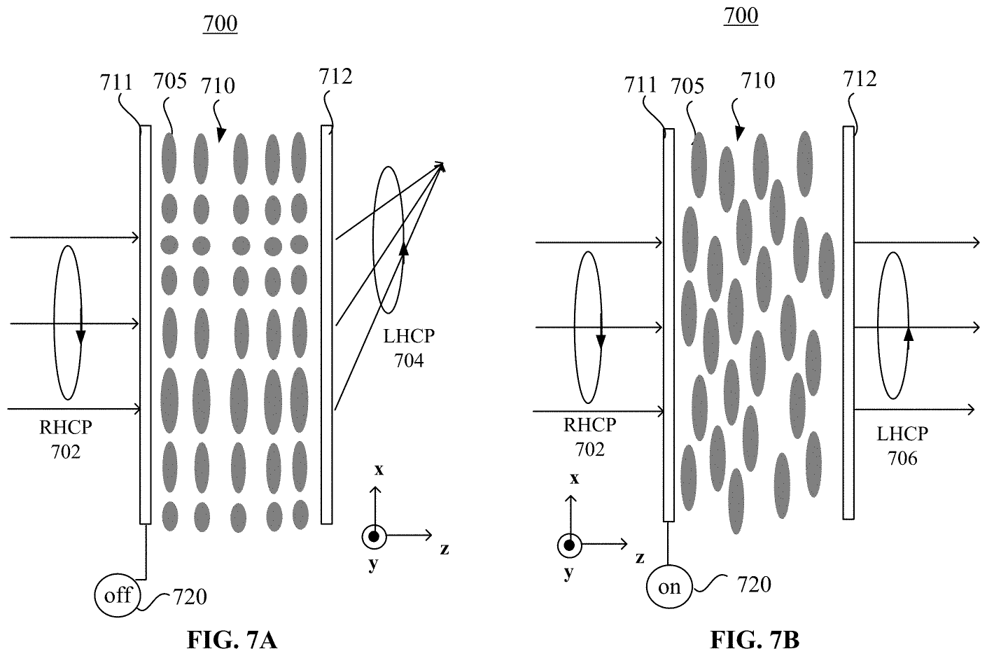

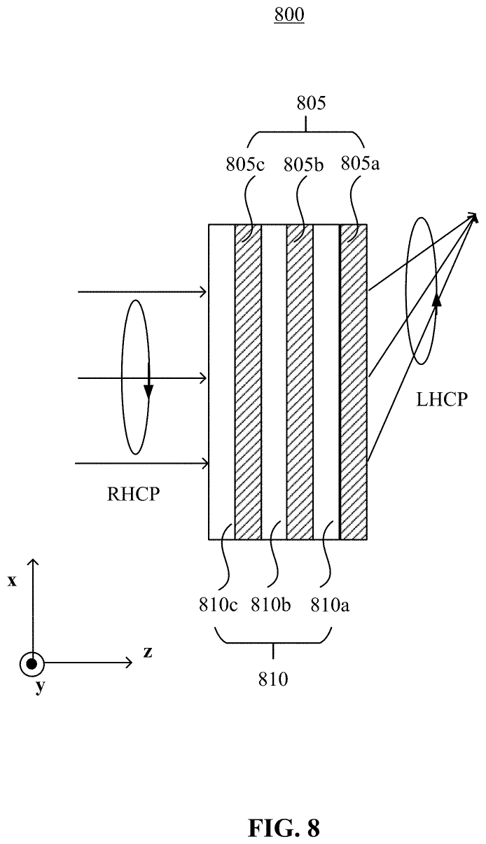

In the following, orientation of the anisotropic molecules in an off-axis focusing PBP lens will be described in detail. For discussion purposes, calamitic (rod-like) LC molecules will be used as examples of the anisotropic molecules. FIGS. 2A and 2B illustrate an LC alignment pattern in an on-axis focusing PBP lens functioning as a spherical lens (referred to as an on-axis focusing PBP spherical lens). FIG. 2C illustrates an LC alignment pattern in an on-axis focusing PBP lens functioning as a cylindrical lens (referred to as an on-axis focusing PBP cylindrical lens). FIG. 2D illustrates a side view of an on-axis focusing PBP lens shown in FIG. 2A or FIG. 2C with an out-of-plane lens pattern center axis coinciding with an out-of-plane geometry center axis passing through a geometry center of the optically anisotropic film of the lens. FIGS. 3A and 3B illustrate an LC alignment pattern in an off-axis focusing PBP lens functioning as a spherical lens (referred to as an off-axis focusing PBP spherical lens). FIG. 3C illustrates an LC alignment pattern in an off-axis focusing PBP lens functioning as a cylindrical lens (referred to as an off-axis focusing PBP cylindrical lens). FIG. 3D illustrates a side view of an off-axis focusing PBP lens shown in FIG. 3A or FIG. 3C with an out-of-plane lens pattern center axis shifted from an out-of-plane geometry center axis for a predetermined distance.

For a recorded PBP lens including an optically anisotropic film, FIG. 2A, FIG. 2C, FIG. 3A, and FIG. 3C each show a cross-sectional view (viewed in the z-axis direction or the thickness direction) of a surface plane (e.g., the x-y plane) taken at a film layer or a lens layer (e.g., a layer including the optically anisotropic film) of the PBP lens. The x-y plane represents the surface plane or a plane parallel with the surface plane of the optically anisotropic film. The x-y plane may also be a light receiving plane. That is, the light may be incident onto the lens from the z-axis direction or a direction non-parallel with the x-y plane. The z-axis is an axis perpendicular to the film layer or the lens layer, which may be in the thickness direction of the PBP lens.

FIG. 2A illustrates an LC alignment pattern (or a lens pattern) in a lens layer of an on-axis focusing PBP lens 200 functioning as a spherical lens. FIG. 2B illustrates a section of an LC director field taken along an x-axis in the on-axis focusing PBP lens 200 shown in FIG. 2A. FIG. 2A shows that the on-axis focusing PBP lens 200 has a circular shape. The origin (point “O” in FIG. 2A) of the x-y plane corresponds to a lens pattern center (O_{L}) 210 and a geometry center (O_{G}) of the effective light receiving area of the on-axis focusing PBP lens 200. That is, in the on-axis focusing PBP lens 200, the lens pattern center O_{L} may coincide with the geometry center O_{G}. For discussion purposes, the entire circular area of the lens is presumed to be the effective light receiving area (or the aperture). Thus, the geometry center (O_{G}) 220 is a center of the circular shape of the lens 200 (or of an aperture of the lens 200).

As shown in FIG. 2A, the on-axis focusing PBP lens 200 may include an optically anisotropic film 201. The optically anisotropic film 201 may include one or more birefringent materials including LC molecules 205. The lens layer refers to a layer of the optically anisotropic film 201 included in the on-axis focusing PBP lens 200. The directors of the LC molecules may be configured with a continuous in-plane rotation pattern, or the azimuthal angles of the LC molecules may be configured with a continuous in-plane changing pattern. As a result, an optic axis of the optically anisotropic film 201 may have a continuous in-plane rotation pattern. As shown in FIG. 2B, the optic axis (or the azimuthal angles of the LC molecules, or the orientation of the directors of the LC molecules) may have an in-plane rotation or orientation pattern from the lens pattern center (O_{L}) 210 to a lens periphery 215 of the on-axis focusing PBP lens 200 in a plurality of radial directions. In some embodiments, when the azimuthal angle changes in a radial direction, the azimuthal angle changing rate may not be constant along the radial direction. The azimuthal angle changing rate of the optic axis of the optically anisotropic film 201 may increase from the lens pattern center (O_{L}) 210 to the lens periphery 215 of the on-axis focusing PBP lens 200 in the radial directions. The lens pattern center (O_{L}) 210 of the on-axis focusing PBP lens 200 may be a point at which the azimuthal angle changing rate is the smallest. That is, the in-plane rotation of the optic axis of the optically anisotropic film 201 may accelerate from the lens pattern center (O_{L}) 210 to the lens periphery 215 in a plurality of radial directions.

In some embodiments, the azimuthal angle of the optic axis of the optically anisotropic film 201 may change in proportional to the distance from the lens pattern center to a local point on the optic axis. For example, the azimuthal angle of the optic axis of the optically anisotropic film 201 may change according to an equation of

$$θ = \frac{π {r}^{2}}{2 L λ} ,$$

where θ is the azimuthal angle of the optic axis at a local point of the optically anisotropic film 201, r is a distance from the lens pattern center (O_{L}) 210 of the optic lens (also the origin O of the x-y plane) to the local point in the lens plane, L is a distance between a lens plane and a focal plane of the PBP lens 200 (i.e., the focal distance in case of an on-axis focusing PBP lens), and λ is a wavelength of a light incident onto the on-axis focusing PBP lens 200. The azimuthal angle changing rate (that is a changing rate of θ or a rotational velocity of θ) is a derivative

$$\frac{d θ}{d r} = \frac{π}{L λ} r ,$$

which is zero when r=0. Thus, the point at which r=0 may be a point with the smallest rotation rate of θ or the smallest azimuthal angle changing rate.

In some embodiments, the optically anisotropic film 201 may include calamitic (rod-like) LC molecules 205. The LC molecules 205 may be aligned with directors of the LC molecules 205 (or LC directors) arranged in a continuous in-plane rotation pattern. As a result, the optic axis of the optically anisotropic film 201 may be configured in a continuous in-plane rotation pattern. As shown in FIG. 2A, the on-axis focusing PBP lens 200 may be a half-wave retarder (or half-wave plate) with LC molecules 205 aligned in a modulated in-plane alignment pattern, which may create a lens profile. Orientations of the LC directors (or azimuthal angles (θ) of the LC molecules 205) may be configured with a continuous in-plane rotation pattern with a varying pitch from a lens pattern center 210 to a lens periphery 215 in a plurality of radial directions. Thus, an optic axis of the optically anisotropic film 201 may be configured with a continuous in-plane rotation pattern with a varying pitch from the lens pattern center 210 to the lens periphery 215 in the radial directions. A pitch A of the continuous in-plane rotation is defined as a distance over which the azimuthal angle (θ) of the LC molecule 205 (or the orientation of the LC directors) changes by a predetermined amount (e.g., 180°). The pitch A of the continuous in-plane rotation may be equal to the period P of the lens pattern.

As shown in FIG. 2B, according to the LC director field along the x-axis, the pitch A may be a function of the distance from the lens pattern center 210. The pitch may monotonically decrease from the lens pattern center 210 to the lens periphery 215 in a radial direction in the x-y plane, i.e., Λ₀>Λ₁> . . . >Λᵣ, where Λ₀ is the pitch at a central region of the lens pattern including the lens pattern center 210, which may be the largest. The pitch Λᵣ is the pitch at an edge region of the lens pattern, which may be the smallest. The lens pattern center (O_{L}) 210 may be a point at which the azimuthal angle changing rate is the smallest.

In the x-y plane, the LC director of the LC molecules 205 may continuously rotate in a rotation pattern having a varying pitch (Λ₀, Λ₁, . . . , Λᵣ) along the opposite radial axes or directions, and an LC director field may have a rotational symmetry about the lens pattern center (O_{L}) 210. In the on-axis focusing PBP lens 200 shown in FIGS. 2A and 2B, the lens pattern center (O_{L}) 210 may coincide with the geometry center (O_{G}) 220 of an effective light receiving area or a lens aperture of the lens 200. In some embodiments, the geometry center may also be referred to as an aperture center. In the embodiment shown in FIG. 2A, the geometry center (O_{G}) 220 is a center of the circular shape, and coincides with the lens pattern center (O_{L}) 210. As the lens pattern center (O_{L}) 210 coincides with the geometry center (O_{G}) 220, the pitch may also be a function of the distance from the geometry center (O_{G}) 220 of the on-axis focusing PBP lens 200.

The on-axis focusing PBP lens 200 may be a PBP grating with a varying periodicity in the opposite radial directions, from the lens pattern center (O_{L}) 210 to the opposite lens peripheries 215. A period P of the lens pattern of the on-axis focusing PBP lens 200 may be defined as a distance over which the azimuthal angle θ of the optic axis of the optically anisotropic film 201 changes by π in the radial directions. Fringes of the PBP grating (i.e., the on-axis focusing PBP lens 200) may have a central symmetry about the lens pattern center (O_{L}) 210. A fringe of the PBP grating refers to a set of local points at which the azimuthal angle of the optic axis (or the rotation angle of the optic axis starting from the lens pattern center (O_{L}) 210 to the local point in the radial direction) is the same. For example, when the rotation angle of the optic axis starting from the lens pattern center (O_{L}) 210 to the local point in the radial direction is expressed as θ=θ₁+nπ (0<θ₁<π), both θ₁ and n may be the same for the local points on the same fringe. A difference in the rotation angle θ of the neighboring fringes is π, i.e., the distance between the neighboring fringes is a period P. The set of local points corresponding to the same θ may be on the same circle for an on-axis focusing PBP lens functioning as a spherical lens or an aspherical lens.

In some embodiments, the azimuthal angle (or rotation angle) θ may monotonically change approximately according to the equation

$$θ = \frac{π {r}^{2}}{2 L λ} ,$$

providing a quadratic phase shift

$$Γ = 2 θ = \frac{π {r}^{2}}{L λ}$$

for a PBP spherical lens, where r is a distance from the lens pattern center (O_{L}) 210 to a local point on the lens, and L is a distance between a lens plane and a focal plane. At a local point at which the distance r is much longer than the period P of the lens pattern (r>>P), the period P may change according to an equation

$$P \approx \frac{L λ}{2} * \frac{1}{r} .$$

That is, the period P of the lens pattern may be roughly inversely proportional to the distance r from the lens pattern center (O_{L}) 210 to the local point on the optic axis. In some embodiments, the period P of the lens pattern of an on-axis focusing PBP lens may not monotonically change (e.g., may not monotonically decrease) in the opposite radial directions from a lens pattern center (O_{L}) to opposite lens peripheries in the entire lens. Instead, the period P of the lens pattern of the on-axis focusing PBP lens may monotonically change (e.g., monotonically decrease) only in a portion of the lens including the lens pattern center (O_{L}) (less than the entire lens), in the opposite radial directions from a lens pattern center (O_{L}) to opposite lens peripheries. Accordingly, the on-axis focusing PBP lens may functions as an aspherical PBP lens (referred to as an on-axis focusing PBP aspherical lens). For example, the period P of the lens pattern of the on-axis focusing PBP aspherical lens may first decrease then increase in the radial directions from the lens pattern center (O_{L}) to the lens periphery. The lens pattern center (O_{L}) may correspond to a geometry center in the on-axis focusing PBP aspherical lens.

FIG. 2C illustrates an LC alignment pattern in a lens layer of an on-axis focusing PBP lens 250 functioning as an on-axis focusing cylindrical lens. The on-axis focusing PBP lens functioning as an on-axis focusing cylindrical lens may have a rectangular shape at a surface plane (i.e., the x-y plane). The on-axis focusing PBP lens 250 may include an optically anisotropic film 251 that includes one or more birefringent materials including LC molecules 255. The lens layer refers to a layer of the optically anisotropic film 251 included in the on-axis focusing PBP lens 250. The origin (point “O” in FIG. 2C) of the x-y plane corresponds to a lens pattern center (O_{L}) 260. The lens pattern center (O_{L}) 260 may be a point at which the azimuthal angle changing rate is the smallest. A geometry center (O_{G}) 270 of the on-axis focusing PBP lens 250 may be the center of the rectangular lens shape. The lens pattern center (O_{L}) 260 and the geometry center (O_{G}) 270 of the on-axis focusing PBP lens 250 may be located on a same symmetric axis (e.g., the lateral symmetric axis) of the on-axis focusing PBP lens 250 (e.g., the x-axis). In the on-axis focusing PBP lens 250, the geometry center (O_{G}) 270 may coincides with the lens pattern center (O_{L}) 260.

For the on-axis focusing PBP lens 250 having a rectangular shape (or a rectangular lens aperture), a width direction of the on-axis focusing PBP lens 250 may be referred to as a lateral direction (e.g., an x-axis direction in FIG. 2C), and a length direction of the on-axis focusing PBP lens 250 may be referred to as a longitudinal direction (e.g., a y-axis direction in FIG. 2C). An in-plane lens pattern center axis 263 may be an axis parallel to the longitudinal direction in the surface plane (e.g., x-y plane) and passing through the lens pattern center (O_{L}) 260. The in-plane lens pattern center axis 263 may be parallel to the y-axis direction, as shown in FIG. 2C. An in-plane geometry center axis 273 of the on-axis focusing PBP lens 250 may be an axis parallel to the longitudinal direction in the surface plane (e.g., x-y plane) and passing through the geometry center (O_{G}) 270. In the embodiment shown in FIG. 2C, the in-plane lens pattern center axis 263 may coincide with the in-plane geometry center axis 273.

An optic axis of the optically anisotropic film 251 may be configured with a continuous in-plane rotation pattern from the lens pattern center (O_{L}) 260 to a lens periphery 265 of the on-axis focusing PBP lens 250 in the lateral direction (e.g., the x-axis direction). An azimuthal angle changing rate of the optic axis of the optically anisotropic film 251 may increase from the lens pattern center (O_{L}) 260 to the lens periphery 265 in the lateral direction. That is, the continuous in-plane rotation of the optic axis of the optically anisotropic film of the on-axis focusing PBP lens 250 may accelerate from the lens pattern center (O_{L}) 260 to the lens periphery 265 in the lateral direction. The azimuthal angles of the optic axis at locations on the same side of the in-plane lens pattern center axis 263 and having a same distance from the in-plane lens pattern center axis 263 in the lateral direction, may be substantially the same.

The on-axis focusing PBP lens 250 may be a PBP grating with a varying periodicity in the opposite lateral directions from the in-plane lens pattern center axis 263 to the opposite lens periphery 265 (e.g., to the left side lens periphery and to the right side lens periphery). A period P of the lens pattern of the on-axis focusing PBP lens 250 may be defined as a distance over which the azimuthal angle θ of the optic axis of the optically anisotropic film 251 changes by π in the radial directions. Fringes of the PBP grating may have an axial symmetry about the in-plane lens pattern center axis 263. The alignment pattern of the PBP grating may be asymmetric about the in-plane lens pattern center axis 263. A fringe of the PBP grating (i.e., the on-axis focusing PBP lens 250) refers to a set of local points at which the azimuthal angle of the optic axis (or the rotation angle of the optic axis starting from the in-plane lens pattern center axis 263 to the local point in the lateral direction) is the same. For example, when the rotation angle of the optic axis from the in-plane lens pattern center axis 263 to the local point in the lateral direction is expressed as θ=θ₁+nπ (0<θ₁<π), both θ₁ and n may be the same for the local points on the same fringe. A difference in the rotation angles of the neighboring fringes is π, i.e., the distance between the neighboring fringes is the period P. The set of local points may be on the same line parallel to the longitudinal direction for the on-axis focusing PBP lens 250 functioning as cylindrical lens.

In some embodiments, the on-axis focusing PBP lens 250 functioning as a cylindrical lens may be considered to have a central symmetry of fringes and alignment pattern with respect to the lens pattern center in the two opposite lateral directions (and in some embodiments, only in the two opposite lateral directions). The equation

$$θ = \frac{π {r}^{2}}{2 L λ}$$

and corresponding phase shift equation

$$Γ = 2 θ = \frac{π {r}^{2}}{L λ}$$

for a PEP spherical lens may also be applied to the on-axis focusing PBP lens 250 functioning as a cylindrical lens, but only in the two opposite lateral directions. That is, r is a distance from the lens pattern center (O_{L}) 260 to a local point of the on-axis focusing PBP lens 250 in the two opposite lateral directions. In this sense, cylindric lens can be considered as a 1d case of spherical lens.

In some embodiments, the optically anisotropic film 251 may include calamitic (rod-like) LC molecules 255. The directors of the LC molecules 255 (LC directors) may continuously rotate within the surface plane, resulting in a continuous in-plane rotation of the optic axis. As shown in FIG. 2C, the on-axis focusing PBP lens 250 may be a half-wave retarder (or half-wave plate) with LC molecules 255 aligned in a modulated in-plane alignment pattern, which may create a lens profile. Directors of the LC molecules 255 (or azimuthal angles (θ) of the LC molecules 255) may be configured with a continuous in-plane rotation pattern with a varying pitch (Λ₀, Λ₁, . . . , Λᵣ) from the lens pattern center (O_{L}) 260 to the lens periphery 265 in the lateral direction (e.g., an x-axis direction in FIG. 2C). The orientations of the directors of the LC molecules 255 (the LC directors) located on the same side of the in-plane lens pattern center axis 263 and at a same distance from the in-plane lens pattern center axis 263 may be substantially the same. As shown in FIG. 2C, the pitch of the lens pattern may be a function of the distance to the in-plane lens pattern center axis 263 in the lateral direction. In some embodiments, the pitch of the lens pattern may monotonically decrease as the distance to the in-plane lens pattern center axis 263 in the lateral direction increases, i.e., Λ₀>Λ₁> . . . >Λᵣ, where Λ₀ is the pitch at a central portion of the lens pattern, which may be the largest. The pitch Λᵣ is the pitch at an edge region of the lens pattern, which may be the smallest.

FIG. 2D illustrates a side view of an on-axis focusing PBP lens, which may be the on-axis focusing PBP lens 200 or the on-axis focusing PBP lens 250. The side view shows an out-of-plane lens pattern center axis 288 and an out-of-plane geometry center axis 299 passing through the lens pattern center O_{L} and the geometry center O_{G}, respectively. The out-of-plane lens pattern center axis 288 and the out-of-plane geometry center axis 299 may be perpendicular to the surface plane (e.g., the x-y plane). That is, the out-of-plane lens pattern center axis 288 and the out-of-plane geometry center axis 299 may be in the z-axis direction or the thickness direction of the lens. For the on-axis focusing PBP lens, because the lens pattern center O_{L} and the geometry center O_{G} coincide with one another, the out-of-plane lens pattern center axis 288 and the out-of-plane geometry center axis 299 also coincide with one another.

FIG. 3A illustrates an LC alignment pattern in a lens layer of an optically anisotropic film 301 included in an off-axis focusing PBP lens 300 according to an embodiment of the present disclosure. The x-y plane may be a light receiving plane of the optically anisotropic film 301. The off-axis focusing PBP lens 300 may function as a spherical lens. FIG. 3A shows that the off-axis focusing PBP lens 300 has a circular shape. The origin (point “O” in FIG. 3A) of the x-y plane corresponds to a lens pattern center (O_{L}) 310 of the off-axis focusing PBP lens 300. A geometry center (O_{G}) 320 of the lens may be the center of the circular shape of the lens. As shown in FIG. 3A, in the off-axis focusing PBP lens 300, the lens pattern center (O_{L}) 310 is shifted from the geometry center (O_{G}) 320 in a predetermined direction (e.g., the x-axis direction) for a predetermined distance D.

The optically anisotropic film 301 may include one or more birefringent materials including LC molecules 305. An optic axis of the optically anisotropic film 301 may be configured with a continuous in-plane rotation (or rotation pattern) from the lens pattern center (O_{L}) 310 to a lens periphery 315 of the off-axis focusing PBP lens 300 in a plurality of radial directions. That is, the directors of the optically anisotropic molecules included in the optically anisotropic film 301 may continuously rotate along a plurality of radial directions. In other words, the azimuthal angles of the optically anisotropic molecules of the optically anisotropic film 301 may continuously change in a plurality of radial directions. An azimuthal angle changing rate of the optic axis of the optically anisotropic film 301 may increase from the lens pattern center (O_{L}) 310 to the lens periphery 315 of the off-axis focusing PBP lens 300 in the radial directions. The lens pattern center (O_{L}) 310 of the off-axis focusing PBP lens 300 may be a point at which the azimuthal angle changing rate is the smallest. That is, the in-plane rotation of the optic axis of the optically anisotropic film 301 may accelerate from the lens pattern center (O_{L}) 310 to the lens periphery 315 in the radial directions. In some embodiments, the azimuthal angle of the optic axis of the optically anisotropic film 301 may be proportional to the distance from the lens pattern center (O_{L}) 310 (also the origin O of the x-y plane) to the local point in the lens plane.

For example, the azimuthal angle θ of the optic axis of the optically anisotropic film 301 in the off-axis focusing PBP lens 300 functioning as a spherical lens may change approximately according to an equation of

$$θ = \frac{Γ}{2} = \frac{π {r}^{2}}{2 L λ} ,$$

where θ is the azimuthal angle of the optic axis at a local point of the optically anisotropic film 301, r is a distance from the lens pattern center (O_{L}) 310 (also the origin O of the x-y plane) to the local point on the optic axis, L is a distance between a lens plane and a focal plane of the off-axis focusing PBP lens 300, and λ is a wavelength of a light incident onto the off-axis focusing PBP lens 300, is a phase shift experienced by a light incident onto the lens with a wavelength k. The azimuthal angle changing rate (that is a changing rate of θ or a rotational velocity of θ) is a derivative

$$\frac{d θ}{d r} = \frac{π}{L λ} r ,$$

which is zero when r=0. Thus, the point at which r=0 may be a point with the smallest rotation rate of θ or the smallest azimuthal angle changing rate.

In some embodiments, the optically anisotropic film 301 may include calamitic (rod-like) LC molecules 305. The directors of the LC molecules 305 (LC directors) may continuously rotate in a surface plane (e.g., the x-y plane) in a continuous in-plane rotation pattern. As a result, the optic axis of the optically anisotropic film 301 may have a continuous in-plane rotation (or rotation pattern). As shown in FIG. 3A, the off-axis focusing PBP lens 300 may be a half-wave retarder (or half-wave plate) configured with a lens profile based on an alignment pattern of the LC molecules 305 in the surface plane (e.g., alignment pattern of the LC molecules 305 in the x-y plane shown in FIG. 3A). An azimuthal angle (θ) characterizing the alignment of LC directors may continuously vary from the lens pattern center (O_{L}) 310 to a lens periphery 315 of the off-axis focusing PBP lens 300, with a varying pitch A. The continuous in-plane rotation of the LC directors refers to the continuous variation or change of the azimuthal angle (θ) of the LC molecules 305 in the x-y plane. As shown in FIG. 3A, the lens pattern center (O_{L}) 310 of the off-axis focusing PBP lens 300 may not coincide with the geometry center (O_{G}) 320. Instead, the lens pattern center (O_{L}) 310 of the off-axis focusing PBP lens 300 may be shifted by a predetermined distance D in a predetermined direction from the geometry center (O_{G}) 320. The shifting direction and the distance D of the shift may be determined based on a desirable position of a focus (focal point) at a focal plane of the off-axis focusing PBP lens 300. That is, the deviation of the focus of the off-axis focusing PBP lens 300 may be determined by the shifting direction and the distance D of the shift. The entire lens pattern of the off-axis focusing PBP lens 300 may be rotationally centrally asymmetric with respect to either one of the lens pattern center (O_{L}) 310 or the geometry center (O_{G}) 320. A predetermined portion of the entire lens pattern (e.g., less than the entire lens pattern) of the off-axis focusing PBP lens 300 may be rotationally centrally symmetric with respect to the lens pattern center (O_{L}) 310. FIG. 3A shows that the lens pattern center (O_{L}) 310 of the off-axis focusing PBP lens 300 is shifted by a distance D in the +x direction from the geometry center (O_{G}) 320 of the off-axis focusing PBP lens 300. This shift is for illustrative purposes and is not intended to limit to the scope of the present disclosure. The shift may be in any other suitable directions and for any other suitable distances. For example, in some embodiments, the lens pattern center (O_{L}) 310 may be shifted by a predetermined distance in the −x-axis direction from the geometry center (O_{G}) 320. In some embodiments, the predetermined direction may be other directions.

FIG. 3B illustrates a section of an LC director field taken along an x-axis in the off-axis focusing PBP lens 300 shown in FIG. 3A. As shown in FIG. 3B, according to the LC director field along the x-axis, the pitch may be a function of a distance from the lens pattern center (O_{L}) 310. Because the lens pattern center (O_{L}) 310 does not coincide with the geometry center (O_{G}) 320, the pitch may be expressed as a function of the distance from the lens pattern center (O_{L}) 310 of the off-axis focusing PBP lens 300 in the radial directions from the origin O (located at the lens pattern center O_{L}). As shown in FIG. 3B, the pitch may monotonically decrease as the distance from the lens pattern center (O_{L}) 310 increases in the radial direction (e.g., the x-axis direction). For example, the pitch in a central region including the lens pattern center (O_{L}) 310 may be Λ₀, which may be the largest. The pitch in first edge region at a first edge 315R (e.g., a right edge in FIG. 3B) may be Λ₁, which may be smaller than Λ₀. The pitch at a second edge region including a second edge 315L (e.g., a left edge in FIG. 3B) may be Λᵣ, which may be the smallest, i.e., Λ₀>Λ₁> . . . >Λᵣ.

In some embodiments, the origin (point “O” in FIG. 3A) of the x-y plane may be configured at the geometry center (O_{G}) 320 of the off-axis focusing PBP lens 300 instead of at the lens pattern center (O_{L}) 310. When the off-axis focusing PBP lens 300 provides a parabolic phase profile, and when the lens pattern center (O_{L}) 310 is shifted with respect to the geometry center (O_{G}) 320 of the off-axis focusing PBP lens 300 along the x-axis, a phase shift experienced by a light with a wavelength λ incident onto the off-axis focusing PBP lens 300 may be expressed as

$$Γ \approx \frac{π {r}^{2}}{L λ} - \frac{2 π}{λ} K * x ,$$

where K is a lion-zero coefficient, r is a distance from the lens pattern center (O_{L}) 310 of the off-axis focusing PBP lens 300 to a local point of the off-axis focusing PBP lens 300, L is a distance between a lens plane and a focal plane of the of the off-axis focusing PBP lens 300, and x is a coordinate in the predetermined direction of the predetermined shift of the lens pattern center (O_{L}) 310 with respect to the geometry center (O_{G}). The corresponding equation for the azimuthal angle θ is

$$θ = \frac{Γ}{2} \approx \frac{π {r}^{2}}{2 L λ} - \frac{π}{λ} K * x .$$

The first term

$$\frac{π {r}^{2}}{2 L λ}$$

corresponds to an optical power of the off-axis focusing PBP lens 300, and the second term corresponds to a shift of the lens pattern center (O_{L}) 310 with respect to the geometry center (O_{G}). The azimuthal angle changing rate in a shifting direction (e.g., an x-axis direction, r=x) may be calculated according to

$$\frac{d θ}{d x} = \frac{π}{λ} * ( \frac{x}{L} - K ) .$$

The azimuthal angle changing rate may be the smallest at a point

$${x}_{c} = D = KL when \frac{d θ}{d x} = 0 .$$

A phase shift experienced by the light with the wavelength λ incident onto an on-axis focusing PBP lens corresponding to the off-axis focusing PBP lens 300 may be expressed as

$$Γ \approx \frac{π {r}^{2}}{L λ} .$$

The off-axis focusing PBP lens 300 may be a PBP grating with a varying periodicity in the opposite radial directions, from the lens pattern center (O_{L}) 310 to the opposite lens peripheries 315. A period P of the lens pattern of the off-axis focusing PBP lens 300 may be defined as a distance over which the azimuthal angle θ of the optic axis of the optically anisotropic film 301 changes by π in the radial directions. Fringes of the PBP grating over the entire PBP grating may not have a central symmetry about the lens pattern center (O_{L}) 310. Fringes of the PBP grating in a predetermined region of the entire PBP grating including the lens pattern center (O_{L}) 310 may have a central symmetry with respect to the lens pattern center center (O_{L}) 310. A fringe of the PBP grating (i.e., the off-axis focusing PBP lens 300) refers to a set of local points at which the azimuthal angle of the optic axis (or the rotation angle of the optic axis starting from the lens pattern center (O_{L}) 310 to the local point in the radial direction) is the same. For example, when the rotation angle of the optic axis starting from the lens pattern center (O_{L}) 310 to the local point in the radial direction is expressed as θ=θ₁+nπ (0<θ₁<π), both θ₁ and n may be the same for the local points on the same fringe. A difference in the rotation angles of the neighboring fringes is π, i.e., the distance between the neighboring fringes is a period P. The set of local points may be on the same circle for an off-axis focusing PBP lens functioning as a spherical lens or an aspherical lens.

In some embodiments, when the azimuthal angle θ of the optic axis changes approximately according to the equation

$$θ = \frac{π {r}^{2}}{2 L λ} ,$$

the period P of the lens pattern may change approximately according to an equation

$$P \approx \frac{L λ}{2} * \frac{1}{r} .$$

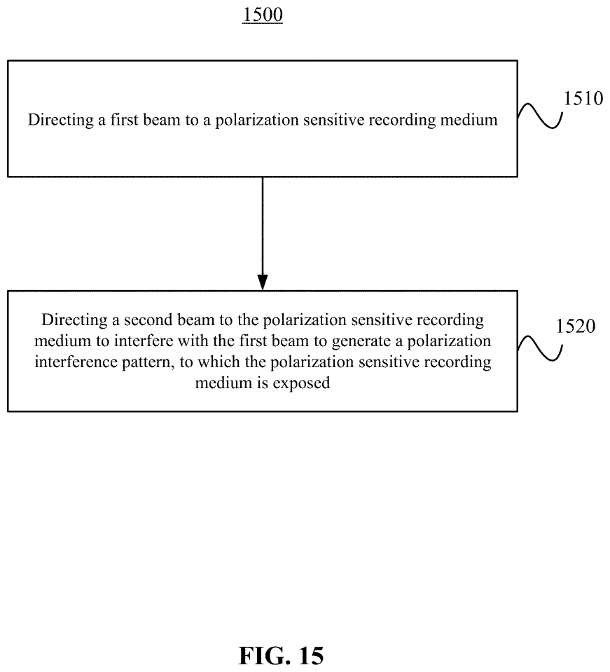

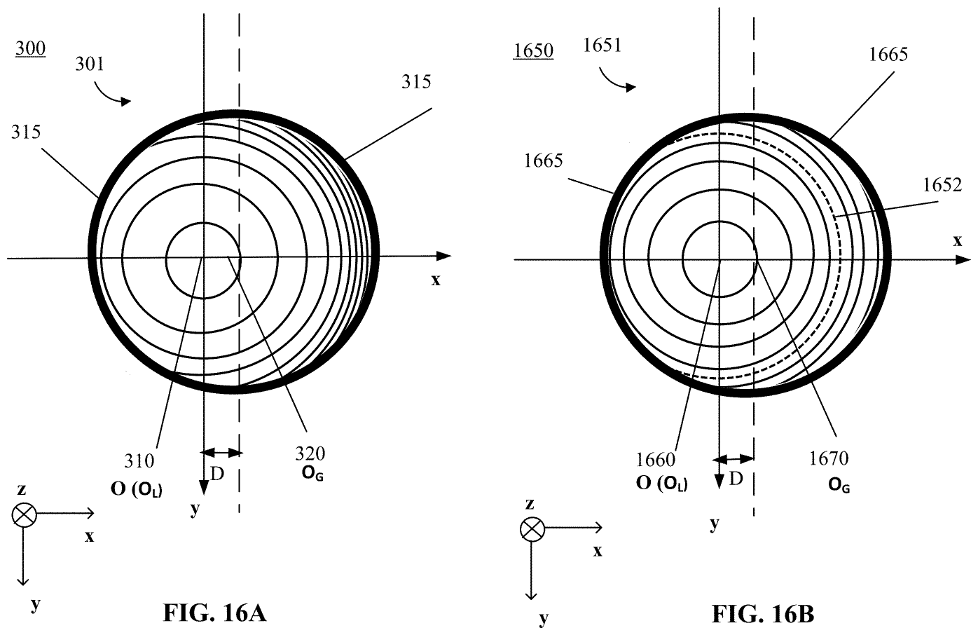

The period P may be roughly inversely proportional to the distance r from the lens pattern center (O_{L}) 310 to the local point on the optic axis, when the distance r from the lens pattern center (O_{L}) 310 is much larger than the period P of the lens pattern (r>>P). In some embodiments, the period P of the lens pattern of the off-axis focusing PBP lens 300 may monotonically change (e.g., monotonically decrease) in the entire off-axis focusing PBP lens from the lens pattern center (O_{L}) 310 in the opposite radial directions, i.e., from the lens pattern center (O_{L}) 310 to the opposite lens peripheries 315. Accordingly, the off-axis focusing PBP lens 300 may function as a spherical PBP lens. FIG. 16A illustrates configuration of fringes and a varying periodicity of the off-axis focusing PBP spherical lens 300 shown in FIGS. 3A and 3B, according to an embodiment of the present disclosure. FIG. 16A illustrates an x-y sectional view of the lens layer of the optically anisotropic film 301 of the off-axis focusing PBP spherical lens 300 shown in FIGS. 3A and 3B, and does not show the LC molecules. Circles or arcs in FIG. 16A represent grating fringes. Local points of the optic axis on the same grating fringe may have the same azimuthal angle θ (or rotation angle). Local points of the optic axis on two adjacent grating fringes may have a change of π in the azimuthal angle θ. Thus, a difference between the radii of two adjacent grating fringes may represent the period P of the lens pattern of the off-axis focusing PBP lens 300. As shown in FIG. 16A, the period P of the lens pattern of the off-axis focusing PBP spherical lens 300 may monotonically change (e.g., monotonically decrease) in the entire off-axis focusing PBP lens 300 from the lens pattern center (O_{L}) 310 in the opposite radial directions, i.e., from the lens pattern center (O_{L}) 310 to the opposite lens peripheries 315.

In some embodiments, the period P of the lens pattern of an off-axis focusing PBP lens may not monotonically change (e.g., may not monotonically decrease) in the opposite radial directions from a lens pattern center (O_{L}) to opposite lens peripheries. Instead, the period P of the lens pattern of the off-axis focusing PBP lens may monotonically change (e.g., monotonically decrease) only in a portion of the lens including the lens pattern center (O_{L}) (less than the entire lens), in the opposite radial directions from a lens pattern center (O_{L}) to opposite lens peripheries. Accordingly, the off-axis focusing PBP lens may function as an aspherical PBP lens (referred to as an off-axis focusing PBP aspherical lens). For example, the period P of the lens pattern of the off-axis focusing PBP aspherical lens may first decrease then increase in the radial directions from the lens pattern center (O_{L}) to the lens periphery. The lens pattern center (O_{L}) of the off-axis focusing PBP aspherical lens may not correspond to a geometry center of the off-axis focusing PBP aspherical lens.

FIG. 16B illustrates configuration of fringes and a varying periodicity of an off-axis focusing PBP aspherical lens 1450, according to an embodiment of the present disclosure. FIG. 16B illustrates an x-y sectional view of a lens layer of an optically anisotropic film 1451 of the off-axis focusing PBP spherical lens 1450, and does not show the LC molecules. Circles or arcs in FIG. 16A represent grating fringes. Local points of the optic axis on the same grating fringe may have the same azimuthal angle θ. Local points of the optic axis on two adjacent grating fringes may have a change of it in the azimuthal angle θ. Thus, a difference between the radii of two adjacent grating fringes may represent the period P of the lens pattern of the off-axis focusing PBP aspherical lens 1450. As shown in FIG. 16B, the period P of the lens pattern of the off-axis focusing PBP aspherical lens 1450 may not monotonically change (e.g., monotonically decrease) in the entire lens in the opposite radial directions from a lens pattern center (O_{L}) 1460 to opposite lens peripheries 1465. Instead, the period P of the lens pattern of the off-axis focusing PBP aspherical lens 1450 may first decrease then increase in the radial directions. For illustrate purposes, FIG. 16B shows the period P of the lens pattern of the off-axis focusing PBP aspherical lens 1450 may monotonically decrease only in a portion of the lens including lens pattern center (O_{L}) 1460 in the opposite radial directions, for example, within an area of the lens enclosed by a grating fringe 1452. Outside the area of the lens enclosed by a grating fringe 1452, the period P of the lens pattern of the off-axis focusing PBP aspherical lens 1450 may monotonically increase in the opposite radial directions. Although not shown, in some embodiments, the period P of the lens pattern of the off-axis focusing PBP aspherical lens 1450 may first decrease, then increase, then decrease again, and so on, in the opposite radial directions.

FIG. 3C illustrates an LC alignment pattern in a lens layer of an optically anisotropic film 351 included in an off-axis focusing PBP lens 350 functioning as an off-axis focusing cylindrical lens. The optically anisotropic film 351 may include one or more birefringent materials including LC molecules (small molecules) or mesogenic fragments (LC polymers) 355. The off-axis focusing PBP lens 350 may have a rectangular shape (or a rectangular lens aperture). The origin (point “O” in FIG. 3C) of the x-y plane may correspond to a lens pattern center (O_{L}) 360. A geometry center (O_{G}) 370 may be the center of the rectangular lens shape of the off-axis focusing PBP lens 350. As shown in FIG. 3C, the lens pattern center (O_{L}) 360 may be shifted from the geometry center (O_{G}) 370 for a predetermined distance D (or a shift D) in a predetermined in-plane direction (e.g., the x-axis direction). The lens pattern center (O_{L}) 360 and the geometry center (O_{G}) 370 of the off-axis focusing PBP lens 350 may be located on a same symmetric axis (e.g., the lateral symmetric axis) of the aperture of the off-axis focusing PBP lens 350 (e.g., the x-axis).

For the off-axis focusing PBP lens 350 having a rectangular shape (or a rectangular lens aperture), a width direction of the off-axis focusing PBP lens 350 may be referred to as a lateral direction (e.g., an x-axis direction in FIG. 3C), and a length direction of the off-axis focusing PBP lens 350 may be referred to as a longitudinal direction (e.g., a y-axis direction in FIG. 3C). An in-plane lens pattern center axis 363 may be an axis parallel with the longitudinal direction and passing through the lens pattern center (O_{L}) 360. An in-plane geometry center axis 373 may be an axis parallel with the longitudinal direction and passing through the geometry center (O_{G}) 370. The in-plane lens pattern center axis 363 and the in-plane geometry center axis 373 are parallel with one another and separated from one another with the predetermined distance D in the predetermined direction.

An optic axis of the optically anisotropic film 351 may be configured with a continuous in-plane rotation from the lens pattern center (O_{L}) 360 to a lens periphery 365 of the off-axis focusing PBP lens 350 in the lateral direction. An azimuthal angle changing rate of the optic axis of the optically anisotropic film 351 may increase from the lens pattern center (O_{L}) 360 to the lens periphery 365 of the off-axis focusing PBP lens 350 in the lateral direction. That is, the continuous in-plane rotation of the optic axis of the optically anisotropic film 351 of the off-axis focusing PBP lens 350 may accelerate from the lens pattern center (O_{L}) 360 to the lens periphery 365 in the lateral direction. The azimuthal angles of the optic axis at locations on the same side of the in-plane lens pattern center axis 363 and having a same distance from the in-plane lens pattern center axis 363 in the lateral direction may be substantially the same.

In some embodiments, the optically anisotropic film 351 may include calamitic (rod-like) LC molecules 355. The directors of the molecules 355 (or LC directors) may continuously rotate in a predetermined in-plane direction in the surface plane of the optically anisotropic film 351. The in-plane continuous rotation of the directors of the molecules 355 may result in a continuous in-plane rotation (or rotation pattern) of the optic axis of the optically anisotropic film 351. As shown in FIG. 3C, the off-axis focusing PBP lens 300 may be a half-wave retarder (or half-wave plate) with LC molecules 355 arranged in a modulated in-plane alignment pattern, which may create a lens profile. Directors of the LC molecules 355 (or azimuthal angles (θ) of the LC molecules 355) may be configured with a continuous in-plane rotation with a varying pitch (Λ₀, Λ₁, . . . , Λᵣ) from the lens pattern center (O_{L}) 360 to the lens periphery 365 in the lateral direction (e.g., an x-axis direction in FIG. 3C). The orientations of the directors of the LC molecules 355 (the LC directors) located on the same side of the in-plane lens pattern center axis 363 and at a same distance from the in-plane lens pattern center axis 363 may be substantially the same. As shown in FIG. 3C, the pitch of the lens pattern (or the optic axis pattern) may be a function of the distance from the in-plane lens pattern center axis 363 in the lateral direction. The pitch of the lens pattern may monotonically decrease as the distance from the in-plane lens pattern center axis 363 in the lateral direction (e.g., the x-axis direction) increases. For example, the pitch at the region labelled by a dashed rectangle 367 including the lens pattern center (O_{L}) 360 may be Λ₀, which may be the largest. The pitch at a region including the lens periphery 365 (e.g., a right lens periphery in FIG. 3C) may be Λ₁, which may be smaller than Λ₀. The pitch at a region including the lens periphery 365 (e.g., a left lens periphery in FIG. 3C) may be Λᵣ, which may be the smallest, i.e., Λ₀>Λ₁> . . . >Λᵣ.

In the optically anisotropic film 351 shown in FIG. 3C, the lens pattern center (O_{L}) 360 of the off-axis focusing PBP lens 350 may not coincide with the geometry center (O_{G}) 370. Instead, the lens pattern center (O_{L}) 360 of the off-axis focusing PBP lens 350 may be shifted by a predetermined distance D in a predetermined direction from the geometry center (O_{G}) 370 of the off-axis focusing PBP lens 350. Accordingly, the in-plane lens pattern center axis 363 of the off-axis focusing PBP lens 350 may not coincide with the in-plane geometry center axis 373 of the off-axis focusing PBP lens 350. Instead, the in-plane lens pattern center axis 363 of the off-axis focusing PBP lens 350 may be shifted by a predetermined distance D in a predetermined direction from the in-plane geometry center axis 373 of the off-axis focusing PBP lens 350. The shifting direction and the distance D of the shift may be determined based on a desirable position of a focal line at a focal plane of the off-axis focusing PBP lens 350. That is, the deviation of the focal line of the off-axis focusing PBP lens 350 may be determined by the shifting direction and the distance D of the shift. In the embodiment shown in FIG. 3C, the lens pattern center (O_{L}) 360 of the off-axis focusing PBP lens 300 is shifted by a distance D in the +x direction from the geometry center (O_{G}) 370 of the off-axis focusing PBP lens 350. Accordingly, the in-plane lens pattern center axis 363 of the off-axis focusing PBP lens 300 is shifted by a distance D in the +x direction from the in-plane geometry center axis 373 of the off-axis focusing PBP lens 350. This shift is for illustrative purposes and is not intended to limit to the scope of the present disclosure. The shift may be in any other suitable directions and for any other suitable distances. For example, in some embodiments, the lens pattern center (O_{L}) 360 may be shifted by a predetermined distance in the −x-axis direction from the geometry center (O_{G}) 370. In some embodiments, the predetermined direction may be other directions.

The off-axis focusing PBP lens 350 may be a PBP grating with a varying periodicity in the opposite lateral directions from the in-plane lens pattern center axis 363 to the opposite lens periphery 365. A period P of the lens pattern of the off-axis focusing PBP lens 350 may be defined as a distance over which the azimuthal angle θ of the optic axis of the optically anisotropic film 351 changes by π in the lateral directions. Fringes of the PBP grating over the entire PBP grating may not have an axial symmetry about the in-plane lens pattern center axis 363. Fringes of the PBP grating in a predetermined region of the entire PBP grating may have a central symmetry about the lens pattern center (O_{L}) 360. A fringe of the PBP grating refers to a set of local points at which the azimuthal angle of the optic axis (or the rotation angle of the optic axis starting from the in-plane lens pattern center axis 363 to the local point in the lateral direction) is the same. For example, when the rotation angle of the optic axis from the in-plane lens pattern center axis 363 to the local point in the lateral direction is expressed θ=θ₁+nπ (0<θ₁<π), both θ₁ and n may be the same for the local points on the same fringe. A difference in the rotation angles of the neighboring fringes is π, i.e., the distance between the neighboring fringes is the period P. The set of local points may be on the same line parallel to the longitudinal direction for an off-axis focusing PBP lens functioning as cylindrical lens.

FIG. 3D illustrates a side view of an off-axis focusing PBP lens, which may be the off-axis focusing PBP lens 300 or 350. The side view shows an out-of-plane lens pattern center axis 388 and an out-of-plane geometry center axis 399 passing through the lens pattern center (O_{L}) 360 and the geometry center (O_{G}) 370, respectively. The out-of-plane lens pattern center axis 388 and the out-of-plane geometry center axis 399 may be perpendicular to the surface plane (e.g., the x-y plane). That is, the out-of-plane lens pattern center axis 388 and the out-of-plane geometry center axis 399 may be in the z-axis direction or the thickness direction of the lens. For the off-axis focusing PBP lens, the lens pattern center (O_{L}) 360 is shifted from the geometry center (O_{G}) 370 for a predetermined distance D. The shift may also correspond to the shift or distance between the parallel out-of-plane lens pattern center axis 388 and the out-of-plane geometry center axis 399.

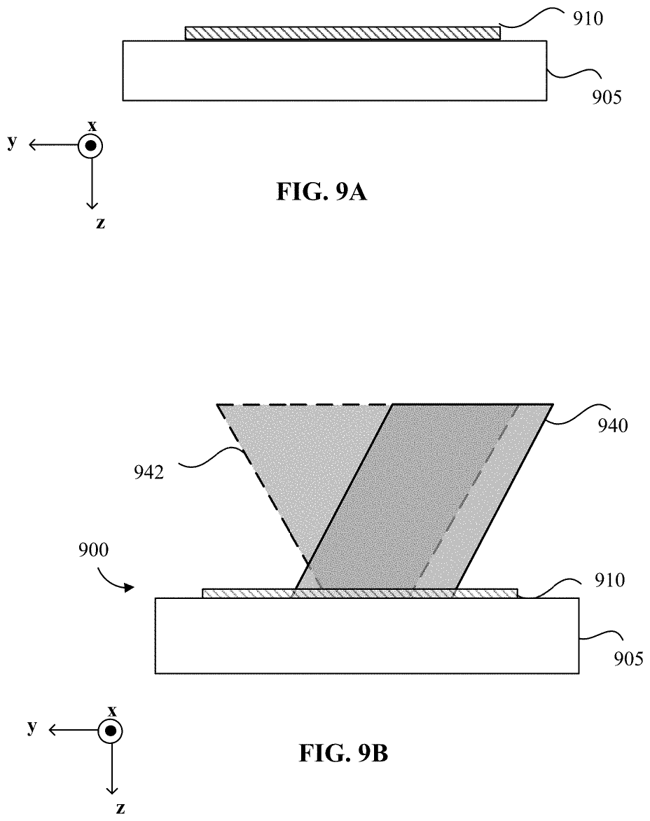

FIGS. 4A-4F illustrate deflections of lights by an off-axis focusing PBP lens 400, according to various embodiments of the present disclosure. The off-axis focusing PBP lens 400 may be an embodiment of the off-axis focusing PBP lenses shown in FIGS. 1A-1D, and FIGS. 3A-3D. The off-axis focusing PBP lens 400 may be an active off-axis focusing PBP lens or a passive off-axis focusing PBP lens. The optically anisotropic film of a passive off-axis focusing PBP lens may include polymerized RMs, LC polymers, or amorphous polymers with an photo-induced alignment, which may not be reorientable by an external field, e.g., an electric field. The optically anisotropic film of an active off-axis focusing PBP lens may include active LCs, which may be reorientable by an external field, e.g., an electric field. The phase retardation of the off-axis focusing PBP lens 400 may be a half wave or an odd number of half waves.

The off-axis focusing PBP lens 400 may be configured to operate in a focusing state for a circularly polarized light having a predetermined handedness (e.g., left handedness or right handedness). For example, as shown in FIG. 4A, the off-axis focusing PBP lens 400 may operate in a focusing state (or a converging state) for a right-handed circularly polarized (“RHCP”) incident light. For example, the off-axis focusing PBP lens 400 may focus an on-axis collimated RHCP light 401 to an off-axis focal point (or focus) F_{off}. The off-axis focal point F_{off} may be shifted from the out-of-plane geometry center axis (or the lens axis) by a distance din a predetermined direction, for example, in the +x-axis direction. The focus shift d in a focal plane 422 may be expressed as d=L*tan(α), where α is an angle formed by a line connecting the off-axis focal point F_{off} and a geometric center O of the lens aperture relative to the out-of-plane geometry center axis (e.g., z-axis in FIG. 4A), and L is the distance between the lens plane of in the off-axis focusing PBP lens 400 and the focal plane 422 of the off-axis focusing PBP lens 400.

As shown in FIG. 4B, the off-axis focusing PBP lens 400 may operate in a defocusing state (or a diverging state) for an LHCP incident light. For example, the off-axis focusing PBP lens 400 may defocus (or diverge) an on-axis collimated LHCP light 402. Thus, the off-axis focusing PBP lens 400 may be indirectly switched between operating in a focusing state and operating in a defocusing state by switching the handedness of the incident light. The embodiments shown in FIG. 4A and FIG. 4B are for illustrative purposes. In some embodiments, the off-axis focusing PBP lens 400 may be configured to operate in a focusing state for an LHCP incident light and operate in a defocusing state for an RHCP incident light.

As shown in FIGS. 4A and 4B, the off-axis focusing PBP lens 400 may reverse the handedness of a circularly polarized light passing therethrough in addition to focusing or defocusing (or converging/diverging) the circularly polarized incident light. In some embodiments, when the off-axis focusing PBP lens 400 is flipped such that an light incidence side and a light exiting side are flipped, the focusing state and the defocusing state of the off-axis focusing PBP lens 400 may be reversed for the circularly polarized incident light with the same handedness. For example, after the flip, the off-axis focusing PBP lens 400 may operate in a focusing state for an LHCP incident light, and operate in a defocusing state for an RHCP incident light. For example, the off-axis focusing PBP lens 400 may focus the on-axis collimated LHCP light 402 to an off-axis focal point, and may defocus the on-axis collimated RHCP light 401.

In addition to focusing or defocusing an on-axis collimated light, the off-axis focusing PBP lens 400 may also have other features. FIG. 4C shows that the off-axis focusing PBP lens 400 may convert an on-axis diverging light 403 emitted from a point light source located in a focal plane 411 to an off-axis collimated light 404. FIG. 4D shows that the off-axis focusing PBP lens 400 may convert an off-axis diverging light 405 emitted from a point light source, which may be located in the focal plane 411 and disposed at an off-axis location relative to the out-of-plane geometry center axis of the off-axis focusing PBP lens 400, to an on-axis collimate light 406. FIG. 4E shows that the off-axis focusing PBP lens 400 may convert an off-axis diverging light 407 from a point light source, which may be located in the focal plane 411 and disposed at an off-axis location relative to the out-of-plane geometry center axis of the off-axis focusing PBP lens 400, to an off-axis collimated light 408. As shown in FIGS. 4C-4E, a displacement of the point light source in the focal plane 411 from the out-of-plane geometry center axis may change the deflection angle of collimated light 408 after propagating through the off-axis focusing PBP lens 400. FIG. 4F shows that the off-axis focusing PBP lens 400 may focus an off-axis collimated light 409 as a converging light 410, which converses to an on-axis focal point Fₒₙ.

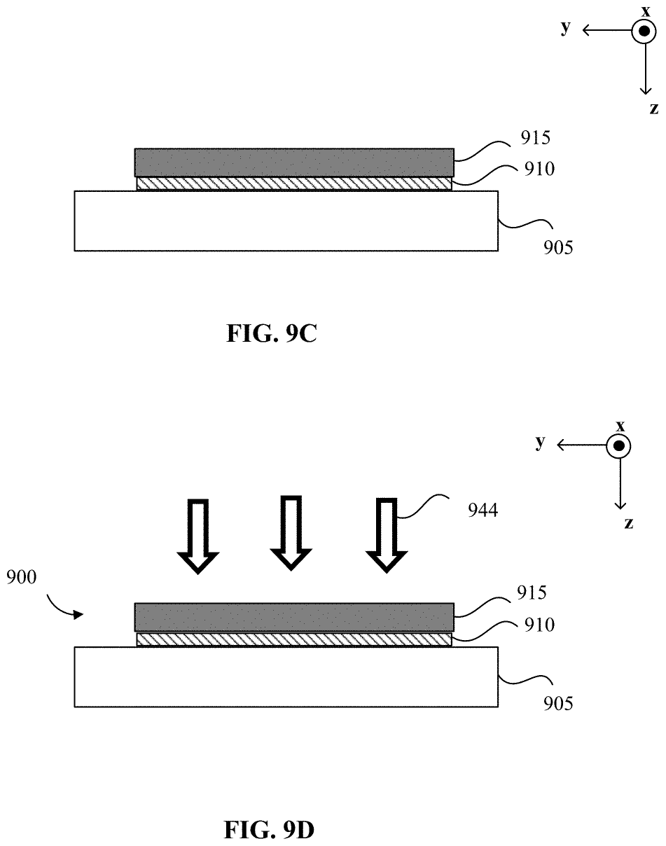

The off-axis focusing PBP lens in accordance with an embodiment of the present disclosure may be indirectly switchable between a focusing state and a defocusing state via changing a handedness of an incident light of the off-axis focusing PBP lens through an external polarization switch. FIGS. 5A and 5B illustrate an indirect switching of an off-axis focusing PBP lens 500 between a focusing state and a defocusing state, according to an embodiment of the present disclosure. The off-axis focusing PBP lens 500 may be an embodiment of the off-axis focusing PBP lenses shown in FIGS. 1A-1D, and FIGS. 3A-4F. The off-axis focusing PBP lens 500 may be an active off-axis focusing PBP lens (e.g., fabricated based on active LCs) or a passive off-axis focusing PBP lens (e.g., fabricated based on non-active LCs, for example, reactive mesogen (“RM”)). As shown in FIGS. 5A and 5B, the off-axis focusing PBP lens 500 may be switchable between a focusing state and a defocusing state via changing the handedness of an incident light of the off-axis focusing PBP lens 500 through a polarization switch 510. The polarization switch 510 may be optically coupled with the off-axis focusing PBP lens 500, and may be configured to control the handedness of a circularly polarized light before the circularly polarized light is incident onto the off-axis focusing PBP lens 500. The polarization switch 510 may be any suitable polarization rotator. In some embodiments, the polarization switch 510 may include a switchable half-wave plate (“SHWP”) 515 configured to transmit a circularly polarized light at an operating state (e.g., a switching state or a non-switching state). The SHWP 515 operating at the switching state may reverse the handedness of the circularly polarized incident light, and the SHWP 515 operating at the non-switching state may transmit the circularly polarized incident light without affecting the handedness.

In some embodiments, the off-axis focusing PBP lens 500 may operate in a focusing state for an RHCP incident light, and may operate in a defocusing state for an LHCP incident light. Thus, the SHWP 515 may be configured to control an optical state (focusing or defocusing state) of the off-axis focusing PBP lens 500 by controlling the handedness of the circularly polarized light incident onto the off-axis focusing PBP lens 500. In some embodiments, the SHWP 515 may include an LC layer. The operating state (switching or non-switching state) of the SHWP 515 may be controllable by controlling an external electric field applied to LC layer.

As shown in FIG. 5A, the SHWP 515 operating at the non-switching state may transmit an RHCP light 502 without affecting the handedness, and output an RHCP light 504 toward the off-axis focusing PBP lens 500. Accordingly, the off-axis focusing PBP lens 500 may operate in a focusing state for the RHCP light 504, and output a converging LHCP light 506. When the RHCP light 504 is an on-axis collimated RHCP light, the RHCP light 504 may be focused to an off-axis focal point by the off-axis focusing PBP lens 500. As shown in FIG. 5B, the SHWP 515 operating at the switching state may reverse the handedness of a circularly polarized incident light. Thus, an on-axis collimated RHCP light 502 incident onto the SHWP 515 may be transmitted as an on-axis collimated LHCP light 508. The off-axis focusing PBP lens 500 may operate in a defocusing state for the on-axis collimated LHCP light 508, and may output a diverging RHCP light 512.

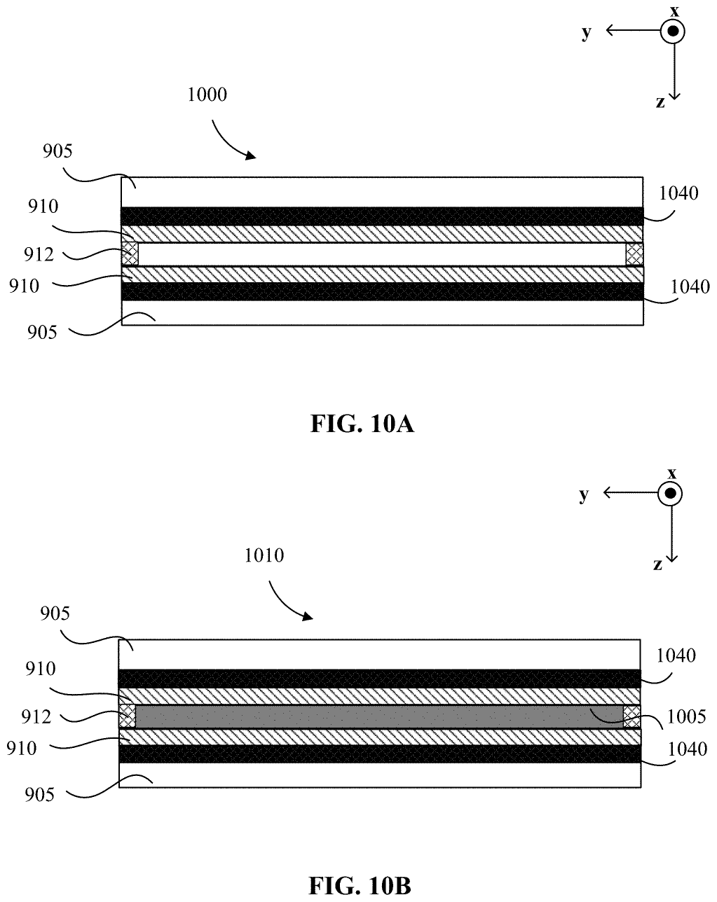

As described above, an off-axis focusing PBP lens may operate in a focusing or a defocusing state depending on the handedness of the circularly polarized light incident onto the off-axis focusing PBP lens and the handedness of the rotation of the LC directors in the off-axis focusing PBP lens. In some embodiments, an active off-axis focusing PBP lens may be switched between a focusing state (or a defocusing state), in which a positive (or a negative) optical power is provided to the incident light, and a neutral state, in which substantially zero optical power is provided to the incident light. For discussion purposes, FIGS. 6A and 6B illustrate a switching of an active off-axis focusing PBP lens 600 between a focusing state and a neutral state. Although the switch between the defocusing state and the neutral state is not shown, it is understood that the defocusing state may be realized in FIG. 6A when the handedness of the incident light of the off-axis focusing PBP lens 600 is switched to an opposite handedness.

As shown in FIGS. 6A and 6B, the active off-axis focusing PBP lens 600 may have an optically anisotropic film 610 including active nematic LCs. The active off-axis focusing PBP lens 600 may include two substrates 611 and 612 disposed on two sides of the optically anisotropic film 610. The substrates 611 and 612 may each include an electrode (not shown). At least one of the substrates 611 and 612 may be provided with a PAM layer that is in-plane patterned to provide a lens pattern (not shown). An embodiment of the configuration of the electrodes is shown in FIG. 1C. A power source 620 may be electrically coupled with the electrodes included in the substrates 611 and 612 to supply a voltage across the optically anisotropic film 610, thereby generating a vertical electric field (e.g., in the z-axis) perpendicular to the substrates 611 and 612.

At a voltage-off state, as shown in FIG. 6A, LC molecules 605 in the optically anisotropic film 610 may be aligned in a patterned LC alignment to provide an optical power to (i.e., to focus or defocus) an incident light. In the example shown in FIG. 6A, the active off-axis focusing PBP lens 600 may operate in a focusing state for an RHCP light 602, and may converge the RHCP light bam 602 as an LHCP light 604. For example, when the RHCP light 602 is an on-axis collimated RHCP light, the active off-axis focusing PBP lens 600 may focus the on-axis collimated RHCP light to an off-axis focal point.

At a voltage-on state, as shown in FIG. 6B, the vertical electric field (e.g., the electric field in the z-axis) perpendicular to the substrates 611 and 612 may be generated in the optically anisotropic film 610 via a voltage applied to electrodes separately disposed at the first and second substrates 611 and 612. The LC molecules 605 may be reoriented along the direction of the vertical electric field (e.g., z-axis). For discussion purposes, FIGS. 6A and 6B show that the active nematic LCs have a positive dielectric anisotropy. The LC molecules 605 may trend to be perpendicular to the substrates 611 and 612 when the vertical electric field is sufficiently strong. That is, the LC molecules 605 may be reoriented to be in a homeotropic state. Thus, the optically anisotropic film 610 may operate as an optically isotropic medium for an incoming light. Accordingly, the active off-axis focusing PBP lens 600 may operate in a neutral state and may negligibly affect or not affect the propagation direction, the wavefront, and the polarization handedness of the incoming light. That is, for a circularly polarized incident light, the active off-axis focusing PBP lens 600 may output a circularly polarized light with substantially the same propagation direction, wavefront, and polarization handedness. For example, as shown in FIG. 6B, the on-axis collimated RHCP light 602 incident onto the active off-axis focusing PBP lens 600 operating in the neutral state may be output as a substantially identical on-axis collimated RHCP light 606. That is, the LC molecules 605 in the optically anisotropic film 610 may be out-of-plane rotated (by the electric field) to switch off the optical power of the active off-axis focusing PBP lens 600. Here, the “out-of-plane” rotation refers to a rotation of the LC directors in a plane perpendicular to a surface of the optically anisotropic film 610 (or perpendicular to the substrates 611, 612). In the example shown in FIG. 6B, the out-of-plane refers to the x-z plane, which is perpendicular to the x-y plane shown in FIGS. 3A-3D.

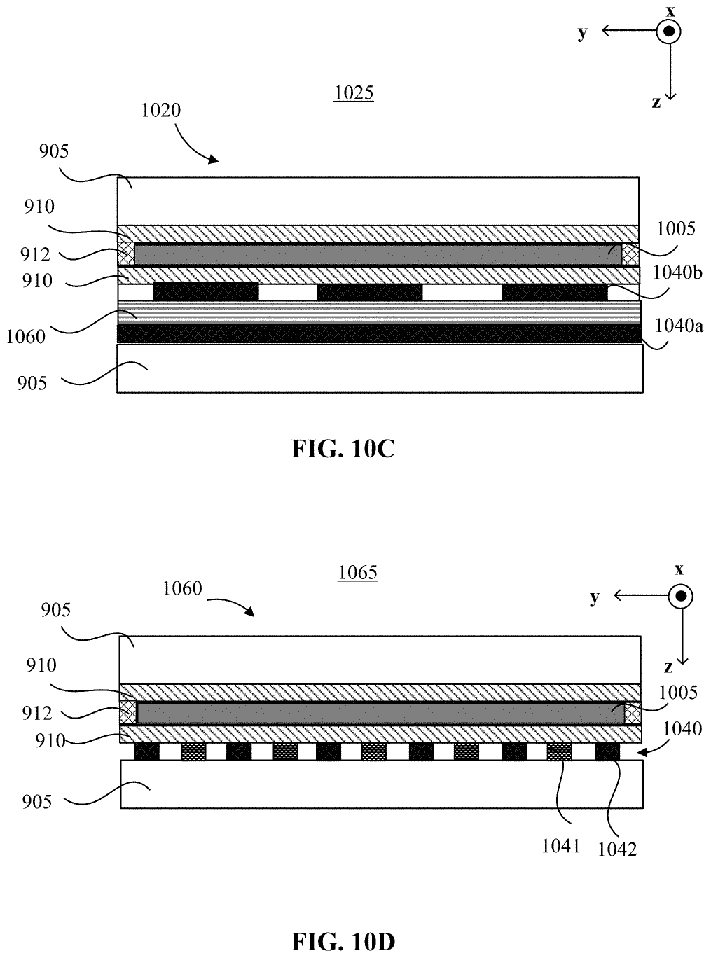

In some embodiments, an active off-axis focusing PBP lens operating at a neutral state with a substantially zero optical power may also affect the handedness of the transmitted light. FIGS. 7A and 7B illustrate a switching of an active off-axis focusing PBP lens 700 between a focusing state with a positive optical power and a neutral state with a substantially zero optical power, according to another embodiment of the present disclosure. Although the switching between the defocusing state and the neutral state is not shown, it is understood that the defocusing state may be realized when the handedness of an incident light of the active off-axis focusing PBP lens 700 is switched to an opposite handedness.

As shown in FIGS. 7A and 7B, the active off-axis focusing PBP lens 700 may have an optically anisotropic film 710 including active nematic LCs. The active off-axis focusing PBP lens 700 may include first and second substrates 711 and 712 disposed on two sides of the optically anisotropic film 710. Electrodes (not shown) may be disposed at one of the first and second substrates 711 and 712. At least one of the substrates 711 and 712 may be provided with a PAM layer that is in-plane patterned to provide a lens pattern (not shown). For illustrative purposes, the electrodes are presumed to be disposed at the first substrate 711. An embodiment of the configuration of the electrodes disposed at one substrate is shown in FIG. 1D. A power source 720 may be electrically coupled with the first substrate 711 to supply a voltage to generate horizontal electric field in the x-axis direction of optically anisotropic film 710.

At a voltage-off state, as shown in FIG. 7A, LC molecules 705 in the optically anisotropic film 710 may be aligned in a planar patterned LC alignment (the LC molecules 705 may have a pretilt angle smaller than 15 degrees, including zero degree) to provide an optical power. The active off-axis focusing PBP lens 700 may operate in a focusing state for the RHCP light 702, and may converge the RHCP light 702 as an LHCP light 704. For example, when the RHCP light 702 is an on-axis collimated RHCP light, the active off-axis focusing PBP lens 700 may focus the on-axis collimated RHCP light to an off-axis focal point.

At a voltage-on state, as shown in FIG. 7B, the horizontal electric field may be generated in the optically anisotropic film 710 by electrodes disposed at the same substrate (e.g., the first substrate 711). The configuration of the electrodes for generating a horizontal electric field may include in-plane switching (“IPS”) electrodes or fringe-field switching (“FFS”) electrodes. For discussion purposes, FIGS. 7A and 7B show the active nematic LCs having a positive dielectric anisotropy. The LC molecules 705 may be reoriented along the direction of the horizontal electric field, and the optically anisotropic film 710 may function as an optical uniaxial film when the horizontal electric field is sufficiently strong. As a result, the patterned LC alignment configured to provide an optical power (shown in FIG. 7A) may be transformed to the uniform uniaxial planar structure (shown in FIG. 7B) that provides no or negligible optical power. As the phase retardation of the PBP lens 700 is a half wave or an odd number of half waves, the optically anisotropic film 710 may function as a half-wave plate. Thus, the active off-axis focusing PBP lens 700 operating in the neutral state may reverse the handedness of the light transmitted through the half-wave plate without focusing (or defocusing) the light. For example, as shown in FIG. 7B, the on-axis collimated RHCP light 702 incident onto the active off-axis focusing PBP lens 700 at the voltage-on state may be transmitted therethrough as an on-axis collimated LHCP light 706. That is, the LC molecules 705 may be rotated in-plane by the electric field to switch off the optical power of the active off-axis focusing PBP lens 700. The handedness of the light transmitted therethrough may be reversed.

For discussion purposes, FIGS. 6A and 6B and FIGS. 7A and 7B show the switching of active off-axis focusing PBP lenses including active nematic LCs with a positive dielectric anisotropy (e.g. positive LCs). In some embodiments, the active off-axis focusing PBP lens may include active nematic LCs with a negative dielectric anisotropy (e.g., negative LCs), which may be reorientable by applying a vertical electric field to activate the PBP lens. For example, at a voltage-off state, the negative LCs in the optically anisotropic film may be configured to be in a homeotropic state, and the optically anisotropic film may operate as an optically isotropic medium for the normally incoming light. Accordingly, the active off-axis focusing PBP lens may operate in a neutral state and may negligibly affect or may not affect the propagation direction, the wavefront, and the polarization handedness of the incoming light. When an applied vertical electric field (perpendicular to the substrates) is sufficiently strong, the directors of the negative LCs may be oriented substantially parallel to the substrate. That is, the negative LCs may be reoriented to be in a planar state with a patterned LC alignment according to patterns of the PAM layer. Accordingly, the active off-axis focusing PBP lens may operate in a focusing state or a defocusing state. In some embodiments, the active off-axis focusing PBP lens may include active nematic LCs with a negative dielectric anisotropy (e.g., negative LCs). The active nematic LCs with the negative dielectric anisotropy may be reorientable by applying a horizontal electric field to deactivate the PBP lens. For example, at a voltage-off state, the negative LCs in the optically anisotropic film may be aligned in a planar LC alignment pattern to provide an optical power. When an applied horizontal electric field is sufficiently strong, the negative LCs may be in-plane reoriented in the direction perpendicular to the direction of the horizontal electric field. The active off-axis focusing PBP lens may operate in the neutral state. In the neutral state, the optically anisotropic film may function as an optically uniaxial film. As the phase retardation of the PBP lens is a half wave or an odd number of half waves, the optically anisotropic film may function as a half-wave plate.

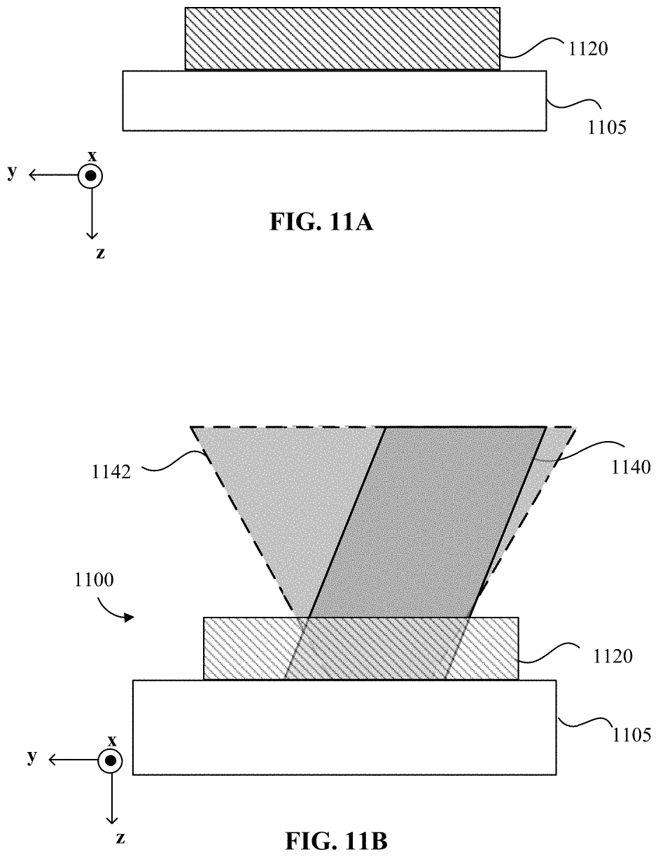

The present disclosure further provides a lens stack including a plurality of lenses. The plurality of lenses may include one or more disclosed off-axis focusing PBP lenses. In some embodiments, all of the lenses included in the lens stack may be off-axis focusing PBP lenses. In some embodiments, the lens stack may include a combination of at least one on-axis focusing PBP lens and at least one off-axis focusing PBP lens. FIG. 8 illustrates a schematic diagram of a lens stack 800 including one or more disclosed off-axis focusing PBP lenses, according to an embodiment of the present disclosure. As shown in FIG. 8, the lens stack 800 may include a plurality of lenses 805 (e.g., 805a, 805b, and 805c) arranged in an optical series. The plurality of lenses 805 may include one or more disclosed off-axis focusing PBP lenses, each of which may be an embodiment of the off-axis focusing PBP lenses described above in connection with FIGS. 1A-1D, and 3A-7B. For example, in some embodiments, the plurality of lenses 805 may also include one or more on-axis focusing PBP lenses. For example, one or more of the lenses 805a, 805b, and 805c may be an on-axis focusing PBP lens. In some embodiments, the plurality of lenses 805 may also include one or more other types of suitable lenses, such as one or more conventional lenses, e.g., one or more glass lenses.

The plurality of lenses 805 may provide a plurality of optical states. The plurality of optical states may provide a range of adjustments of optical powers and a range of adjustments of beam deviations for the lens stack 800. An optical power P of the lens stack 800 may be calculated by P=1/f (unit: diopter), where f is the focal length of the lens stack 800. The optical power P of the lens stack 800 may be a sum of the optical powers of the respective lenses 805 included in the lens stack 800. The optical powers of the respective lenses 805 may be positive, negative, or zero. The resultant beam deviations may depend on the shift of the structural center (or structural center shift) in the respective lenses 805 and the relative orientations between the lenses 805. For example, when the structural center is shifted in the x-axis by the lenses 805, the resultant structural center shift may be in the x-axis. The structural center shift of the lens stack 800 may be a sum of the structural center shifts of the lenses 805 included in the lens stack 800. The structural center shift of each of the lenses 805 may be positive, negative, or zero. For example, a structural center shift in the +x-axis with respective to the lens aperture center may be defined as a positive structural center shift, and a structural center shift in the −x-axis with respective to the lens aperture center may be defined as a negative lens aperture center shift.

In some embodiments, the lens stack 800 may be switchable between a focusing state (or a defocusing state) and a neutral state. In some embodiments, a focal distance and a deflection angle of a focused beam (or beam deviation of a focused beam) may be adjustable. Accordingly, a 2D and 3D beam steering with focusing may be realized. A 3D positioning of focal point may be, for example, useful for direct 3D optical recording in photo-sensitive materials. The switchable lens stack 800 may include one or more active PBP lenses, which may be directly switchable between the focusing state (or the defocusing state) and the neutral state by an electric field, as described in FIGS. 6A-7B. The one or more active PBP lenses may include an on-axis focusing PBP lens or a disclosed off-axis focusing PBP lens.

In some embodiments, the lens stack 800 may include at least one SHWP arranged adjacent to a PBP lens. For illustrative purposes, FIG. 8 shows that the lens stack 800 may include a plurality of SHWPs 810 (e.g., three SHWPs 810a, 810b, and 810c) and a plurality of PBP lenses 805 (e.g., three PBP lenses 805a, 805b, and 805c) alternately arranged. The SHWP 810 may be configured to reverse or maintain a handedness of a polarized light depending on an operating state of the SHWP, as described above in connection with FIGS. 5A and 5B. In some embodiments, the lenses 805 may include one or more active off-axis focusing PBP lenses, which may provide an optical power (zero or non-zero optical power) depending on the handedness of a circularly polarized light incident on the PBP lens 805, the handedness of LC director rotation in the PBP lens 805, and an applied voltage. A thickness of an individual PBP lens 805 (e.g., 805a, 805b, or 805c) may be 1-10 microns, which may be negligible when compared with a thickness of the substrate. Thus, an overall thickness of the lens stack 800 may be substantially determined by the thickness of the glass or plastic substrate(s). The overall thickness of the lens stack 800 may have a thickness of, for example, 1-10 millimeters. The lens stack 800 may provide an off-axis focusing capability without physically tilting the PBP lenses. Thus, the lens stack 800 fabricated based on one or more disclosed off-axis focusing PBP lenses may have a compactness that significantly reduces the form factor of an optical system including the lens stack 800. Although three lenses 805a, 805b, and 805c and three SHWPs 810a, 810b, and 810c are shown in FIG. 8 for illustrative purposes, the lens stack 800 may include any suitable number of lenses (including any suitable number of disclosed off-axis focusing PBP lenses), such as one, two, four, five, etc., and any suitable number of SHWPs, such as one, two, four, five, etc.

In some embodiments, the lens stack 800 may include one or more passive off-axis focusing PBP lenses, which may provide an optical power (zero or non-zero optical power) depending on the handedness of a circularly polarized light incident on the PBP lens 805 and the handedness of LC director rotation in the PBP lens 805. Thus, through controlling the operating state (switching or non-switching state) of the at least one SHWP 810 coupled with a corresponding off-axis focusing PBP lens 805, the lens stack 800 may provide a plurality of optical states. The plurality of optical states may provide a range of adjustments of optical powers and a range of adjustments of beam deviations for an incident light.

In some embodiments, the lens stack 800 may include both passive off-axis focusing PBP lenses and active off-axis focusing PBP lenses. Through controlling the operating state (switching or non-switching state) of the at least one SHWP 810 coupled with a corresponding passive off-axis focusing PBP lens, and controlling the operating state (switching or non-switching state) of the at least one SHWP 810 coupled with a corresponding active off-axis focusing PBP lens and an applied voltage of the active off-axis focusing PBP lens, the lens stack 800 may provide a plurality of optical states. The plurality of optical states may provide a range of adjustments of optical powers and a range of adjustments of beam deviations for the incident light.

The disclosed off-axis focusing PBP lens and the lens stack including one or more off-axis focusing PBP lenses may include features such as flatness, compactness, small weight, thin thickness, high efficiency, high aperture ratio, flexible design, simply fabrication, and low cost, etc. Thus, the disclosed off-axis focusing PBP lens and the lens stack may be implemented in various applications such as portable or wearable optical devices and systems. The disclosed off-axis focusing PBP lens and the lens stack including one or more off-axis focusing PBP lenses may provide complex optical functions while maintaining a small form factor, compactness and light weight. For example, the disclosed off-axis focusing PBP lenses and/or the lens stack including one or more off-axis focusing PBP lenses may be implemented in a near-eye display (“NED”). In some embodiments, the disclosed off-axis focusing PBP lenses and/or the lens stack including one or more off-axis focusing PBP lenses may be implemented in object-tracking (e.g., eye-tracking) components, display components, adaptive optical components for human eye vergence-accommodation, etc.

The present disclosure provides fabrication methods for fabricating off-axis focusing geometric phase (“GP”) optical elements, such as off-axis focusing GP or Pancharatnam-Berry phase (“PBP”) lenses and off-axis focusing GP mirrors, etc. An off-axis focusing PBP lens may be considered as a transmissive GP optical element with an optical power. An off-axis focusing GP mirror may be considered as a reflective GP optical element with an optical power. In some embodiments, an off-axis focusing GP optical element may be fabricated by cropping or cutting an on-axis focusing GP optical element asymmetrically. The on-axis focusing GP optical element may be fabricated via suitable processes, such as a holographic recording, a direct writing, a master mask exposure, or a photocopying, etc. In some embodiments, an off-axis focusing GP optical element may be fabricated via a holographic recording, in which a polarization interference pattern corresponding to an off-axis focusing lens (or mirror) pattern may be holographically recorded in a polarization sensitive recording medium via a two-beam-interference exposure.

The holographic recording method may include directing a first beam (or first light beam) and a second beam (or second light beam) to a polarization sensitive recording medium to produce a polarization interference pattern at (e.g., on and/or in) the polarization sensitive recording medium. The first beam and the second beam may be referred to as recording beams. In some embodiments, one of the first beam and the second beam may be a reference beam with a planar wavefront (or plane wavefront), and the other may be a signal beam with a non-planar or curved wavefront (e.g., a spherical wavefront, a cylindrical wavefront, an aspherical wavefront, or a freeform wavefront, etc.) that is desirable to be reproduced subsequently. In some embodiments, the reference beam and the signal beam may have a wavelength within an absorption band of the polarization sensitive recording medium, e.g. ultraviolet (“UV”), violet, blue, or green beams. In some embodiments, the reference beam and the signal beam may be laser beams, e.g., UV, violet, blue, or green laser beams. A propagation direction of the reference beam may not be parallel with (i.e., may be non-parallel with) a propagation direction of the signal beam. Instead, the propagation direction of the reference beam may form an angle Θ with respect to the propagation direction of the signal beam. In some embodiments, the value of the angle Θ may be greater than 0° and smaller than or equal to about 90°. In some embodiments, the value of the angle Θ may be greater than 0° and smaller than or equal to about 60°. In some embodiments, the value of the angle Θ may be greater than 0° and smaller than or equal to about 40°. In some embodiments, the value of the angle Θ may be greater than 0° and smaller than or equal to about 20°. In some embodiments, the value of the angle Θ may be greater than 0° and smaller than or equal to about 10°.

In some embodiments, the reference beam and the signal beam may be coherent circularly polarized beams with orthogonal polarizations, e.g., coherent circularly polarized beams with opposite handednesses. The holographic recording method may also include directing the reference beam and the signal beam to a first surface of the polarization sensitive recording medium. In some embodiments, a propagation direction of one of the reference beam and the signal beam may be substantially parallel to a normal of the first surface of the polarization sensitive recording medium, and a propagation direction of the other of the reference beam and the signal beam may form an angle α with respect to the normal of the first surface of the polarization sensitive recording medium. The angle α may be an acute angle, and a value of the angle Θ may be equal to an absolute value of the angle α. In some embodiments, a propagation direction of one of the reference beam and the signal beam has an angle α with respect to a normal of the first surface of the polarization sensitive recording medium, and a propagation direction of the other of the reference beam and the signal beam may form an angle β with respect to the normal of the first surface of the polarization sensitive recording medium. In some embodiments, the angle α and the angle β may have different signs, e.g., one of the angle α and the angle β may be a positive angle, and the other may be a negative angle. In some embodiments, the angle α and the angle β may have the same sign, e.g., both are positive angles or negative angles. A value of the angle θ may be a sum of an absolute value of the angle α and an absolute value of the angle β. The angle α and the angle β may be acute angles. In some embodiments, the angle α and the angle β may have a substantially same absolute value.

In some embodiments, the absolute value of the angle α may be greater than 0° and smaller than or equal to about 45°. In some embodiments, the absolute value of the angle α may be greater than 0° and smaller than or equal to about 30°. In some embodiments, the absolute value of the angle α may be greater than 0° and smaller than or equal to about 20°. In some embodiments, the absolute value of the angle α may be greater than 0° and smaller than or equal to about 10°. In some embodiments, the absolute value of the angle α may be greater than 0° and smaller than or equal to about 5°. In some embodiments, the absolute value of the angle β may be greater than 0° and smaller than or equal to about 45°. In some embodiments, the absolute value of the angle β may be greater than 0° and smaller than or equal to about 30°. In some embodiments, the absolute value of the angle β may be greater than 0° and smaller than or equal to about 20°. In some embodiments, the absolute value of the angle β may be greater than 0° and smaller than or equal to about 10°. In some embodiments, the absolute value of the angle β may be greater than 0° and smaller than or equal to about 5°.

In the present disclosure, an angle of a propagation direction of a beam with respect to a normal of a surface of the polarization sensitive recording medium can be defined as a positive angle or a negative angle, depending on the positional relationship between the propagation direction of the beam and the normal of the surface of the polarization sensitive recording medium. For example, when the propagation direction of the beam is in a direction clockwise from the normal, the angle of the propagation direction may be defined as a positive angle, and when the propagation direction of the beam is in a direction counter-clockwise from the normal, the angle of the propagation direction may be defined as a negative angle.

In some embodiments, the reference beam and the signal beam may have a substantially uniform intensity. The superimposition of the reference beam and the signal beam may generate a superimposed wave that has a substantially uniform intensity and a linear polarization with a spatially varying orientation (or a spatially varying linear polarization orientation angle). That is, the superimposition of the reference beam and the signal beam may generate a polarization interference pattern, which is a pattern of the spatially varying orientation of the linear polarization of the superimposed wave. The pattern of the spatially varying orientation of the linear polarization may correspond to a lens pattern of an off-axis focusing PBP lens (referred to as an off-axis focusing lens pattern). According to the wavefront of the signal beam, the pattern of the spatially varying orientation of the linear polarization of the superimposed wave may correspond to a lens pattern of an off-axis focusing PBP spherical lens, an off-axis focusing PBP cylindrical lens, an off-axis focusing PBP aspherical lens, or an off-axis focusing PBP freeform lens, etc.

The holographic recording method may also include exposing the polarization sensitive recording medium to the polarization interference pattern. The polarization sensitive recording medium may include a photo-alignment material configured to have a photoinduced optical anisotropy when exposed to the polarization interference pattern. Thus, the polarization interference pattern (or the pattern of the spatially varying orientation of the linear polarization of the superimposed wave) may be recorded at (e.g., in) the polarization sensitive recording medium to define an orientation pattern of an optic axis of the polarization sensitive recording medium. The defined orientation pattern of the optic axis of the polarization sensitive recording medium may correspond to the off-axis focusing lens pattern.

In some embodiments, the holographic recording method may also include dispensing a birefringent medium having an intrinsic birefringence, at (e.g. on) the exposed polarization sensitive recording medium to form a birefringent medium layer. In some embodiments, materials forming the birefringent medium may be dissolved in a solvent to form a solution, and a suitable amount of the solution may be dispensed (e.g., coated, or sprayed, etc.) to form the birefringent medium layer. In some embodiments, the holographic recording method may also include pre-exposure heating the birefringent medium layer to remove the remaining solvent. In some embodiments, the birefringent medium may include liquid crystals (“LCs”) and/or reactive mesogens (“RMs”). The LCs and/or RMs may be aligned in the off-axis focusing lens pattern by the exposed polarization sensitive recording medium. Thus, the orientational pattern of the optic axis of the recording medium may be transferred to the LCs or RMs. In some embodiments, the holographic recording method may also include post-exposure heat treating (e.g., annealing) the birefringent medium layer in a temperature range corresponding to a nematic phase of the LCs and/or RMs. The alignments (or orientation pattern) of the LCs and/or RMs may be enhanced. In some embodiments, the holographic recording method may also include thermo- or photo-polymerizing the birefringent medium layer. In some embodiments, the step of heat treating (e.g., annealing) the birefringent medium layer may be omitted. In some embodiments, the step of thermo- or photo-polymerizing the birefringent medium layer may be omitted. An off-axis focusing PBP lens may be obtained through the disclosed fabrication method.

In some embodiments, the polarization sensitive recording medium may include a photo-sensitive polymer (or photo-polymer), e.g., an amorphous polymer, an LC polymer, etc. The polarization interference pattern (or the pattern of the spatially varying orientation of the linear polarization of the superimposed wave) may be recorded in the photo-sensitive polymer due to the polarization selective photo-reactions that result in photo-induced optical anisotropy. The polarization interference pattern may relate to a light field. Under influence of the light field, an alignment pattern of the optic axis of the polarization sensitive recording medium may be induced. Both the polarization interference pattern and the alignment pattern of the optic axis of the polarization sensitive recording medium may have 3D dimensionality. This alignment process may also be referred to as bulk-mediated photoalignment.

In some embodiments, when the polarization sensitive recording medium includes an LC polymer, the holographic recording method may also include post-exposure heating the exposed polarization sensitive recording medium. For example, the holographic recording method may include heat treating (e.g., annealing) the exposed LC polymer in a temperature range corresponding to a liquid crystalline state of the LC polymer. The post-exposure heating of the LC polymer may enhance the photo-induced orientational order (characterized, e.g., by birefringence) in the LC polymer due to the self-organization in LC phase. In some embodiments, the step of post-exposure heating (e.g., annealing) the exposed polarization sensitive recording medium may be omitted. For example, the post-exposure heating may be omitted for an exposed amorphous polymer. In some embodiments, the polarization sensitive recording medium may be dissolved in a solvent to form a solution, and a suitable amount of the solution may be dispensed (e.g., coated, or sprayed, etc.) on a substrate to form a film of the polarization sensitive recording medium. In some embodiments, the holographic recording method may also include pre-exposure heating the film of the polarization sensitive recording medium to remove the remaining solvent. An off-axis focusing PBP lens may be obtained through the disclosed fabrication method.

The disclosed holographic recording method may also be used to fabricate other types of off-axis focusing GP optical elements, such as an off-axis focusing GP reflector (e.g., mirror), when the reference beam and the signal beam are coherent circularly polarized beams having a same handedness. The fabricated off-axis focusing GP optical element include helical structures with a predetermined rotation direction and a helix pitch. In some embodiments, the fabricated off-axis focusing GP optical element may be configured to reflect an incoming light with predetermined optical properties (e.g., a predetermined polarization, a predetermined wavelength range, and/or a predetermined incidence angle range), and provide an off-axis focusing without tilting the GP optical element. This off-axis focusing GP optical element may function as an off-axis focusing GP reflector (e.g., mirror). In some embodiments, the fabricated off-axis focusing GP optical element may be configured to transmit an incoming light with predetermined optical properties (e.g., a predetermined polarization, a predetermined wavelength range, and/or a predetermined incidence angle range), and provide an off-axis focusing without tilting the GP optical element. This off-axis focusing GP optical element may function as an off-axis focusing GP or PBP lens.

The holographic recording method may include directing the reference beam and the signal beam to a first surface and an opposing second surface of the polarization sensitive recording medium, respectively. In some embodiments, a propagation direction of one of the reference beam and the signal beam may be substantially parallel to a normal of the first surface of the polarization sensitive recording medium, and a propagation direction of the other of the reference beam and the signal beam may form an angle α with respect to a normal of the second surface of the polarization sensitive recording medium. The value of the angle Θ formed between the propagation directions of the reference beam and the signal beam may be equal to an absolute value of the angle α. In some embodiments, a propagation direction of one of the reference beam and the signal beam may form an angle α with respect to the normal of the first surface of the polarization sensitive recording medium, and a propagation direction of the other of the reference beam and the signal beam may form an angle β with respect to the normal of the second surface of the polarization sensitive recording medium. In some embodiments, one of the angle α and the angle β may be a positive angle, and the other may be a negative angle. In some embodiments, the angle α and the angle β may have the same sign, e.g., both are positive angles or negative angles. A value of the angle Θ may be a sum of an absolute value of the angle α and an absolute value of the angle β. The angle α and the angle β may be acute angles, and the value of the angle Θ may be greater than 0° and smaller than 180°. In some embodiments, the angle α and the angle β may have a substantially same absolute value.

In some embodiments, the absolute value of the angle α may be greater than 0° and smaller than or equal to about 45°. In some embodiments, the absolute value of the angle α may be greater than 0° and smaller than or equal to about 30°. In some embodiments, the absolute value of the angle α may be greater than 0° and smaller than or equal to about 20°. In some embodiments, the absolute value of the angle α may be greater than 0° and smaller than or equal to about 10°. In some embodiments, the absolute value of the angle α may be greater than 0° and smaller than or equal to about 5°. In some embodiments, the absolute value of the angle β may be greater than 0° and smaller than or equal to about 45°. In some embodiments, the absolute value of the angle β may be greater than 0° and smaller than or equal to about 30°. In some embodiments, the absolute value of the angle β may be greater than 0° and smaller than or equal to about 20°. In some embodiments, the absolute value of the angle β may be greater than 0° and smaller than or equal to about 10°. In some embodiments, the absolute value of the angle β may be greater than 0° and smaller than or equal to about 5°. In some embodiments, the value of the angle Θ may be greater than 0° and smaller than or equal to about 90°. In some embodiments, the value of the angle Θ may be greater than 0° and smaller than or equal to about 60°. In some embodiments, the value of the angle Θ may be greater than 0° and smaller than or equal to about 40°. In some embodiments, the value of the angle Θ may be greater than 0° and smaller than or equal to about 20°. In some embodiments, the value of the angle Θ may be greater than 0° and smaller than or equal to about 10°.

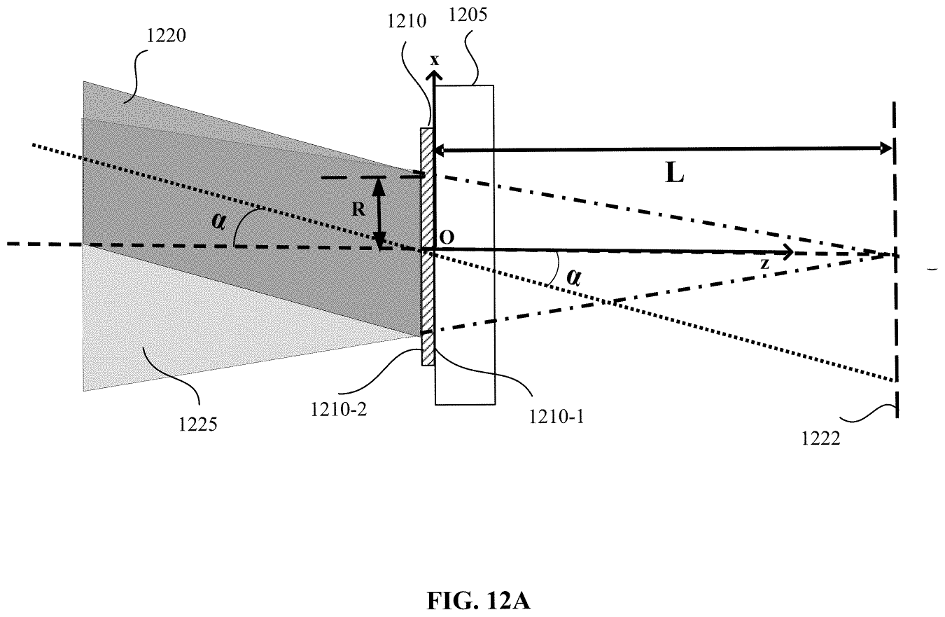

In the following, exemplary methods for fabricating off-axis focusing PBP lenses, in accordance with various embodiments of the present disclosure will be discussed. In some embodiments, exemplary methods for fabricating other off-axis focusing elements, such as off-axis focusing GP mirrors, may include steps similar to those for fabricating off-axis focusing PBP lenses. FIGS. 9A-9D schematically illustrate processes for fabricating an off-axis focusing PBP lens, according to various embodiments of the present disclosure. The fabrication process may include holographic recording of an alignment pattern in a photo-aligning film and alignment of an anisotropic material (e.g., LC) by the photo-aligning film. This alignment process may be referred to as a surface-mediated photo-alignment. The off-axis focusing PBP lens fabricated based on the fabrication processes shown in FIGS. 9A-9D may be a passive off-axis focusing PBP lens, such as the off-axis focusing PBP lens 100 shown in FIG. 1A. For illustrative purposes, the substrate and different layers or films or structures formed thereon are shown as having flat surfaces. In some embodiments, the substrate and different layers or films or structures may have curved surfaces.

As shown in FIG. 9A, a recording medium 910 may be dispensed, e.g., coated or deposited, on a surface (e.g., a top surface) of a substrate 905 to form a polarization sensitive recording medium layer (which is also represented by reference numeral 910). The recording medium 910 may be a polarization sensitive recording medium. The recording medium 910 may include an optically recordable and polarization sensitive material (e.g., a photo-alignment material) configured to have a photo-induced optical anisotropy when exposed to a polarized light irradiation. Molecules (fragments) and/or photo-products of the optically recordable and polarization sensitive material may be configured to generate an orientational ordering under a polarized light irradiation. In some embodiments, the recording medium 910 may include other ingredients, such as a solvent in which the optically recordable and polarization sensitive materials may be dissolved to form a solution. The solution may be dispensed on the substrate 905 using any suitable solution coating process, e.g., spin coating, slot coating, blade coating, spray coating, or jet (ink-jet) coating or printing, and the solvent may be removed from the coated solution using a suitable process, e.g., drying, or heating.

The substrate 905 may provide support and protection to various layers, films, and/or structures formed thereon. In some embodiments, the substrate 905 may be at least partially transparent at least in the visible wavelength band (e.g., about 380 nm to about 700 nm). In some embodiments, the substrate 905 may be at least partially transparent in at least a portion of the infrared (“IR”) band (e.g., about 700 nm to about 9 mm). The substrate 905 may include a suitable material that is at least partially transparent to lights of the above-listed wavelength ranges, such as, a glass, a plastic, a sapphire, or a combination thereof, etc. The substrate 905 may be rigid, semi-rigid, flexible, or semi-flexible. The substrate 905 may include a flat surface or a curved surface, on which the different layers or films may be formed. In some embodiments, the substrate 905 may be a part of another optical element or device (e.g., another opto-electrical element or device). For example, the substrate 905 may be a solid optical lens or a part of a solid optical lens. In some embodiments, the substrate 905 may be a part of a functional device, such as a display screen. In some embodiments, the substrate 905 may be used to fabricate, store, or transport the fabricated PBP lens. In some embodiments, the substrate 905 may be detachable or removable from the fabricated PBP lens after the PBP lens is fabricated or transported to another place or device. That is, the substrate 905 may be used in fabrication, transportation, and/or storage to support the PBP lens provided on the substrate 905, and may be separated or removed from the PBP lens when the fabrication of the PBP lens is completed, or when the PBP lens is to be implemented in an optical device. In some embodiments, the substrate 905 may not be separated from the PBP lens.

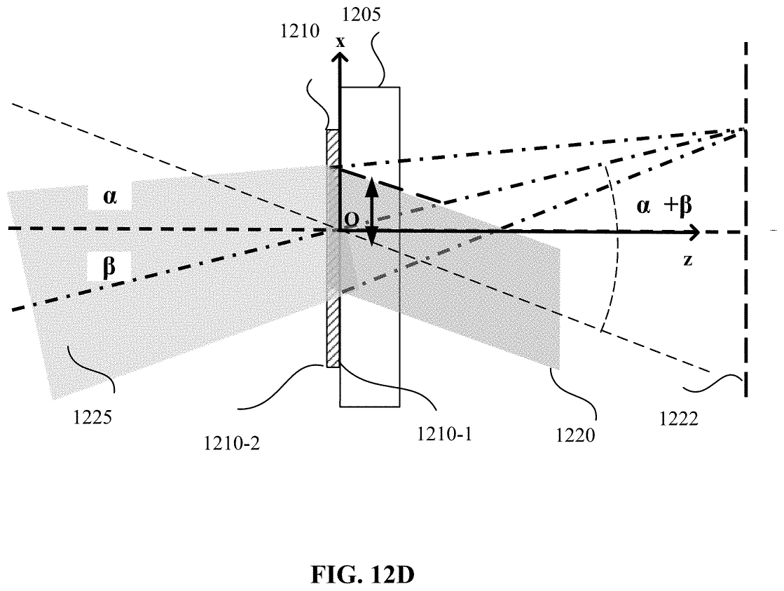

After the recording medium layer 910 is formed on the substrate 905, as shown in FIG. 9B, the recording medium layer 910 may be optically patterned through a holographic two-beam-interference exposure process. An orientation pattern of an optic axis of the recording medium layer 910 may be defined during the holographic two-beam-interference exposure process. The orientation pattern of an optic axis of the recording medium layer 910 may correspond to an off-axis focusing lens pattern. In some embodiments, as shown in FIG. 9B, two recording beams 940 and 942 may be interfered to generate a superimposed wave that has a substantially uniform intensity and a linear polarization with a spatially varying orientation (or a spatially varying linear polarization orientation angle). That is, the superimposition of the recording beams 940 and 942 may generate a polarization interference pattern, which is a pattern of the spatially varying orientation of the linear polarization of the superimposed wave. The pattern of the spatially varying orientation of the linear polarization may be configured based on a desirable off-axis focusing lens pattern to be achieved. The wavefronts and propagation directions of the two recording beams 940 and 942 shown in FIG. 9B are for illustrative purposes. Exemplary wavefronts and propagation directions of the two recording beams 940 and 942 used for the holographic two-beam-interference exposure process will be discussed in connection with FIGS. 12A-12D. The two recording beams 940 and 942 may be coherent beams having a wavelength within an absorption band of the recording medium 910, e.g. ultraviolet (“UV”), violet, blue, or green beams. The recording beams 940 and 942 may have the same wavelength. The wavelength of the recording beams 940 and 942 may be referred to as a recording wavelength. In some embodiments, the recording beams 940 and 942 may be laser beams, e.g., UV, violet, or blue laser beams. In some embodiments, the recording beams 940 and 942 may be circularly polarized beams having opposite handednesses. In some embodiments, the recording beams 940 and 942 may be circularly polarized beams having the same handedness.

In some embodiments, the recording medium 910 may include elongated anisotropic photo-sensitive units (e.g., small molecules or fragments of polymeric molecules). After being subjected to a sufficient exposure of the polarization interference pattern generated by the two recording lights 940 and 942, the polarization interference pattern may induce local alignment directions of the anisotropic photo-sensitive units in the recording medium 910, resulting in an alignment pattern (or in-plane modulation) of an optic axis of the recording medium 910 due to a photo-alignment of the anisotropic photo-sensitive units. The in-plane modulation of the optic axis of the recording medium 910 may correspond to an off-axis focusing lens pattern, such as the off-axis focusing PBP lens pattern shown in FIGS. 3A and 3B, or the off-axis focusing PBP lens pattern shown in FIG. 3C. The details of various off-axis focusing PBP lens patterns may refer to the descriptions rendered in connection with FIGS. 3A-3C. After the recording medium 910 is optically patterned or the off-axis focusing PBP lens pattern is holographically recorded in the recording medium 910, the polarization sensitive recording medium (or polarization sensitive recording medium layer) 910 may be referred to as a patterned polarization sensitive recording medium (or a patterned polarization sensitive recording medium layer) with an alignment pattern.

In some embodiments, as shown in FIG. 9C, a birefringent medium 915 may be dispensed, e.g., coated or deposited, on the patterned recording medium layer 910 to form a birefringent medium layer (or an optically anisotropic film, also represented by the reference numeral 915). The birefringent medium 915 may include one or more birefringent materials having an intrinsic birefringence, such as non-polymerizable LCs or polymerizable LCs (e.g., RMs). In some embodiments, the birefringent medium 915 may also include other ingredients, such as solvents, initiators (e.g., photo-initiators or thermal initiators), chiral dopants, or surfactants, etc. In some embodiments, the birefringent medium 915 may be coated on the patterned recording medium layer 910 using a suitable process, e.g., spin coating, slot coating, blade coating, spray coating, or jet (ink-jet) coating or printing.

The patterned recording medium 910 may be configured to provide a surface alignment (e.g., planar alignment, or homeotropic alignment, etc.) to optically anisotropic molecules (e.g., LC molecules, RM molecules, etc.) in the birefringent medium 915. For example, the patterned recording medium 910 may at least partially align the LC molecules or RM molecules in the birefringent medium layer 915 that are in contact with the patterned recording medium 910 in the off-axis focusing PBP lens pattern. In other words, the LC molecules or RM molecules in the birefringent medium layer 915 may be at least partially aligned along the local alignment directions of the anisotropic photo-sensitive units in the patterned recording medium 910 to have the off-axis focusing PBP lens pattern. Thus, the off-axis focusing PBP lens pattern recorded in the patterned recording medium layer 910 (or the in-plane orientational pattern of the optic axis of the recording medium 910) may be transferred to the birefringent medium layer 915. That is, the patterned recording medium 910 may function as a photo-alignment material (“PAM”) layer for the LCs or RMs in the birefringent medium layer 915. Such an alignment procedure may be referred to as a surface-mediated photo-alignment. The thickness of the birefringent medium layer 915 and the birefringence of the birefringent medium 915 may be configured such that the birefringent medium layer 915 may provide a phase retardation of substantially a half wave or an odd number of half waves for a wavelength (or a wavelength range) of interest, e.g., the recording wavelength or wavelength range.

In some embodiments, after the LCs or RMs in the birefringent medium 915 are aligned by the patterned recording medium 910, the birefringent medium layer 915 may be heat treated (e.g., annealed) in a temperature range corresponding to a nematic phase of the LCs or RMs in birefringent medium layer 915 to enhance the intrinsic self-organization of the LCs or RMs (not shown in FIG. 9C). In some embodiments, when the birefringent medium 915 includes polymerizable LCs (e.g., RMs), after the RMs are aligned by the patterned recording medium 910, the RMs may be polymerized, e.g., thermally polymerized or photo-polymerized to solidify the birefringent medium layer 915 and stabilize the orientational pattern of the optic axis of the birefringent medium layer 915. In some embodiments, as shown in FIG. 9D, the birefringent medium layer 915 may be irradiated with, e.g., a UV light 944. Under a sufficient UV light irradiation, the birefringent medium layer 915 may be polymerized to solidify and stabilize the orientational pattern of the optic axis of the birefringent medium layer 915. In some embodiments, the polymerization of the birefringent medium layer 915 under the UV light irradiation may be carried out in air, in an inert atmosphere formed, for example, by nitrogen, argon, carbon-dioxide, or in vacuum. Thus, an off-axis focusing PBP lens 900 may be obtained based on the holographic recording and surface-mediated photo-alignment. The off-axis focusing PBP lens 900 fabricated based on the fabrication processes shown in FIGS. 9A-9D may be a passive off-axis focusing PBP lens. The off-axis focusing PBP lens 900 may provide a phase retardation that is substantially a half wave or an odd number of half waves for a wavelength (or a wavelength range) of interest, e.g., the recording wavelength or wavelength range.

In some embodiments, as shown in FIG. 9D, the substrate 905 and/or the recording medium layer 910 may be used to fabricate, store, or transport the off-axis focusing PBP lens 900. In some embodiments, the substrate 905 and/or the recording medium layer 910 may be detachable or removable from other portions of the off-axis focusing PBP lens 900 after the other portions of the off-axis focusing PBP lens 900 are fabricated or transported to another place or device. That is, the substrate 905 and/or the patterned recording medium layer 910 may be used in fabrication, transportation, and/or storage to support the birefringent medium layer 915 provided at a surface of the recording medium layer 910, and may be separated or removed from the birefringent medium layer 915 when the fabrication of the off-axis focusing PBP lens 900 is completed, or when the off-axis focusing PBP lens 900 is to be implemented in an optical device. In some embodiments, the substrate 905 and/or the recording medium layer 910 may not be separated from the off-axis focusing PBP lens 900.

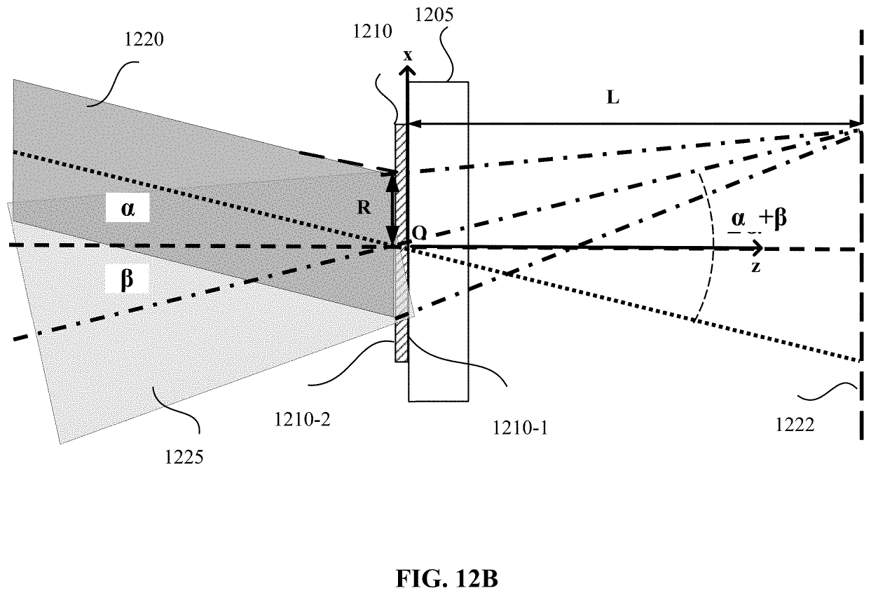

FIGS. 10A and 10B schematically illustrate processes for fabricating an off-axis focusing PBP lens, according to another embodiment of the present disclosure. The fabrication processes shown in FIGS. 10A and 10B may include steps or processes similar to those shown in FIGS. 9A-9D. The off-axis focusing PBP lens fabricated based on the processes shown in FIGS. 10A and 10B may include elements similar to those included in the off-axis focusing PBP lens fabricated based on the processes shown in FIGS. 9A-9D. Descriptions of the similar steps and similar elements can refer to the descriptions rendered above in connection with FIGS. 9A-9D. The off-axis focusing PBP lens fabricated based on the fabrication processes shown in FIGS. 10A and 10B may be an active off-axis focusing PBP lens, such as the off-axis focusing PBP lens 150 shown in FIG. 1C, the off-axis focusing PBP lens 170 shown in FIG. 1D, etc. Although the substrate and films or layers are shown as having flat surfaces, in some embodiments, the substrate and films or layers formed thereon may have curved surfaces.

As shown in FIG. 10A, two substrates 905 may be assembled to form a lens cell 1000. For example, the two substrates 905 may be bonded to each other via an adhesive 912 (e.g., optical adhesive 912) to form the lens cell 1000. At least one (e.g., each) of the two substrates 905 may be provided with one or more conductive electrode layers 1040 and a patterned recording medium layer 910. For example, one or more conductive electrode layers 1040 may be formed on the substrate 905, and a patterned recording medium layer 910 may be formed on the substrate 905 provided with the conductive electrode layer(s) 1040 following the steps or processes similar to those shown in FIGS. 9A and 9B. Each electrode layer 1040 may be provided on a surface of each substrate 905. Each patterned recording medium layer 910 may be provided on a surface of each electrode layer 1040. The conductive electrode layer 1040 may be transmissive and/or reflective at least in the same spectrum band as the substrate 905. The conductive electrode layer 1040 may be a planar continuous electrode layer or a patterned electrode layer.

After the lens cell 1000 is assembled, as shown in FIG. 10B, active LCs 1005 that are reorientable by an external field, e.g., an electric field, may be filled into the lens cell 1000 (hence 1005 may also be referred to as an active LC layer 1005). The patterned recording medium layer 910 may function as a PAM layer to the active LCs 1005 filled into the lens cell 1000, such that the active LCs 1005 may be at least partially aligned by the patterned recording medium layer 910 to have an off-axis focusing PBP lens pattern. The lens cell 1000 filled with the active LCs 1005 may be sealed via, e.g., the adhesive 912, and an active off-axis focusing PBP lens 1010 may be obtained. The active off-axis focusing PBP lens 1010 may be switchable by a voltage applied to the conductive electrode layers 1040 disposed at at least one of the substrates 905.

For illustrative purposes, FIGS. 10A and 10B show that a patterned recording medium layer 910 may be disposed at an inner surface of each of the two substrates 905. In some embodiments, the PAM layer 910 disposed at each of the two substates 905 may be configured to provide a planar alignment (or an alignment with a small pretilt angle), and the PAM layers 910 disposed at the two substates 905 may be configured to provide parallel surface alignments or anti-parallel surface alignments. In some embodiments, the PAM layers 910 disposed at the two substates 905 may be configured to provide hybrid surface alignments. For example, the PAM layer 910 disposed at one of the two substates 905 may be configured to provide a planar alignment (or an alignment with a small pretilt angle) corresponding to an off-axis focusing PBP lens pattern, and the PAM layer 910 disposed at the other substate 905 may be configured to provide a homeotropic alignment. Although not shown, in some embodiments, one of the substrates 905 may be provided with the PAM layer 910, and the other one of the substrates 905 may not be provided with the PAM layer 910.

For illustrative purposes, FIGS. 10A and 10B show that a conductive electrode layer 1040 may be disposed at each of the two substrates 905. That is, each of the two substrates 905 may be provided with a conductive electrode layer 1040 that is disposed between the patterned recording medium layer 910 and the substrate 905. In the embodiment shown in FIGS. 10A and 10B, the conductive electrode layer 1040 disposed at each of the two substrates 905 may be a continuous planar electrode layer. A driving voltage may be applied to the conductive electrode layers 1040 disposed at the two parallel substrates 905 to generate a vertical electric field to reorient the LC molecules, thereby switching the optical properties of the off-axis focusing PBP lens 1010. That is, the conductive electrode layers 1040 are disposed at two sides of the active LC layer 1005.

In some embodiments, the two conductive electrode layers 1040 may be disposed at the same substrate 905. For example, as shown in FIG. 10C, two substates 905 may be assembled to form a lens cell 1020. One substrate 905 (e.g., an upper substrate) may not be provided with a conductive electrode layer, while the other substrate 905 (e.g., a lower substrate) may be provide with two conductive electrode layers (e.g., 1040a and 1040b) and an electrically insulating layer 1060 disposed between the two conductive electrode layers. The two conductive electrode layers 1040a and 1040b may include a continuous planar electrode layer 1040a and a patterned electrode layer 1040b. The patterned electrode layer 1040b may include a plurality of striped electrodes arranged in parallel in an interleaved manner. After the lens cell 1020 is filled with active LCs 1005 (forming an active LC layer 1005) and sealed, an active off-axis focusing PBP lens 1025 may be obtained. A voltage may be applied between the continuous planar electrode layer 1040a and the patterned electrode layer 1040b disposed at the same side of the active LC layer 1005, e.g., on the same substrate 905 (e.g., the lower substrate 915), to generate a horizontal electric field to reorient the LC molecules, thereby switching the optical properties of the fabricated off-axis focusing PBP lens.

In some embodiments, as shown in FIG. 10D, two substates 905 may be assembled to form a lens cell 1060. One substrate 905 (e.g., an upper substrate) may not be provided with a conductive electrode layer, while the other substrate 905 (e.g., a lower substrate) may be provide with a conductive electrode layer 1040. The conductive electrode layer 1040 may include interdigitated electrodes, which may include two individually addressable interdigitated comb-like electrode structures 1041 and 1042. After the lens cell 1060 is filled with active LCs 1005 (forming an active LC layer 1005) and sealed, an active off-axis focusing PBP lens 1065 may be obtained. A voltage may be applied between the interdigitated comb-like electrode structures 1041 and 1042 disposed at the same side of the active LC layer 1005, e.g., on the same substrate 905 (e.g., the lower substrate 905), to generate a horizontal electric field to reorient the LC molecules in the active LC layer 1005, thereby switching the optical properties of the fabricated off-axis focusing PBP lens.

Referring back to FIGS. 10A-10D, in some embodiments, the recording medium layer(s) may not be optically patterned before the lens cell is assembled, instead, the recording medium layer(s) may be optically patterned after the lens cell is assembled. For example, two substrates 905 may be assembled to form a lens cell. At least one of the two substrates 905 may be provided with one or more conductive electrode layers 1040 and a recording medium layer (that has not been optically patterned yet). Then the lens cell may be exposed to a holographic two-beam-interference, which may be similar to that shown in FIG. 9B. Accordingly, the recording medium layer disposed at the substrate may be optically patterned to provide an alignment pattern corresponding to a lens pattern (e.g., an off-axis focusing PBP lens pattern). After the lens cell is filled with active LCs and sealed, an active off-axis focusing PBP lens may be obtained.

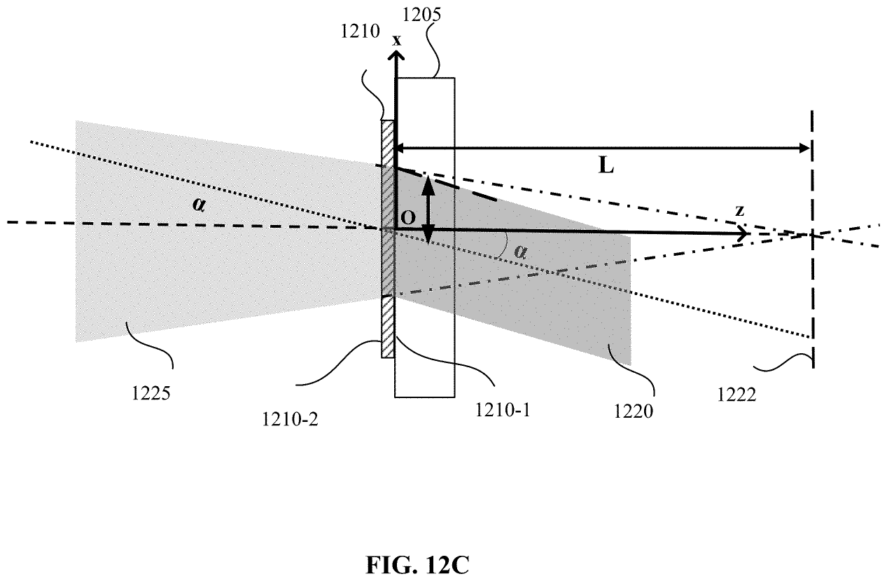

FIGS. 11A and 11B schematically illustrate processes for fabricating an off-axis focusing PBP lens, according to another embodiment of the present disclosure. The fabrication process may include holographic recording and bulk-mediated photo-alignment. The fabrication processes shown in FIGS. 11A and 11B may include steps or processes similar to those shown in FIGS. 9A and 9B. The off-axis focusing PBP lens fabricated based on the processes shown in FIGS. 11A and 11B may include elements similar to those included in the off-axis focusing PBP lens fabricated based on the processes shown in FIGS. 9A and 9B. Descriptions of the similar steps and similar elements can refer to the descriptions rendered above in connection with FIGS. 9A and 9B. The off-axis focusing PBP lens fabricated based on the fabrication processes shown in FIGS. 11A and 11B may be a passive off-axis focusing PBP lens, such as the off-axis focusing PBP lens 130 shown in FIG. 1B. Although the substrate and films or layers are shown as having flat surfaces, in some embodiments, the substrate and films or layers formed thereon may have curved surfaces.

Similar to the embodiment shown in FIGS. 9A and 9B, the processes shown in FIGS. 11A and 11B may include dispensing (e.g., coating, depositing, etc.) a recording medium 1120 on a surface (e.g., a top surface) of a substrate 1105 to form a recording medium layer (which is also represented by the reference numeral 1120). The recording medium 1120 may be a polarization sensitive recording medium. The recording medium 1120 may include an optically recordable and polarization sensitive material (e.g., a photo-alignment material) configured to have a photoinduced optical anisotropy when exposed to a polarized light irradiation. Molecules (fragments) and/or photo-products of the optically recordable and polarization sensitive material may generate anisotropic angular distributions in a film plane of the recording medium 1120 under a polarized light irradiation. In some embodiments, the recording medium 1120 may include other ingredients, such as a solvent in which the optically recordable and polarization sensitive materials may be dissolved to form a solution, and photo-sensitizers. The solution may be dispensed on the substrate 1105 using a suitable process, e.g., spin coating, slot coating, blade coating, spray coating, or jet (ink-jet) coating or printing, and the solvent may be removed from the coated solution using a suitable process, e.g., drying, or heating.

After the recording medium layer 1120 is formed on the substrate 1105, as shown in FIG. 11B, the recording medium layer 1120 may be optically patterned through a holographic two-beam-interference exposure process. An orientation pattern of an optic axis of the recording medium layer 1120 may be defined during the holographic two-beam-interference exposure process. The orientation pattern of an optic axis of the recording medium layer 1120 may correspond to an off-axis focusing lens pattern. In some embodiments, as shown in FIG. 11B, two recording beams 1140 and 1142 may be interfered to generate a superimposed wave that has a substantially uniform intensity and a linear polarization with a spatially varying orientation (or a spatially varying linear polarization orientation angle). That is, the superimposition of the recording beams 1140 and 1142 may generate a polarization interference pattern, which is a pattern of the spatially varying orientation of the linear polarization of the superimposed wave. The pattern of the spatially varying orientation of the linear polarization may correspond to the off-axis focusing lens pattern. The wavefronts and propagation directions of the two recording beams 1140 and 1142 shown in FIG. 11B are for illustrative purposes. Exemplary wavefronts and propagation directions of the two recording beams 1140 and 1142 used for the holographic two-beam-interference exposure process will be discussed in connection with FIGS. 12A-12D.

The two recording beams 1140 and 1142 may be coherent beams having a wavelength within an absorption band of the recording medium 1120, e.g. UV, violet, blue, or green beams. The wavelength of the recording beams 1140 and 1142 may be referred to as a recording wavelength. In some embodiments, the recording beams 1140 and 1142 may be laser beams, e.g., UV, violet, or blue laser beams. In some embodiments, the recording beams 1140 and 1142 may be circularly polarized beams with opposite handednesses. In some embodiments, the recording beams 1140 and 1142 may be circularly polarized beams having the same handedness.

In the embodiment shown in FIGS. 11A and 11B, the recording medium 1120 may include a photo-sensitive polymer, and molecules of the photo-sensitive polymer may include one or more polarization sensitive photo-reactive groups embedded in a main polymer chain or a side polymer chain. During the holographic two-beam-interference exposure of the recording medium layer 1120, a photo-alignment of the polarization sensitive photo-reactive groups may occur in a volume of the recording medium layer 1120. That is, a 3D polarization field generated by the interface of the two coherent lights 1140 and 1142 may be directly recorded in the volume of the recording medium layer 1120. Such an alignment procedure shown in FIG. 11B may be referred to as a bulk-mediated photo-alignment. In the embodiment shown in FIGS. 11A and 11B, an in-plane orientational pattern of the optic axis may be directly recorded in the recording medium layer 1120 via the bulk-mediated photo-alignment. A step of disposing an additional birefringent medium layer on the patterned recording medium layer 1120 may be omitted. The patterned recording medium layer 1120 may function as an off-axis focusing PBP lens 1100.

In some embodiments, the photo-sensitive polymer included in the recording medium 1120 may include an amorphous polymer, an LC polymer, etc. The molecules of the photo-sensitive polymer may include one or more polarization sensitive photo-reactive groups embedded in a main polymer chain or a side polymer chain. In some embodiments, the polarization sensitive photo-reactive group may include an azobenzene group, a cinnamate group, or a coumarin group, etc. In some embodiments, the photo-sensitive polymer may be an amorphous polymer, which may be initially optically isotropic prior to undergoing the holographic two-beam-interference exposure process, and may exhibit an induced (e.g., photo-induced) optical anisotropy after being subjected to the holographic two-beam-interference exposure process. In some embodiments, the photo-sensitive polymer may be an LC polymer, in which the birefringence and in-plane orientational pattern may be recorded due to an effect of photo-induced optical anisotropy. In some embodiments, the photo-sensitive polymer may be an LC polymer with a polarization sensitive cinnamate group embedded in a side polymer chain. An example of the LC polymer with a polarization sensitive cinnamate group embedded in a side polymer chain is an LC polymer M1. The LC polymer M1 has a nematic mesophase in a temperature range of about 115° C. to about 300° C. An optical anisotropy may be induced by irradiating a film of the LC polymer M1 with a polarized UV light (e.g., a laser light with a wavelength of 325 nm or 355 nm). In some embodiments, the induced optical anisotropy may be subsequently enhanced by more than an order of magnitude by annealing the patterned recording medium 1120 at a temperature range of about 115° C. to about 300° C. In some embodiments, the annealing of the patterned recording medium 1120 may be omitted.

The LC polymer M1 is an example of an LC polymer with a polarization sensitive cinnamate group embedded in a side polymer chain. The dependence of the photo-induced birefringence on exposure energy is qualitatively similar for other materials from liquid crystalline polymers of M series. Liquid crystalline polymers of M series are discussed in U.S. patent application Ser. No. 16/443,506, filed on Jun. 17, 2019, titled “Photosensitive Polymers for Volume Holography,” published as U.S. 2020/0081398, which is incorporated by reference for all purposes (including the descriptions of the M series). In some embodiments, when the recording medium layer 1120 includes an LC polymer, the patterned recording medium layer 1120 may be heat treated (e.g., annealed) in a temperature range corresponding to a liquid crystalline state of the LC polymer to enhance the photo-induced optical anisotropy due to an intrinsic self-organization of the LC polymer (not shown in FIG. 11B). The recording medium layer 1120 for a bulk-mediated photo-alignment shown in FIG. 11B may be relatively thicker than the recording medium layer 910 for a surface-mediated photo-alignment shown in FIGS. 9B-9D.

The substrate 1105 may be similar to the substrate 905 shown in FIGS. 9A-9D. In some embodiments, the substrate 1105 may be used to fabricate, store, or transport the off-axis focusing PBP lens 1100. In some embodiments, the substrate 1105 may be detachable or removable from the off-axis focusing PBP lens 1100 after the off-axis focusing PBP lens 1100 is fabricated or transported to another place or device. That is, the substrate 1105 may be used in fabrication, transportation, and/or storage to support the off-axis focusing PBP lens 1100 provided on the substrate 1105, and may be separated or removed from the off-axis focusing PBP lens 1100 when the fabrication of the off-axis focusing PBP lens 1100 is completed, or when the off-axis focusing PBP lens 1100 is to be implemented in an optical device. In some embodiments, the substrate 1105 may not be separated from the off-axis focusing PBP lens 1100.

FIGS. 12A-12D schematically illustrate holographic two-beam-interference exposure processes shown in FIG. 9B or FIG. 11B, according to various embodiments of the present disclosure. FIGS. 12A and 12B schematically illustrate holographic two-beam-interference exposure processes for fabricating an off-axis focusing PBP lens. As shown in FIGS. 12A-12B, two recording beams, e.g., a first recording beam (a reference beam) 1220 and a second recording beam (a signal beam) 1225, may be interfered to generate a polarization interference pattern that is recorded into a polarization sensitive recording medium (or medium layer) 1210. In the coordinate system shown in FIGS. 12A and 12B, the z-axis is a symmetry axis of the signal beam 1225, and the origin (“O”) is an intersection of the z-axis with the plane of the recording medium layer 1210. The polarization interference pattern may correspond to a desirable off-axis focusing lens pattern. According to the wavefront of the second recording beam (signal beam) 1225, the polarization interference pattern may correspond to a lens pattern of an off-axis focusing PBP spherical lens, an off-axis focusing PBP cylindrical lens, an off-axis focusing PBP aspherical lens, or an off-axis focusing PBP freeform lens, etc. The two recording beams 1220 and 1225 may be embodiments of the two recording beams 940 and 942 shown in FIG. 9B or embodiments of the two recording beams 1140 and 1142 shown in FIG. 11B. The polarization sensitive recording medium (layer) 1210 may be an embodiment of the recording medium (layer) 910 shown in FIG. 9B or an embodiment of the recording medium (layer) 1120 shown in FIG. 11B.

In some embodiments, the reference beam 1220 and the signal beam 1225 may be circularly polarized beams having opposite handednesses. In some embodiments, the reference beam 1220 and the signal beam 1225 may be circularly polarized beams having the same handedness. In some embodiments, the reference beam 1220 may be a collimated beam having a planar wavefront, and the signal beam 1225 may be a converging or diverging beam having a non-planar wavefront. According to the wavefront of the signal beam 1225, an off-axis focusing PBP lens fabricated based on the patterned recording medium (layer) 1210 may function as a spherical lens, a cylindrical lens, an aspherical lens, or a freeform lens, etc. In some embodiments, to fabricate an off-axis focusing PBP lens functioning as a spherical lens, the signal beam 1225 may be a converging or diverging beam having a spherical wavefront. In some embodiments, to fabricate an off-axis focusing PBP lens functioning as a cylindrical lens, the signal beam 1225 may be a converging or diverging beam having a cylindrical wavefront. In some embodiments, to fabricate an off-axis focusing PBP lens functioning as an aspherical lens, the signal beam 1225 may be a converging or diverging beam having an aspherical wavefront. In some embodiments, to fabricate an off-axis focusing PBP lens functioning as a freeform lens, the signal beam 1225 may be a converging or diverging beam having a freeform wavefront corresponding to a focused or defocused beam. In some embodiments, to fabricate a transmissive off-axis focusing PBP lens, the reference beam 1220 and the signal beam 1225 may be configured to be circularly polarized beams with opposite handednesses and propagating toward the same surface of the recording medium layer 1210. In some embodiments, to fabricate a reflective off-axis focusing PBP lens, the reference beam 1220 and the signal beam 1225 may be configured to be circularly polarized beams with the same handedness and propagating toward different surfaces of the recording medium layer 1210.

FIG. 12A shows a holographic two-beam-interference exposure process based on an x-z sectional view of the polarization sensitive recording medium layer 1210 and the substrate 1205, according to an embodiment of the present disclosure. As shown in FIG. 12A, the reference beam 1220 and the signal beam 1225 may propagate toward the recording medium layer 1210 from the same side of the recording medium layer 1210 (e.g., from the left side of the recording medium layer 1210 shown in FIG. 12A). The reference beam 1220 and the signal beam 1225 may be circularly polarized beams with opposite handednesses. For example, one of the reference beam 1220 and the signal beam 1225 may be a right-handed circular polarized (“RHCP”) beam, and the other may be a left-handed circular polarized (“LHCP”) beam. The recording medium layer 1210 may have a first surface 1210-1 facing the substrate 1205 and an opposing, second surface 1210-2. The reference beam 1220 and the signal beam 1225 may propagate toward the recording medium layer 1210 from the same side of the recording medium layer 1210, and may be incident onto the same surface of the recording medium layer 1210, for example, the second surface 1210-2 of the recording medium layer 1210. In some embodiments, as shown in FIG. 12A, the reference beam 1220 may be a collimated circularly polarized beam having a propagation direction forming an angle α with respect to a normal of the second surface 1210-2 of the recording medium layer 1210, where the angle α is an acute angle. In some embodiments, the absolute value of the angle α may be greater than 0° and smaller than or equal to about 45°. In some embodiments, the absolute value of the angle α may be greater than 0° and smaller than or equal to about 30°. In some embodiments, the absolute value of the angle α may be greater than 0° and smaller than or equal to about 20°. In some embodiments, the absolute value of the angle α may be greater than 0° and smaller than or equal to about 10°. In some embodiments, the absolute value of the angle α may be greater than 0° and smaller than or equal to about 5°.

The signal beam 1225 may be a converging or diverging circularly polarized beam that is normally incident onto the second surface 1210-2 of the recording medium layer 1210. That is, the signal beam 1225 may have a propagation direction forming a substantially zero degree angle with respect to the normal of the second surface 1210-2 of the recording medium layer 1210. Thus, a propagation direction of the reference beam 1220 may not be parallel with a propagation direction of the signal beam 1225. Instead, the propagation direction of the reference beam 1220 may form an angle Θ with respect to the propagation direction of the signal beam 1225. The angle Θ is an acute angle, and a value of the angle Θ may be equivalent to a value of the angle α. In some embodiments, the absolute value of the angle Θ may be greater than 0° and smaller than or equal to about 45°. In some embodiments, the absolute value of the angle Θ may be greater than 0° and smaller than or equal to about 30°. In some embodiments, the absolute value of the angle Θ may be greater than 0° and smaller than or equal to about 20°. In some embodiments, the absolute value of the angle Θ may be greater than 0° and smaller than or equal to about 10°. In some embodiments, the absolute value of the angle Θ may be greater than 0° and smaller than or equal to about 5°.

In some embodiments, the reference beam 1220 may be a collimated circularly polarized beam having a planar wavefront, and the signal beam 1225 may be a converging or diverging circularly polarized beam having a spherical wavefront. The recording medium layer 1210 may be optically patterned, via the holographic two-beam-interference exposure process, to have an off-axis focusing lens pattern similar to that shown in FIGS. 3A and 3B. An off-axis focusing PBP lens fabricated based on the patterned recording medium layer 1210 may function as an off-axis focusing spherical lens. In some embodiments, the Jones vectors of the reference beam 1220 and the signal beam 1225 may be

$${E}_{1} = ( \begin{matrix}1 \\ i\end{matrix} ) {e}^{- i \frac{2 π}{λ} x * sin α} and {E}_{2} = ( \begin{matrix}1 \\ - i\end{matrix} ) {e}^{- i \frac{π {r}^{2}}{L λ}} ,$$

respectively, where λ is a recording wavelength that is a wavelength of the reference beam 1220 and the signal beam 1225, r is a distance from the origin (“O”) to a local point on the recording medium layer 1210. R is the radius of the spherical wavefront of the signal beam 1225 (R is also a radius of the aperture of the off-axis focusing PBP lens fabricated based on the recording medium layer 1210), and L is a distance between the recording medium layer 1210 and a focal plane 1222 of the fabricated off-axis focusing PBP lens. When the reference beam 1220 and the signal beam 1225 are interfered, the Jones vector of resulted field of the two interfering beams may be

$${E}_{tot} = ( \begin{matrix}1 \\ i\end{matrix} ) {e}^{- i \frac{2 π}{λ} x * sin α} + ( \begin{matrix}1 \\ - i\end{matrix} ) {e}^{- i \frac{{π r}^{2}}{L λ}} = ( \begin{matrix}{e}^{- i \frac{2 π}{λ} x * sin α} + {e}^{- i \frac{{π r}^{2}}{L λ}} \\ i ( {e}^{- i \frac{2 π}{λ} x * sin α} - {e}^{- i \frac{{π r}^{2}}{L λ}} )\end{matrix} ) = {e}^{- i \frac{2 π}{λ} x * sin α} ( \begin{matrix}1 + {e}^{i ( \frac{- {π r}^{2}}{L * λ} + \frac{2 π}{λ} x * sin α )} \\ i ( 1 - {e}^{i ( \frac{- {π r}^{2}}{L λ} + \frac{2 π}{λ} x * sin α )} )\end{matrix} ) = 2 {e}^{- i ( \frac{{π r}^{2}}{2 L λ} + \frac{π}{λ} x * sin α )} ( \begin{matrix}cos ( - \frac{{π r}^{2}}{2 L λ} + \frac{π}{λ} x * sin α ) \\ sin ( - \frac{{π r}^{2}}{2 L λ} + \frac{π}{λ} x * sin α )\end{matrix} ) . \qquad ( 1 )$$

The equation (1) shows that the interference of the reference beam 1220 and the signal beam 1225 in the plane of the recording medium layer 1210 may generate spatially varying linear polarization fields. The light polarizations in the resulting polarization fields may be linear polarizations with an azimuthal angle expressed as

$$θ = \frac{{π r}^{2}}{2 L λ} + \frac{π}{λ} sin ( α ) * x .$$

The optical (geometric) phase introduced by the fabricated off-axis focusing PBP lens may be

$$Γ = 2 θ = \frac{{π r}^{2}}{2 L λ} + \frac{π}{λ} sin ( α ) * x ,$$

which may include a focusing term

$$\frac{{π r}^{2}}{L λ}$$

and a tilting term

$$\frac{2 π}{λ} sin ( α ) * x .$$

In the formula of the optical (geometric) phase introduced by the fabricated off-axis focusing PBP lens for other suitable fabrication technique, a non-zero coefficient K may replace sin(a) associated with the holographic recording techniques. Then the formula of the optical (geometric) phase introduced by the fabricated off-axis focusing PBP lens may be expressed as

$$Γ = \frac{{π r}^{2}}{L λ} + \frac{2 π}{λ} K * x .$$

In some embodiments, when an on-axis collimated circularly polarized light having a predetermined handedness and a wavelength that is substantially the same as the recording wavelength is incident onto the fabricated off-axis focusing PBP lens, the fabricated off-axis focusing PBP lens may focus the on-axis collimated circularly polarized light to an off-axis focal point (or focus) F_{off}. In some embodiments, a propagation direction of the circularly polarized light transmitted through the fabricated off-axis focusing PBP lens may form the angle Θ (having a value that is the same as the value of the angle α) with respect to the normal of the surface of the recording medium layer 1210. The off-axis focal point F_{off} may be shifted from the out-of-plane geometry center axis (or the lens axis) by a distance d (or focus shift d) in a predetermined direction, for example, in the −x-axis direction. The focus shift din the focal plane 1222 may be expressed as d=L*tan(α), where L is the distance between the recording medium layer 1210 and the focal plane 1222 of the fabricated off-axis focusing PBP lens for the recording wavelength.

FIG. 12B shows a holographic two-beam-interference exposure process based on an x-z sectional view of the substrate 1205 and the recording medium layer 1210, according to another embodiment of the present disclosure. The holographic two-beam-interference exposure process shown in FIG. 12B may include elements, structures, and/or functions that are the same as or similar to those included in the holographic two-beam-interference exposure process shown in FIG. 12A. Descriptions of the same or similar elements, structures, and/or functions can refer to the above descriptions rendered in connection with FIG. 12A.

As shown in FIG. 12B, the reference beam 1220 and the signal beam 1225 may be circularly polarized beams with opposite handednesses. The reference beam 1220 and the signal beam 1225 may propagate toward the recording medium layer 1210 from the same side of the recording medium layer 1210 (e.g., from the left side of the recording medium layer 1210 shown in FIG. 12A), and may be incident onto the same surface of the recording medium layer 1210, for example, the second surface 1210-2 of the recording medium layer 1210. In some embodiments, as shown in FIG. 12B, the reference beam 1220 may be a collimated circularly polarized beam having a propagation direction forming an angle α with respect to a normal of the second surface 1210-2 of the recording medium layer 1210. The signal beam 1225 may be a converging or diverging circularly polarized beam having a propagation direction forming an angle β with respect to a normal of the second surface 1210-2 of the recording medium layer 1210.

In some embodiments, the angle α and angle β may be acute angles having different signs, for example, the angle α may be a positive acute angle, and the angle β may be a negative acute angle. In some embodiments, the angle α and angle β may be acute angles having the same sign. The absolute values of the angle α and angle β may be the same or different. Thus, a propagation direction of the reference beam 1220 may not be parallel with (i.e., may be non-parallel with) a propagation direction of the signal beam 1225, and the propagation direction of the reference beam 1220 may form an angle Θ with respect to the propagation direction of the signal beam 1225, where the value of the angle Θ may be a sum of the absolute value of the angle α and the absolute value of the angle β. The value of the angle Θ may be greater than 0° and smaller than 180°. In some embodiments, the absolute values of the angle α and angle β may be the same, and the value of the angle Θ may be twice the value of the angle α.

In some embodiments, the absolute value of the angle α may be greater than 0° and smaller than or equal to about 45°. In some embodiments, the absolute value of the angle α may be greater than 0° and smaller than or equal to about 30°. In some embodiments, the absolute value of the angle α may be greater than 0° and smaller than or equal to about 20°. In some embodiments, the absolute value of the angle α may be greater than 0° and smaller than or equal to about 10°. In some embodiments, the absolute value of the angle α may be greater than 0° and smaller than or equal to about 5°. In some embodiments, the absolute value of the angle β may be greater than 0° and smaller than or equal to about 45°. In some embodiments, the absolute value of the angle β may be greater than 0° and smaller than or equal to about 30°. In some embodiments, the absolute value of the angle β may be greater than 0° and smaller than or equal to about 20°. In some embodiments, the absolute value of the angle θ may be greater than 0° and smaller than or equal to about 10°. In some embodiments, the absolute value of the angle β may be greater than 0° and smaller than or equal to about 5°. In some embodiments, the absolute value of the angle Θ may be greater than 0° and smaller than or equal to about 90°. In some embodiments, the absolute value of the angle Θ may be greater than 0° and smaller than or equal to about 60°. In some embodiments, the absolute value of the angle Θ may be greater than 0° and smaller than or equal to about 40°. In some embodiments, the absolute value of the angle Θ may be greater than 0° and smaller than or equal to about 20°. In some embodiments, the absolute value of the angle Θ may be greater than 0° and smaller than or equal to about 10°.

In some embodiments, the reference beam 1220 may be a collimated circularly polarized beam having a planar wavefront, and the signal beam 1225 may be a converging or diverging circularly polarized beam having a spherical wavefront. The recording medium layer 1210 may be optically patterned, via the holographic two-beam-interference exposure process, to have a lens pattern similar to that shown in FIGS. 3A and 3B. An off-axis focusing PBP lens fabricated based on the patterned recording medium layer 1210 may function as an off-axis focusing spherical lens. For example, the Jones vectors of the of the reference beam 1220 and the signal beam 1225 may be

$${E}_{1} = ( \begin{matrix}1 \\ i\end{matrix} ) {e}^{- i \frac{2 π}{λ} x * sin α}$$

$$and$$

$${E}_{2} = ( \begin{matrix}1 \\ - i\end{matrix} ) {e}^{i ( - \frac{{π r}^{2}}{L λ} + \frac{2 π}{λ} x * sin α )} ,$$

respectively, where λ is a recording wavelength that is a wavelength of the reference beam 1220 and the signal beam 1225, and r is a distance from the origin (“O”) to a local point on the recording medium layer 1210. R is the radius of the spherical wavefront of the signal beam 1225 (R is also a radius of the aperture of the off-axis focusing PBP lens fabricated based on the recording medium layer 1210), and L is a distance between the recording medium layer 1210 and the focal plane 1222 of the fabricated off-axis focusing PBP lens. When the reference beam 1220 and the signal beam 1225 are interfered, the Jones vector of resulting fields of the two interfering beams may be

$${E}_{1} = ( \begin{matrix}1 \\ i\end{matrix} ) {e}^{- i \frac{2 π}{λ} x * sin α} + ( \begin{matrix}1 \\ - i\end{matrix} ) {e}^{i ( - \frac{{π r}^{2}}{L λ} + \frac{2 π}{λ} x * sin α )} = {e}^{- i ( \frac{{π r}^{2}}{2 L λ} + \frac{2 π}{λ} x * sin α )} ( \begin{matrix}cos ( - \frac{{π r}^{2}}{2 L λ} + \frac{π}{λ} x * sin α ) \\ sin ( - \frac{{π r}^{2}}{2 L λ} + \frac{π}{λ} x * sin α )\end{matrix} ) . \qquad ( 2 )$$

The equation (2) shows that the interference of the reference beam 1220 and the signal beam 1225 may generate spatially varying linear polarization fields. The light polarizations in the resulting polarization fields may be linear polarizations with an azimuthal angle

$$θ = \frac{{π r}^{2}}{2 L λ} + \frac{2 π}{λ} sin ( α ) + x .$$

The optical (geometric) phase introduced by the fabricated off-axis focusing PBP lens may be

$$Γ = 2 θ = \frac{{π r}^{2}}{L λ} + \frac{4 π}{λ} sin ( α ) * x ,$$

which may include a focusing term

$$\frac{π r}{L λ}$$

and a tilting term

$$\frac{4 π}{λ} sin ( α ) * x .$$

The tilting term

$$\frac{4 π}{λ} sin ( α ) * x$$

in the phase equation deduced from the equation (2) is twice of the tilting term

$$\frac{2 π}{λ} sin ( α ) * x$$

in the phase equation deduced from the equation (1). In the formula of the optical (geometric) phase introduced by the fabricated off-axis focusing PBP lens for other suitable fabrication technique, a non-zero coefficient K may replace sin(a) associated with the holographic recording techniques. Then the formula of the optical (geometric) phase introduced by the fabricated off-axis focusing PBP lens may be expressed as

$$Γ = \frac{{π r}^{2}}{L λ} + \frac{2 π}{λ} K * x .$$

In some embodiments, when an on-axis collimated circularly polarized light having a predetermined handedness and a wavelength that is substantially the same as the recording wavelength is incident onto the fabricated off-axis focusing PBP lens, the fabricated off-axis focusing PBP lens may focus the on-axis collimated circularly polarized light to an off-axis focal point (or focus) F_{off}. In some embodiments, a propagation direction of the circularly polarized light transmitted through the fabricated off-axis focusing PBP lens may form the angle Θ (having a value that is twice the value of the angle α) with respect to the normal of the surface of the recording medium layer 1210. The off-axis focal point F_{off} may be shifted from the out-of-plane geometry center axis (or the lens axis) by a distance din a predetermined direction, for example, in the −x-axis direction. The focus shift din the focal plane 1222 may be expressed as d=L*tan(2α), where L is the distance between the recording medium layer 1210 and the focal plane 1222 of the fabricated off-axis focusing PBP lens.

FIGS. 12C and 12D schematically illustrate holographic two-beam-interference exposure processes for fabricating an off-axis focusing GP mirror or lens. In the coordinate system shown in FIGS. 12C and 12D, the z-axis is a symmetry axis of the signal beam 1225, and the origin (“O”) is an intersection of the z-axis with the plane of the recording medium layer 1210. FIG. 12C shows a holographic two-beam-interference exposure process based on an x-z sectional view of the substrate 1205 and the recording medium layer 1210, according to an embodiment of the present disclosure. The holographic two-beam-interference exposure process shown in FIG. 12C may include elements, structures, and/or functions that are the same as or similar to those included in the holographic two-beam-interference exposure process shown in FIGS. 12A and 12B. Descriptions of the same or similar elements, structures, and/or functions can refer to the above descriptions rendered in connection with FIGS. 12A and 12B.

As shown in FIG. 12C, the reference beam 1220 and the signal beam 1225 may propagate toward the recording medium layer 1210 from different sides of the recording medium layer 1210, and may be incident onto different surfaces of the recording medium layer 1210. For illustrative purposes, the reference beam 1220 may be incident onto the first surface 1210-1 of the recording medium layer 1210, and the signal beam 1225 may be incident onto the second surface 1210-2 of the recording medium layer 1210. The reference beam 1220 and the signal beam 1225 may be circularly polarized beams with the same handedness. For example, both the reference beam 1220 and the signal beam 1225 may be RHCP beams or LHCP beams. In some embodiments, as shown in FIG. 12C, the reference beam 1220 may be a collimated circularly polarized beam having a propagation direction forming an angle α with respect to a normal of the first surface 1210-1 of the recording medium layer 1210. The signal beam 1225 may be a converging or diverging circularly polarized beam that is substantially normally incident onto the second surface 1210-2 of the recording medium layer 1210. That is, the signal beam 1225 may have a propagation direction forming a substantially zero angle with respect to the normal of the second surface 1210-2 of the recording medium layer 1210. Thus, a propagation direction of the reference beam 1220 may not be parallel with a propagation direction of the signal beam 1225. Instead, the propagation direction of the reference beam 1220 may form an angle Θ with respect to the propagation direction of the signal beam 1225. The angle Θ is an acute angle, and a value of the angle Θ may be equivalent to a value of the angle α.

The interference between the reference beam 1220 and the signal beam 1225 may result in spatially varying linear polarization fields. In some embodiments, the linear polarizations may rotate along a direction parallel to the thickness direction of the recording medium layer 1210, forming helical structures similar to cholesteric helical structures. In some embodiments, the linear polarizations may rotate along a direction tilted with respect to the thickness direction of the recording medium layer 1210, forming helical structures similar to cholesteric helical structures. The direction along which the linear polarizations rotate may be referred to as a helical axis direction. An off-axis focusing GP optical element fabricated based on the patterned recording medium layer 1210 may function as an off-axis focusing GP mirror or an off-axis focusing GP lens, depending on the value of an angle formed between the helical axis direction and the thickness direction of the recording medium layer 1210. The off-axis focusing GP mirror including helical structures may also be referred to as an off-axis focusing reflective polarization volume hologram (“PVH”). The off-axis focusing GP lens including helical structures may also be referred to as an off-axis focusing transmissive PVH.

In some embodiments, the reference beam 1220 may be a collimated circularly polarized beam having a planar wavefront, and the signal beam 1225 may be a converging or diverging circularly polarized beam having a spherical wavefront. The recording medium layer 1210 may be optically patterned, via the holographic two-beam-interference exposure process, to have an off-axis focusing lens/mirror pattern similar to that shown in FIGS. 3A and 3B. An off-axis focusing GP optical element fabricated based on the patterned recording medium layer 1210 may function as an off-axis focusing PBP spherical lens or an off-axis focusing GP mirror.

In some embodiments, when an on-axis collimated circularly polarized light having predetermined handedness and a wavelength that is substantially the same as the recording wavelength is incident onto the fabricated off-axis focusing GP mirror, the fabricated off-axis focusing GP mirror may reflect and focus the on-axis collimated circularly polarized light to an off-axis focal point (or focus) F_{off}. In some embodiments, a propagation direction of the circularly polarized light reflected by the fabricated off-axis focusing GP mirror may form the angle Θ (having a value that is the same as the value of the angle α) with respect to the normal of the surface of the recording medium layer 1210. The off-axis focal point F_{off} may be shifted from the out-of-plane geometry center axis (or the lens axis) by a distance din a predetermined direction, for example, in the −x-axis direction. The focus shift din the focal plane 1222 may be expressed as d=L*tan(α), where L is the distance between the recording medium layer 1210 and the focal plane 1222 of the fabricated off-axis focusing GP mirror.

In some embodiments, when an on-axis collimated circularly polarized light having predetermined handedness and a wavelength that is substantially the same as the recording wavelength is incident onto the fabricated off-axis focusing PBP lens, the fabricated off-axis focusing PBP lens may transmit and focus the on-axis collimated circularly polarized light to an off-axis focal point (or focus) F_{off}. In some embodiments, a propagation direction of the circularly polarized light transmitted by the fabricated off-axis focusing PBP lens may form the angle Θ (having a value that is the same as the value of the angle α) with respect to the normal of the surface of the recording medium layer 1210. The off-axis focal point F_{off} may be shifted from the out-of-plane geometry center axis (or the lens axis) by a distance din a predetermined direction, for example, in the −x-axis direction. The focus shift din the focal plane 1222 may be expressed as d=L*tan(α), where L is the distance between the recording medium layer 1210 and the focal plane 1222 of the fabricated off-axis focusing PBP lens.

FIG. 12D a holographic two-beam-interference exposure process based on an x-z sectional view of the substrate 1205 and the recording medium layer 1210, according to another embodiment of the present disclosure. The holographic two-beam-interference exposure process shown in FIG. 12D may include elements, structures, and/or functions that are the same as or similar to those included in the holographic two-beam-interference exposure process shown in FIG. 12C. Descriptions of the same or similar elements, structures, and/or functions can refer to the above descriptions rendered in connection with FIG. 12C.

As shown in FIG. 12D, the reference beam 1220 and the signal beam 1225 may propagate toward the recording medium layer 1210 from different sides of the recording medium layer 1210, and may be incident onto different surfaces of the recording medium layer 1210. For illustrative purposes, the reference beam 1220 may be incident onto the first surface 1210-1 of the recording medium layer 1210, and the signal beam 1225 may be incident onto the second surface 1210-2 of the recording medium layer 1210. The reference beam 1220 and the signal beam 1225 may be circularly polarized beams with the same handedness. For example, both the reference beam 1220 and the signal beam 1225 may be RHCP beams or LHCP beams. In some embodiments, as shown in FIG. 12D, the reference beam 1220 may be a collimated circularly polarized beam having a propagation direction forming an angle α with respect to a normal of the first surface 1210-1 of the recording medium layer 1210. The signal beam 1225 may be a converging or diverging circularly polarized beam having a propagation direction forming an angle β with respect to a normal of the second surface 1210-2 of the recording medium layer 1210. The angle α and angle β may be acute angles having different signs, for example, the angle α may be a positive acute angle, and the angle β may be a negative acute angle. In some embodiments, the angle α and angle β may be acute angles having the same sign. The absolute values of the angle α and angle β may be the same or different. Thus, a propagation direction of the reference beam 1220 may not be parallel with a propagation direction of the signal beam 1225, and the propagation direction of the reference beam 1220 may form an angle Θ with respect to the propagation direction of the signal beam 1225, where the value of the angle Θ may be a sum of the absolute value of the angle α and the absolute value of the angle β. In some embodiments, the absolute values of the angle α and angle β may be the same, and the value of the angle Θ may be twice of the value of the angle α.

The interference between the reference beam 1220 and the signal beam 1225 may result in spatially varying linear polarization fields. In some embodiments, the linear polarizations may rotate along a direction parallel to the thickness direction of the recording medium layer 1210, forming helical structures similar to cholesteric helical structures. In some embodiments, the linear polarizations may rotate along a direction tilted with respect to the thickness direction of the recording medium layer 1210, forming helical structures similar to cholesteric helical structures. The direction along which the linear polarizations rotate may be referred to as a helical axis direction. An off-axis focusing GP optical element fabricated based on the patterned recording medium layer 1210 may function as an off-axis focusing GP mirror or an off-axis focusing GP lens, depending on the value of an angle formed between the helical axis direction and the thickness direction of the recording medium layer 1210.

In some embodiments, the reference beam 1220 may be a collimated circularly polarized beam having a planar wavefront, and the signal beam 1225 may be a converging or diverging circularly polarized beam having a spherical wavefront. The recording medium layer 1210 may be optically patterned, via the holographic two-beam-interference exposure process, to have an off-axis focusing lens/mirror pattern similar to that shown in FIGS. 3A and 3B. An off-axis focusing GP optical element fabricated based on the patterned recording medium layer 1210 may function as an off-axis focusing PBP spherical lens or an off-axis focusing GP mirror.

In some embodiments, when an on-axis collimated circularly polarized light having a predetermined handedness and a wavelength that is substantially the same as the recording wavelength is incident onto the fabricated off-axis focusing GP mirror, the fabricated off-axis focusing GP mirror may reflect and focus the on-axis collimated circularly polarized light to an off-axis focal point (or focus) F_{off}. In some embodiments, a propagation direction of the circularly polarized light reflected by the fabricated off-axis focusing GP mirror may form the angle Θ (having a value that is the same as the value of the angle α) with respect to the normal of the surface of the recording medium layer 1210. The off-axis focal point F_{off} may be shifted from the out-of-plane geometry center axis (or the lens axis) by a distance din a predetermined direction, for example, in the −x-axis direction. The focus shift din the focal plane 1222 may be expressed as d=L*tan(α), where L is the distance between the recording medium layer 1210 and the focal plane 1222 of the fabricated off-axis focusing GP mirror.

In some embodiments, when an on-axis collimated circularly polarized light having a predetermined handedness and a wavelength that is substantially the same as the recording wavelength is incident onto the fabricated off-axis focusing PBP lens, the fabricated off-axis focusing PBP lens may transmit and focus the on-axis collimated circularly polarized light to an off-axis focal point (or focus) F_{off}. In some embodiments, a propagation direction of the circularly polarized light transmitted by the fabricated off-axis focusing PBP lens may form the angle Θ (having a value that is the same as the value of the angle α) with respect to the normal of the surface of the recording medium layer 1210. The off-axis focal point F_{off} may be shifted from the out-of-plane geometry center axis (or the lens axis) by a distance din a predetermined direction, for example, in the −x-axis direction. The focus shift din the focal plane 1222 may be expressed as d=L*tan(α), where L is the distance between the recording medium layer 1210 and the focal plane 1222 of the fabricated off-axis focusing PBP lens.

Referring to FIGS. 12A-12D, in some embodiments, the reference beam 1220 may be a collimated circularly polarized beam having a planar wavefront, and the signal beam 1225 may be a converging or diverging circularly polarized beam having a cylindrical wavefront. The recording medium layer 1210 may be optically patterned, via the holographic two-beam-interference exposure process, to have an off-axis focusing lens pattern similar to that shown in FIG. 3C. An off-axis focusing PBP lens fabricated based on the patterned recording medium layer 1210 may function as an off-axis focusing cylindrical lens. For example, when an on-axis collimated circularly polarized light having a predetermined handedness and a wavelength that is substantially the same as the recording wavelength is incident onto the fabricated off-axis focusing PBP lens, the fabricated off-axis focusing PBP lens may focus the on-axis collimated beam to an off-axis line focus. In some embodiments, a propagation direction of the circularly polarized light reflected by the fabricated off-axis focusing PBP lens may form the angle Θ (having a value that is the same as the value of the angle α) with respect to the normal of the surface of the recording medium layer 1210. The off-axis line focus may be shifted from the in-plane geometry center axis by a distance din a predetermined direction. For example, when the longitudinal direction of the off-axis focusing cylindrical PBP lens is the y-axis direction in FIG. 12A, the off-axis line focus may be shifted from the in-plane geometry center axis by a distance din the −x-axis direction. The line focus shift din the focal plane 1222 may be expressed as d=L*tan(α), where L is the distance between the recording medium layer 1210 and the focal plane 1222 of the fabricated off-axis focusing PBP lens.

In some embodiments, the reference beam 1220 may be a collimated circularly polarized beam having a planar wavefront, and the signal beam 1225 may be a converging or diverging circularly polarized beam having an aspherical wavefront or a freeform wavefront. The recording medium layer 1210 may be optically patterned, via the holographic two-beam-interference exposure process, to have an off-axis focusing lens pattern corresponding to an alignment pattern of an off-axis focusing aspherical lens or an off-axis focusing freeform lens. An off-axis focusing PBP lens fabricated based on the patterned recording medium layer 1210 may function as an off-axis focusing aspherical lens or an off-axis focusing freeform lens.

Referring to FIGS. 12A-12D, the propagation directions of the reference beam 1220 and the signal beam 1225 may be exchangeable. For example, in some embodiments, the reference beam 1220 may be substantially normally incident onto the recording medium layer 1210, and the signal beam 1225 may have a propagation direction forming an angle α with respect to a normal of a surface of the recording medium layer 1210. In some embodiments, the reference beam 1220 may have a propagation direction forming an angle β with respect to a normal of a surface the recording medium layer 1210, and the signal beam 1225 may have a propagation direction forming an angle α with respect to a normal of a surface of the recording medium layer 1210.

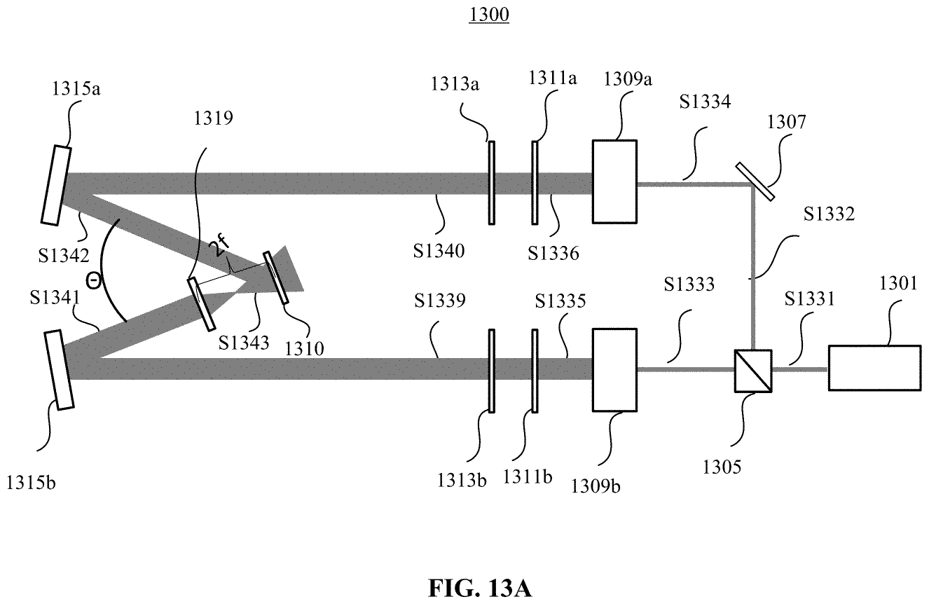

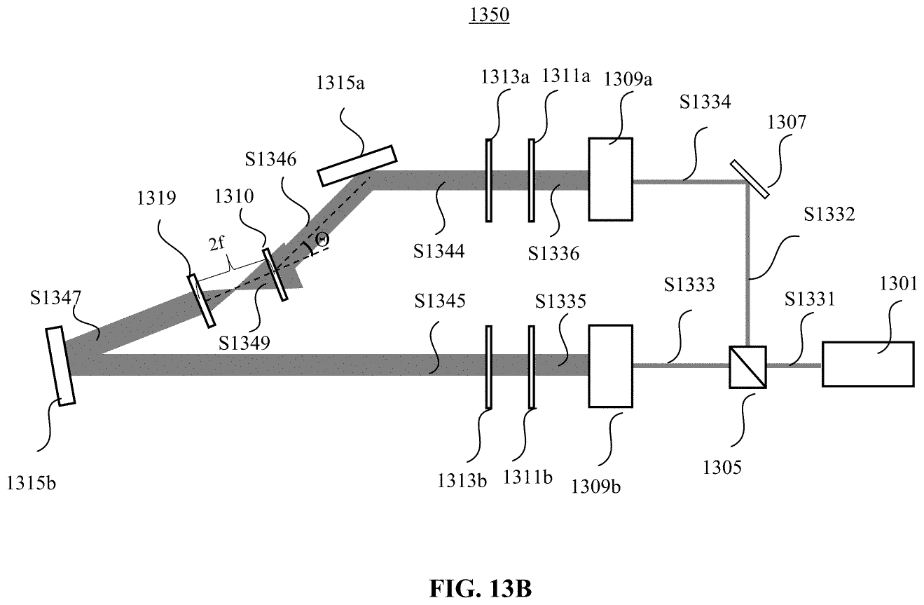

FIG. 13A schematically illustrates an x-z sectional view of an optical system 1300 for generating a holographic two-beam-interference exposure on a recording medium 1310, according to an embodiment of the present disclosure. The holographic two-beam-interference exposure may be similar to that shown in FIG. 12A. The recording medium 1310 may be the recording medium 910 in FIG. 9B or the recording medium 1120 in FIG. 11B. For discussion purposes, the recording medium 1310 may be placed within an x-y plane in FIG. 13A. As shown in FIG. 13A, the optical system 1300 may include a light source 1301 configured to emit a beam S1331 having wavelengths within an absorption band of the recording medium 1310 disposed on a substrate (not shown). For example, the beam S1331 may be a UV, violet, blue, or green beam. In some embodiments, the light source 1301 may be a laser light source, e.g., a laser diode, configured to emit a laser beam S1331 (e.g., a blue laser beam with a center wavelength of about 460 nm). The laser beam S1331 may be polarized or unpolarized. For discussion purposes, in the embodiment shown in FIG. 13A, the laser beam S1331 may be an unpolarized laser beam. The optical system 1300 may include a beam splitter 1305 configured to split the beam S1331 substantially evenly into two paths: a first beam S1332 in a reference path and a second beam S1333 in a signal path. In some embodiments, the beam splitter 1305 may be non-polarizing beam splitter. In some embodiments, the beam S1331 may be a collimated beam directly incident onto the beam splitter 1305. In some embodiments, the beam S1331 may be an uncollimated beam, and the optical system 1300 may include a collimating lens (not shown) disposed between the light source 1301 and the beam splitter 1305. The collimating lens may be configured to collimate the beam S1331 before the beam S1331 is incident onto the beam splitter 1305.

The optical system 1300 may include a reflector (e.g., mirror) 1307 configured to reflect the first beam S1332 in the first path as a beam S1334 that is substantially parallel to the second beam S1333 in the signal path (i.e., the second path). In each of the reference path and the signal path, the optical system 1300 may include a beam expander 1309a or 1309b, a polarizer (e.g., linear polarizer) 1311a or 1311b, a waveplate (e.g., quarter waveplate) 1313a or 1313b, and a reflector (e.g., mirror) 1315a or 1315b arranged in optical series. The beam expander 1309a or 1309b may expand the beam S1334 or S1333 to increase the size of the beam. For example, the beam expander 1309a may expand the beam S1334 as a beam S1336, and the beam expander 1309b may expand the beam S1333 as a beam S1335 having a beam size that is substantially the same as a beam size of the beam S1336. The beam size of each of the expanded beams S1335 and S1336 may be larger than or equal to a predetermined aperture size of an off-axis focusing PBP lens fabricated based on the patterned recording medium 1310. The expanded beams S1335 and S1336 may be collimated beams. In some embodiments, the expanded beams S1335 and S1336 may be unpolarized beams.

The polarizer (e.g., the linear polarizer) 1311a or 1311b may convert the expanded unpolarized beam S1336 or S1335 received from the beam expander 1309a or 1309b to a linearly polarized beam having a predetermined polarization. In some embodiments, the transmission axes of the polarizer (e.g., the linear polarizer) 1311a and 1311b may be arranged in the same direction. That is, the polarizer (e.g., the linear polarizer) 1311a and 1311b may be an absorptive type polarizer configured to selectively transmit a linearly polarized beam having the predetermined polarization and block a linearly polarized beam having a polarization orthogonal to the predetermined polarization. The waveplate 1313a or 1313b may function as a quarter waveplate for the linearly polarized beam received from the polarizer (e.g., the linear polarizer) 1311a or 1311b. A polarization axis (e.g., fast axis) of the waveplate 1313a may be oriented relative to the transmission axis of the polarizer (e.g., the linear polarizer) 1311a to convert the linearly polarized beam to a circularly polarized beam S1340 having a first handedness. A polarization axis (e.g., fast axis) of the waveplate 1313b may be oriented relative to the transmission axis of the polarizer (e.g., the linear polarizer) 1311b to convert the linearly polarized beam to a circularly polarized beam S1339 having a second handedness opposite to the first handedness. For example, one of the circularly polarized beam S1340 and the circularly polarized beam S1339 may be an LHCP beam and the other may be an RHCP beam. The reflector (e.g., mirror) 1315a or 1315b may reflect the circularly polarized beam S1340 or S1339 as a circularly polarized beam S1342 or S1341 propagating toward a same surface of the recording medium 1310. The circularly polarized beams S1342 and S1341 may have opposite handednesses. An angle between the propagation directions of the circularly polarized beam S1341 and the circularly polarized beam S1342 may be Θ. The angle Θ may be adjustable through adjusting the tilting angles of the reflector 1315a and/or the reflector 1315b.

In some embodiments, the optical system 1300 may also include an optical lens 1319 disposed between the reflector (e.g., mirror) 1315b and the recording medium 1310, and transmit the beam S1341 as a beam S1343 propagating toward the recording medium 1310. The lens 1319 may be configured to convert a planar wavefront of the beam S1341 to a spherical wavefront of the beam S1343. In some embodiments, a distance between the lens 1319 and the recording medium 1310 may be about twice the focal length of the lens 1319, such that the fabricated off-axis focusing lens may have a size that is substantially the same as the size of the lens 1319. In addition, more space between the lens 1319 and the recording medium 1310 may be available to converge beams under a small angle. Although not shown, in some embodiments, the distance between the lens 1319 and the recording medium 1310 may have other suitable values. In the embodiment shown in FIG. 13A, the lens 1319 may convert the beam S1341 to the beam S1343 that is a diverging beam with respect to the recording medium 1310. Although not shown, in some embodiments, the distance between the lens 1319 and the recording medium 1310 may be adjusted, and the lens 1319 may convert the beam S1341 to the beam S1343 that is a converging beam with respect to the recording medium 1310.

The locations of the reflector (e.g., mirror) 1315a and/or 1315b and the tilting angles of the reflector 1315a and/or the reflector 1315b may be adjustable with respect to the locations of the recording medium 1310, such that the circularly polarized collimated beam S1342 and the circularly polarized diverging beam S1343 may be interfered in a confined 3D space within which the recording medium 1310 is located. In other words, a polarization interference pattern may be generated in the confined 3D space within which the recording medium 1310 is located.

The beam S1342 may be a reference beam, and the beam S1343 may be a signal beam. In some embodiments, a propagation direction of the reference beam S1342 may form an angle α with respect to a normal of a surface of the recording medium layer 1310. The signal beam S1343 may be substantially normally incident onto the same surface of the recording medium layer 1310 as the reference beam S1342. Thus, a propagation direction of the reference beam S1343 may not be parallel with a propagation direction of the signal beam S1342. The angle Θ between the propagation direction of the reference beam S1342 and the propagation direction of the signal beam S1343 may have a value that is the same as the value of the angle α.

In some embodiments, the reflector 1315a or 1315b may cause a depolarization in a reflected beam. For example, the reflected beam S1342 or S1341 may not be a circularly polarized beam, but may become an elliptically polarized beam. To provide the beams S1342 and S1343 as circularly polarized beams having opposite handedness, in some embodiments, the polarizer (e.g., the linear polarizer) 1311a and the waveplate 1313a may be disposed between the reflector 1315a and the recording medium 1310, and the polarizer (e.g., the linear polarizer) 1311b and the waveplate 1313b may be disposed between the reflector 1315b and the lens 1319.

In some embodiments, the optical system 1300 may be adjusted to generate a holographic two-beam-interference exposure similar to that shown in FIG. 12B. For example, the locations and the tilting angles of the reflector 1315a and/or the reflector 1315b may be adjustable with respect to the locations of the recording medium 1310, and/or the locations of the recording medium 1310 may be adjustable, such that one of the reference beam S1342 and the signal beam S1343 may have a propagation direction forming an angle α with respect to a normal of a surface of the recording medium layer 1310, and the other may have a propagation direction forming an angle β with respect to the normal of the same surface of the recording medium layer 1310. The angle α and angle β may be acute angles having different signs, for example, the angle α may be a positive acute angle, and the angle β may be a negative acute angle. The absolute values of the angle α and angle β may be the same or different. Thus, a propagation direction of the reference beam S1342 may not be parallel with a propagation direction of the signal beam S1343. The propagation direction of the reference beam S1342 may form an angle Θ with respect to the propagation direction of the signal beam S1343, where the value of the angle Θ may be a sum of the absolute value of the angle α and the absolute value of the angle β. The value of the angle Θ may be greater than 0° and smaller than 180°. In some embodiments, the absolute values of the angle α and angle β may be the same, and the value of the angle Θ may be twice of the value of the angle α.

FIG. 13B schematically illustrates an optical system 1350 for generating a holographic two-beam-interference exposure, according to another embodiment of the present disclosure. The optical system 1350 shown in FIG. 13B may include elements, structures, and/or functions that are the same as or similar to those included in the optical system 1300 shown in FIG. 13A. Descriptions of the same or similar elements, structures, and/or functions can refer to the above descriptions rendered in connection with FIG. 13A. The holographic two-beam-interference exposure may be similar to that shown in FIG. 12C.

As shown in FIG. 13B, the waveplate 1313a or 1313b may function as a quarter waveplate for the linearly polarized beam received from the polarizer (e.g., the linear polarizer) 1311a or 1311b. A polarization axis (e.g., fast axis) of the waveplate 1313a may be oriented relative to the transmission axis of the polarizer (e.g., the linear polarizer) 1311a to convert the linearly polarized beam to a circularly polarized beam S1344 having a predetermined handedness. A polarization axis (e.g., fast axis) of the waveplate 1313b may be oriented relative to the transmission axis of the polarizer (e.g., the linear polarizer) 1311b to convert the linearly polarized beam to a circularly polarized beam S1345 having a handedness that is the same as the handedness of the circularly polarized beam S1344. That is, the waveplate 1313a and the waveplate 1313b may be configured to convert the linearly polarized beams received from the corresponding polarizers to the circularly polarized beams S1344 and S1345 having the same handedness, e.g., the circularly polarized beam S1344 and the circularly polarized beam S1345 may be LHCP beams or RHCP beams. The reflectors (e.g., mirror) 1315a and 1315b may reflect the circularly polarized beams S1344 and S1345 as a circularly polarized beams S1346 and S1347, respectively. The circularly polarized beams S1346 and S1347 may have the same handedness, and may propagate toward the recording medium 1310 from different sides of the recording medium 1310. An angle between the propagation directions of the circularly polarized beams S1346 and S1347 may be Θ. The angle Θ may be adjustable through adjusting the tilting angles of the reflector 1315a and/or the reflector 1315b.

The lens 1319 may be disposed between the reflector (e.g., mirror) 1315b and the recording medium 1310, and may transmit the circularly polarized beam S1347 as a circularly polarized beam S1349 propagating toward the recording medium 1310. A distance between the lens 1319 and the recording medium 1310 may be about twice of the focal length of the lens 1319, such that the circularly polarized beam S1349 may be first focused to the focus (or line focus) of the lens 1319 and then diverged. That is, the beam S1349 may be a diverging beam with respect to the recording medium 1310. Although not shown, in some embodiments, the distance between the lens 1319 and the recording medium 1310 may be adjusted, and the lens 1319 may convert the beam S1347 to the beam S1349 that is a converging beam with respect to the recording medium 1310.

The locations of the reflector (e.g., mirror) 1315a and/or 1315b and the tilting angles of the reflector 1315a and/or the reflector 1315b may be adjustable with respect to the locations of the recording medium 1310, such that the circularly polarized collimated beam S1346 and the circularly polarized diverging beam S1349 may be interfered in a confined 3D space within which the recording medium 1310 is located. In other words, a polarization inference pattern may be generated in the confined 3D space within which the recording medium 1310 is located.

The beam S1346 may be a reference beam, and the beam S1349 may be a signal beam. The recording medium layer 1310 may have a first surface facing the reflector 1315a and a second surface opposite to the first face. The second surface of the recording medium layer 1310 may face the lens 1319. For illustrative purposes, FIG. 13B shows that the reference beam S1346 may be incident onto the first surface of the recording medium layer 1310, and the signal beam S1349 may be incident onto the second surface of the recording medium layer 1310. In some embodiments, a propagation direction of the reference beam S1346 may form an angle α with respect to a normal of the first surface of the recording medium layer 1310. The signal beam S1349 may be substantially normally incident onto the same surface of the recording medium layer 1310. Thus, a propagation direction of the reference beam S1346 may not be parallel with a propagation direction of the signal beam S1349. The angle Θ between the propagation direction of the reference beam S1346 and the propagation direction of the signal beam S1349 may have a value that is the same as the value of the angle α.

In some embodiments, the optical system 1350 may be adjusted to generate a holographic two-beam-interference exposure similar to that shown in FIG. 12D. For example, the locations of the reflector (e.g., mirror) 1315a and/or 1315b and the tilting angles of the reflector 1315a and/or the reflector 1315b may be adjustable with respect to the locations of the recording medium 1310, or the locations of the recording medium 1310 may be adjustable, such that one of the reference beam S1346 and the signal beam S1349 may have a propagation direction forming an angle α with respect to a normal of a first surface of the recording medium layer 1310, and the other may have a propagation direction forming an angle β with respect to the normal of a second surface of the recording medium layer 1310. The angle α and angle β may be acute angles having different signs, for example, the angle α may be a positive acute angle, and the angle β may be a negative acute angle. The absolute values of the angle α and angle β may be the same or different. Thus, a propagation direction of the reference beam S1346 may not be parallel with a propagation direction of the signal beam S1349. The propagation direction of the reference beam S1346 may form an angle Θ with respect to the propagation direction of the signal beam S1349, where the value of the angle Θ may be a sum of the absolute value of the angle α and the absolute value of the angle β. In some embodiments, the absolute values of the angle α and angle θ may be the same, and the value of the angle Θ may be twice of the value of the angle α.

In some embodiments, the reflector 1315a or 1315b may cause a depolarization in a reflected beam. For example, the reflected beam S1347 or S1346 may not be a circularly polarized beam, but may become an elliptically polarized beam. To provide the beams S1346 and S1347 as circularly polarized beams having the same handedness, in some embodiments, the polarizer (e.g., the linear polarizer) 1311a and the waveplate 1313a may be disposed between the reflector 1315a and the recording medium 1310, and the polarizer (e.g., the linear polarizer) 1311b and the waveplate 1313b may be disposed between the reflector 1315b and the lens 1319.

Referring to FIGS. 13A and 13B, the lens 1319 in the optical system 1300 may include one or more suitable lenses configured to generate a desirable wavefront of the signal beam S1343. In some embodiments, the lens 1319 may include a spherical lens configured to convert the beam S1341 to the signal beam S1343 having a spherical wavefront. In some embodiments, an off-axis focusing PBP lens fabricated based on the patterned recording medium 1310 may function as a spherical lens. In some embodiments, the lens 1319 may include a cylindrical lens configured to convert the beam S1341 to the signal beam S1343 having a cylindrical wavefront. In some embodiments, an off-axis focusing PBP lens fabricated based on the patterned recording medium 1310 may function as a cylindrical lens. In some embodiments, the lens 1319 may include an aspherical lens configured to convert the beam S1341 to the signal beam S1343 having an aspherical wavefront. In some embodiments, an off-axis focusing PBP lens fabricated based on the patterned recording medium 1310 may function as an aspherical lens. In some embodiments, the lens 1319 may include a freeform lens configured to convert the beam S1341 to the signal beam S1343 having a freeform wavefront. In some embodiments, an off-axis focusing PBP lens fabricated based on the patterned recording medium 1310 may function as a freeform ens.

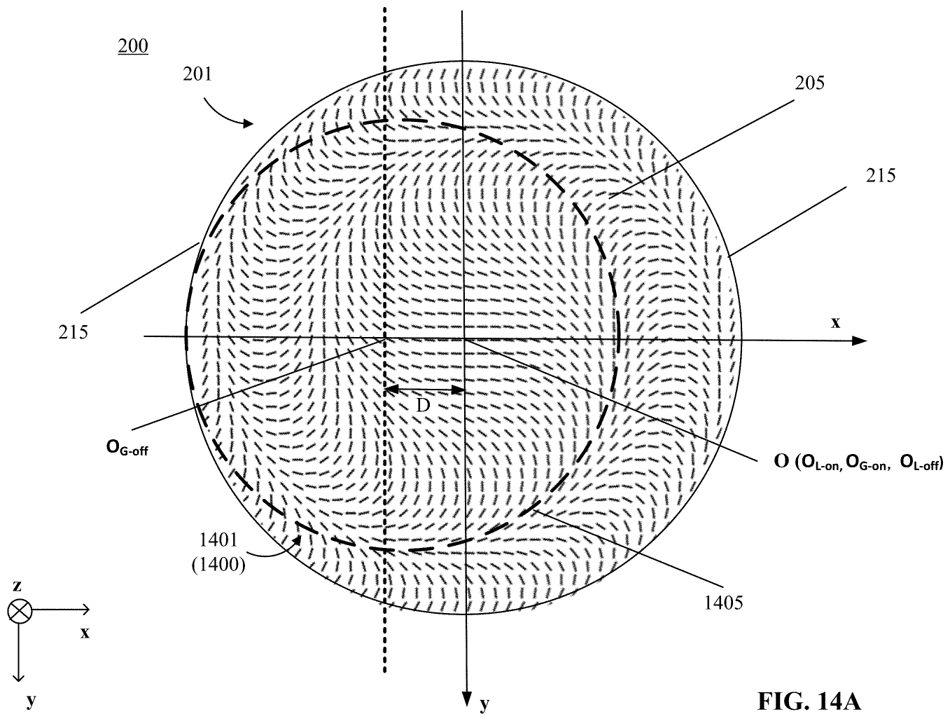

FIGS. 14A and 14B schematically illustrate processes for fabricating off-axis focusing PBP lenses, according to various embodiments of the present disclosure. The off-axis focusing PBP lenses fabricated based on the processes shown in FIGS. 14A and 14B may be passive off-axis focusing PBP lenses. As shown in FIGS. 14A and 14B, an off-axis focusing PBP lens may be obtained by cropping or cutting an on-axis focusing PBP lens asymmetrically with respect to at least one symmetric axis of the aperture of the on-axis focusing PBP lens. The off-axis focusing PBP lens may be obtained by cropping or cutting an on-axis focusing PBP lens asymmetrically at least including a lens pattern center O_{L-On} of the on-axis focusing PBP lens. A lens layer of the obtained off-axis focusing PBP lens may include a lens pattern center O_{L-Off}, which may correspond to the lens pattern center O_{L-On} of the on-axis focusing PBP lens from the off-axis focusing PBP lens is cut or cropped. A geometry center O_{G-On} of the on-axis focusing PBP lens may coincide with the lens pattern center O_{L-On} of the on-axis focusing PBP lens. Thus, as shown in FIG. 14A, the point “O” may represent the lens pattern center O_{L-On} of the on-axis focusing PBP lens, the geometry center O_{G-On} of the on-axis focusing PBP lens, and the lens pattern center O_{L-Off} of the off-axis focusing PBP lens. The geometry center O_{G-Off} of the obtained off-axis focusing PBP lens may be shifted from the geometry center O_{G-On} of the on-axis focusing PBP lens.

FIG. 14A shows the LC alignment pattern (or the lens pattern) in the lens layer 201 of the on-axis focusing PBP lens 200 shown in FIG. 2A. The on-axis focusing PBP lens 200 may function as an on-axis focusing spherical PBP lens. As shown in FIG. 14A, an off-axis focusing PBP lens 1400 may be obtained by cropping or cutting the lens layer 201 of the on-axis focusing PBP lens 200 asymmetrically with respect to at least one symmetric axis of the aperture of the on-axis focusing PBP lens 200 (e.g., a symmetric axis in the y-axis direction). For illustrative purposes, FIG. 14A shows that a portion (represented by a circle 1405) of the lens layer 201 of the on-axis focusing PBP lens 200 may be cropped or cut to form an off-axis focusing PBP lens 1400. Reference numeral “1401” represents a lens layer of the off-axis focusing PBP lens 1400. Although not shown, the lens layer 201 of the on-axis focusing PBP lens 200 may be cropped or cut into other shapes, e.g., a square (with a center of the square off from the geometry center O_{G-On} of the on-axis focusing PBP lens 200). The lens layer 1401 of the off-axis focusing PBP lens 1400 may include a geometry center O_{G-Off}, which is a center of the circular shape of the off-axis focusing PBP lens 1400. The geometric center O_{G-Off} is shifted from the geometry center O_{G-On} of the on-axis focusing PBP lens 200 for a predetermined distance D along the x-axis. The lens pattern center O_{L-Off} of the obtained off-axis focusing PBP lens 1400 may coincide with the lens pattern center O_{L-On} of the on-axis focusing PBP lens 200. The obtained off-axis focusing PBP lens 1400 may function as an off-axis focusing spherical lens.

FIG. 14B shows the LC alignment pattern (or the lens pattern) in the lens layer 251 of the on-axis focusing PBP lens 250 shown in FIG. 2C. The on-axis focusing PBP lens 250 may function as an on-axis focusing cylindrical PBP lens. As shown in FIG. 14B, an off-axis focusing PBP lens 1450 may be obtained by cropping or cutting the lens layer 251 of the on-axis focusing PBP lens 250 asymmetrically with respect to at least one symmetric axis of the aperture of the on-axis focusing PBP lens 250 (e.g., a longitudinal symmetric axis in the y-axis direction). For illustrative purposes, a portion of the lens layer 251 enclosed by the dashed rectangle 1455 may represents a lens layer 1451 of the off-axis focusing PBP lens 1450. Although not shown, the lens layer 251 of the on-axis focusing PBP lens 250 may be cropped or cut into other shapes, e.g., a circle. The lens layer 1451 of the off-axis focusing PBP lens 1450 may include a geometry center O_{G-Off}, which may be a center of the rectangular shape 1455 of the lens layer 1451. The lens pattern center O_{L-Off} of the off-axis focusing PBP lens 1450 may coincide with the lens pattern center O_{L-On} of the original on-axis focusing PBP lens 250. A geometry center O_{G-Off} of the obtained off-axis focusing PBP lens 1450 may be shifted from the geometry center O_{G-On} of the on-axis focusing PBP lens 250. The obtained off-axis focusing PBP lens 1450 may function as an off-axis focusing cylindrical lens.

Although not shown, an off-axis focusing PBP lens functioning as an off-axis focusing aspherical lens may be obtained by cropping or cutting an on-axis focusing PBP lens functioning as an on-axis focusing spherical lens asymmetrically, with respect to at least one symmetric axis of the aperture of the on-axis focusing PBP lens. In some embodiments, an off-axis focusing PBP lens functioning as an off-axis focusing freeform lens may be obtained by cropping or cutting an on-axis focusing PBP lens functioning as an on-axis focusing spherical lens asymmetrically, with respect to at least one symmetric axis of the aperture of the on-axis focusing PBP lens.

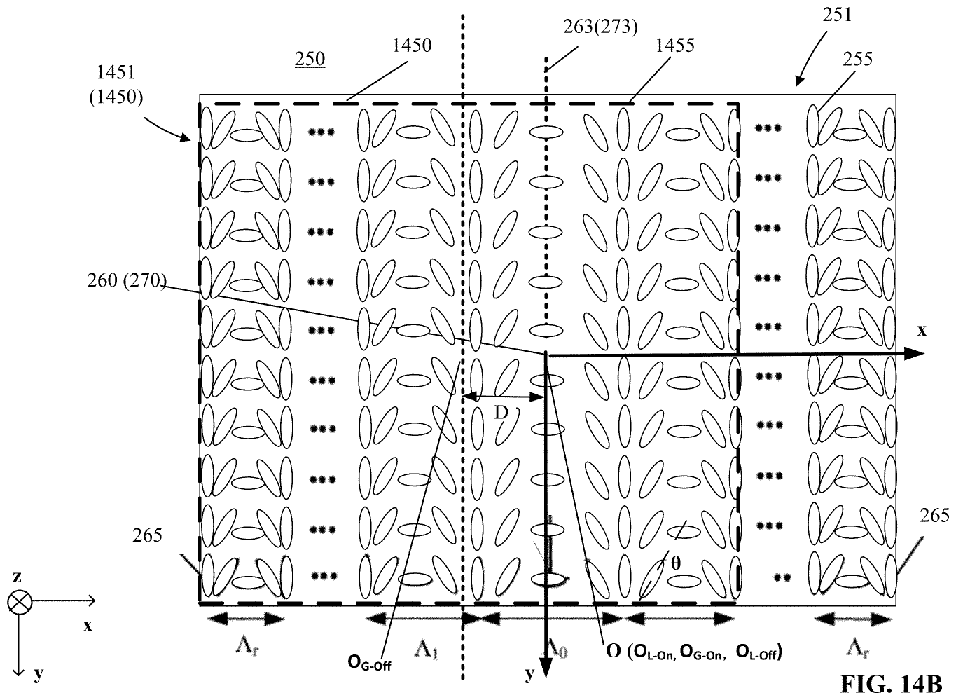

FIG. 15 illustrates a flowchart showing a method 1500 for fabricating an off-axis focusing GP optical element, according to an embodiment of the present disclosure. The method 1500 may include directing a first beam to a polarization sensitive recording medium (Step 1510). The method 1500 may include directing a second beam to the polarization sensitive recording medium to interfere with the first beam to generate a polarization interference pattern, to which the polarization sensitive recording medium is exposed (Step 1520).

One of the first beam and the second beam may have a planar wavefront and the other may have a non-planar wavefront. A first propagation direction of the first beam and a second propagation direction of the second beam may be non-parallel. The polarization interference pattern may have a substantially uniform intensity and a spatially varying linear polarization orientation angle. The polarization interference pattern may be recorded at the polarization sensitive recording medium to define an orientation pattern of an optic axis of the polarization sensitive recording medium. The orientation pattern of an optic axis of the polarization sensitive recording medium may correspond to an off-axis focusing GP optical element, such as an off-axis focusing GP lens, an off-axis focusing GP mirror, etc. In some embodiments, the first beam and the second beam may be laser beams having a wavelength within an absorption band of the polarization sensitive recording medium. In some embodiments, the first beam and the second beam may be ultraviolet, violet, blue, or green beams. In some embodiments, the non-planar wavefront may include at least one of a spherical wavefront, a cylindrical wavefront, an aspherical wavefront, or a freeform wavefront. Accordingly, the off-axis focusing PBP lens fabricated based on the steps in FIG. 15 may be a spherical lens/mirror, a cylindrical lens/mirror, an aspherical lens/mirror, or a freeform lens/mirror.

In some embodiments, directing the first beam first beam to the polarization sensitive recording medium and directing the second beam to the polarization sensitive recording medium to interfere with the first beam to generate the polarization interference pattern may also include directing the first beam and the second beam to a same surface of the polarization sensitive recording medium. The first beam and the second beam may be circularly polarized beams having opposite handednesses. The first propagation direction may form a first angle with respect to a normal of the surface, and the second propagation direction forms a second angle with respect to the normal of the surface. The first angle and the second angle may have different signs or the same sign. In some embodiments, the first angle and the second angle may have a substantially same absolute value. In some embodiments, one of the first angle and the second angle may be greater than or equal to 0° and smaller than or equal to about 45°, and the other of the first angle and the second angle may be greater than 0° and smaller than or equal to about 45°. In some embodiments, one of the first angle and the second angle may be greater than or equal to 0° and smaller than or equal to about 30°, and the other of the first angle and the second angle may be greater than 0° and smaller than or equal to about 30°. In some embodiments, one of the first angle and the second angle may be greater than or equal to 0° and smaller than or equal to about 20°, and the other of the first angle and the second angle may be greater than 0° and smaller than or equal to about 20°. In some embodiments, one of the first angle and the second angle may be greater than or equal to 0° and smaller than or equal to about 10°, and the other of the first angle and the second angle may be greater than 0° and smaller than or equal to about 10°.

For example, in some embodiments, the first propagation direction may be substantially parallel to a normal of the surface, and the second propagation direction may form an acute angle with respect to a normal of the surface. In some embodiments, the first propagation direction may form a first acute angle with respect to a normal of the surface, and the second propagation direction may form a second acute angle with respect to the normal of the surface. In some embodiments, the first acute angle and the second acute angle may have different signs. In some embodiments, the first acute angle and the second acute angle may have the same sign. In some embodiments, the first acute angle and the second acute angle have a substantially same absolute value.

In some embodiments, directing the first beam first beam to the polarization sensitive recording medium and directing the second beam to the polarization sensitive recording medium to interfere with the first beam to generate the polarization interference pattern may also include directing the first beam and the second beam to a first surface and an opposing second surface of the polarization sensitive recording medium, respectively. The first beam and the second beam may be circularly polarized beams having a same handedness. The first propagation direction may form a first angle with respect to a normal of the first surface, and the second propagation direction forms a second angle with respect to the normal of the second surface. The first angle and the second angle may have different signs or the same sign. In some embodiments, the first angle and the second angle may have a substantially same absolute value. In some embodiments, one of the first angle and the second angle may be greater than or equal to 0° and smaller than or equal to about 45°, and the other of the first angle and the second angle may be greater than 0° and smaller than or equal to about 45°. In some embodiments, one of the first angle and the second angle may be greater than or equal to 0° and smaller than or equal to about 30°, and the other of the first angle and the second angle may be greater than 0° and smaller than or equal to about 30°. In some embodiments, one of the first angle and the second angle may be greater than or equal to 0° and smaller than or equal to about 20°, and the other of the first angle and the second angle may be greater than 0° and smaller than or equal to about 20°. In some embodiments, one of the first angle and the second angle may be greater than or equal to 0° and smaller than or equal to about 10°, and the other of the first angle and the second angle may be greater than 0° and smaller than or equal to about 10°.

For example, in some embodiments, the first propagation direction may be substantially parallel to a normal of the first surface, and the second propagation direction may form an acute angle with respect to a normal of the second surface. In some embodiments, the first propagation direction may form a first acute angle with respect to a normal of the first surface, and the second propagation direction may form a second acute angle with respect to a normal of the second surface. In some embodiments, the first acute angle and the second acute angle may have different signs. In some embodiments, the first acute angle and the second acute angle have a substantially same absolute value.

In some embodiments, the polarization sensitive recording medium may include a photo-sensitive polymer (or photo-polymer), e.g., an amorphous polymer, an LC polymer, etc. The polarization sensitive recording medium after exposed to the polarization interference pattern may function as an off-axis focusing GP optical element. In some embodiments, the method 1500 may also include annealing the polarization sensitive recording medium in a predetermined temperature range after the polarization sensitive recording medium is exposed to the polarization interference pattern. For example, when the polarization sensitive recording medium includes LC polymer, the predetermined temperature range may correspond to a liquid crystalline state of the LC polymer.

In some embodiments, the polarization sensitive recording medium may include a photo-alignment material, and the polarization sensitive recording medium after exposed to the polarization interference pattern may function as a surface alignment layer. The method 1500 may also include forming a birefringent medium layer on the polarization sensitive recording medium. In some embodiments, the birefringent medium layer includes at least one of LCs or RMs. In some embodiments, the method 1500 may also include annealing the polarization sensitive recording medium in a predetermined temperature range after the polarization sensitive recording medium is exposed to the polarization interference pattern. In some embodiments, the predetermined temperature range may correspond to a nematic phase of the LCs or RMs. In some embodiments, the method 1500 may also include polymerizing the birefringent medium layer. In some embodiments, the polymerized birefringent medium layer may function as an off-axis focusing GP optical element.

The foregoing description of the embodiments of the present disclosure have been presented for the purpose of illustration. It is not intended to be exhaustive or to limit the disclosure to the precise forms disclosed. Persons skilled in the relevant art can appreciate that modifications and variations are possible in light of the above disclosure.

Some portions of this description may describe the embodiments of the present disclosure in terms of algorithms and symbolic representations of operations on information. These operations, while described functionally, computationally, or logically, may be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware and/or software modules, alone or in combination with other devices. In one embodiment, a software module is implemented with a computer program product including a computer-readable medium containing computer program code, which can be executed by a computer processor for performing any or all of the steps, operations, or processes described. In some embodiments, a hardware module may include hardware components such as a device, a system, an optical element, a controller, an electrical circuit, a logic gate, etc.

Embodiments of the present disclosure may also relate to an apparatus for performing the operations herein. This apparatus may be specially constructed for the specific purposes, and/or it may include a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. The non-transitory computer-readable storage medium can be any medium that can store program codes, for example, a magnetic disk, an optical disk, a read-only memory (“ROM”), or a random access memory (“RAM”), an Electrically Programmable read only memory (“EPROM”), an Electrically Erasable Programmable read only memory (“EEPROM”), a register, a hard disk, a solid-state disk drive, a smart media card (“SMC”), a secure digital card (“SD”), a flash card, etc. Furthermore, any computing systems described in the specification may include a single processor or may be architectures employing multiple processors for increased computing capability. The processor may be a central processing unit (“CPU”), a graphics processing unit (“GPU”), or any processing device configured to process data and/or performing computation based on data. The processor may include both software and hardware components. For example, the processor may include a hardware component, such as an application-specific integrated circuit (“ASIC”), a programmable logic device (“PLD”), or a combination thereof. The PLD may be a complex programmable logic device (“CPLD”), a field-programmable gate array (“FPGA”), etc.

Embodiments of the present disclosure may also relate to a product that is produced by a computing process described herein. Such a product may include information resulting from a computing process, where the information is stored on a non-transitory, tangible computer readable storage medium and may include any embodiment of a computer program product or other data combination described herein.

Further, when an embodiment illustrated in a drawing shows a single element, it is understood that the embodiment or another embodiment not shown in the figures but within the scope of the present disclosure may include a plurality of such elements. Likewise, when an embodiment illustrated in a drawing shows a plurality of such elements, it is understood that the embodiment or another embodiment not shown in the figures but within the scope of the present disclosure may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one figure/embodiment but not shown in another figure/embodiment may nevertheless be included in the other figure/embodiment. In any optical device disclosed herein including one or more optical layers, films, plates, or elements, the numbers of the layers, films, plates, or elements shown in the figures are for illustrative purposes only. In other embodiments not shown in the figures, which are still within the scope of the present disclosure, the same or different layers, films, plates, or elements shown in the same or different figures/embodiments may be combined or repeated in various manners to form a stack.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A method, comprising:
directing a first beam to a polarization sensitive recording medium; and
directing a second beam to the polarization sensitive recording medium to interfere with the first beam to generate a polarization interference pattern, to which the polarization sensitive recording medium is exposed,
wherein one of the first beam and the second beam has a planar wavefront and the other has a non-planar wavefront, and
wherein a first propagation direction of the first beam and a second propagation direction of the second beam are non-parallel.

2. The method of claim 1, wherein the polarization sensitive recording medium includes a photopolymer.

3. The method of claim 1, wherein the polarization sensitive recording medium includes a photo-alignment material, and the method further comprises forming a birefringent medium layer on the polarization sensitive recording medium.

4. The method of claim 3, further comprising polymerizing the birefringent medium layer.

5. The method of claim 3, wherein the birefringent medium layer includes liquid crystals.

6. The method of claim 1, further comprises annealing the polarization sensitive recording medium in a predetermined temperature range after the polarization sensitive recording medium is exposed to the polarization interference pattern.

7. The method of claim 6, wherein the polarization sensitive recording medium includes a liquid crystal polymer, and the predetermined temperature range corresponds to a liquid crystalline state of the liquid crystal polymer.

8. The method of claim 1, wherein directing the first beam to the polarization sensitive recording medium and directing the second beam to the polarization sensitive recording medium to interfere with the first beam to generate the polarization interference pattern further comprise:
directing the first beam and the second beam to a same surface of the polarization sensitive recording medium, wherein the first beam and the second beam are circularly polarized beams having opposite handednesses.

9. The method of claim 8, wherein:
the first propagation direction forms a first angle with respect to a normal of the surface,
the second propagation direction forms a second angle with respect to the normal of the surface, and
the first angle and the second angle have different signs or the same sign.

10. The method of claim 9, wherein the first angle is greater than or equal to 0° and smaller than or equal to about 30°, and the second angle is greater than 0° and smaller than or equal to about 30°.

11. The method of claim 9, wherein the first angle and the second angle have a substantially same absolute value.

12. The method of claim 1, wherein directing the first beam to the polarization sensitive recording medium and directing the second beam to the polarization sensitive recording medium to interfere with the first beam to generate the polarization interference pattern further comprise:
directing the first beam and the second beam to a first surface and an opposing second surface of the polarization sensitive recording medium, respectively,
wherein the first beam and the second beam are circularly polarized beams having a same handedness.

13. The method of claim 12, wherein:
the first propagation direction forms a first angle with respect to a normal of the first surface,
the second propagation direction forms a second angle with respect to the normal of the second surface, and
the first angle and the second angle have different signs or the same sign.

14. The method of claim 13, wherein the first angle is greater than or equal to 0° and smaller than or equal to about 30°, and the second angle is greater than 0° and smaller than or equal to about 30°.

15. The method of claim 13, wherein the first angle and the second angle have a substantially same absolute value.

16. The method of claim 1, wherein the polarization interference pattern has a substantially uniform intensity and a spatially varying linear polarization orientation angle.

17. The method of claim 1, wherein the polarization interference pattern is recorded at the polarization sensitive recording medium to define an orientation pattern of an optic axis of the polarization sensitive recording medium, and the orientation pattern of the optic axis of the polarization sensitive recording medium corresponds to an off-axis focusing geometric phase lens or mirror.

18. The method of claim 1, wherein the first beam and the second beam are laser beams having a wavelength within an absorption band of the polarization sensitive recording medium.

19. The method of claim 1, wherein the first beam and the second beam are ultraviolet, violet, blue, or green beams.

20. The method of claim 1, wherein the non-planar wavefront includes at least one of a spherical wavefront, a cylindrical wavefront, an aspherical wavefront, or a freeform wavefront corresponding to a focused or defocused beam.
